(19) United States
(12) Patent Application Publication
(10) Pub. No.: US 2025/0035232 A1
(43) Pub. Date: Jan. 30, 2025

(54) AUTOMATIC MAGNETIC VALVE, SYSTEM, AND METHODS

(71) Applicant: Iowa State University Research Foundation, Inc., Ames, IA (US)

(72) Inventors: KYUIL CHO, Holland, MI (US); VITALIJ K. PECHARSKY, AMES, IA (US); JULIE SLAUGHTER-ZROSTLIK, Nevada, IA (US); LUCAS GRIFFITH, AMES, IA (US); AGATA CZERNUSZEWICZ, Gilbert, IA (US)

(21) Appl. No.: 18/785,839

(22) Filed: Jul. 26, 2024

Related U.S. Application Data
(60) Provisional application No. 63/515,711, filed on Jul. 26, 2023.

(51) Int. Cl. F16K 31/08; F16K 3/02

(52) U.S. Cl. CPC F16K 31/08; F16K 3/0254

(57) ABSTRACT

A method, apparatus, and system of controlling flow of a flowable material including interposing an automatic magnetic valve comprising a magnetic actuator moveable in a valve body relative to a flow path for the flowable material without any on-board magnetic field source for actuating movement of the magnetic actuator in the valve body, or control circuit or electrical power source; selecting operating state of the valve to normally-open or normally-closed by configuration of the restoring force component relative to the magnetic actuator; positioning the valve relative to an off-board magnetic field to effectively take advantage of a direction and magnitude of the off-board magnetic field; and operatively connecting and controlling a flow of the flowable material through the valve with the off-board magnetic field influence on the on-board magnetic actuator.

### CROSS-REFERENCE TO RELATED APPLICATIONS

This application claims the benefit of Provisional Application U. S. Ser. No. 63/515,711 filed on Jul. 26, 2023, all of which is herein incorporated by reference in its entirety.

### GOVERNMENT RIGHTS CLAUSE

This invention was made with Government support under contract No. DE-AC02-07CH11358 issued by the U.S. Department of Energy. The government has certain rights in the invention.

### BACKGROUND OF THE INVENTION

### 1.1 Field of the Invention

This invention relates to the general field of valves for controlling flow of materials including liquid, gas, and flowable solid phase materials and, in particular, to magnetic valves.

### 1.2 Problems in the State of the Art

Magnetic valves actuated by on-board solenoid coil control units are common. See, e.g., US 2017/0175917 A1 Kolbenschlag, incorporated by reference herein. See FIGS. 1A-B and 1C for diagrammatic views of general operation of such solenoid valves 10. A valve body 11 has a flow path 14 that passes a valve seat or seal 15. A spring-loaded, moveable magnetic actuator 17 moves along a range of motion (ROM) 12 between normally open (FIG. 1A) or normally closed (FIG. 1C, left side) position and closed (FIG. 1B) or open (FIG. 1C, right side) by activation of an on-board solenoid 19 encasing a substantial portion of movable magnetic actuator 17 via a control circuit connected to an electrical power source. A portion or surface (plug end) 16 of magnetic actuator 17 is either seated in or spaced from valve seat or seal 15 to either block or allow flow of flowable material 13 through flow path 14. A spring 18 supplies a restoring force to return magnetic actuator 17 to an original position when solenoid 18 is de-energized. By “magnetic valve” it is meant in the commonly-used context that the actuator that opens or closes the flow path is at least partially of ferromagnetic material which responds to a magnetic field created by the on-board solenoid. By “on-board” it is meant in the commonly-used context that the activation solenoid is an integral, dedicated part of and installed on or within the valve 10, and operates via electrical power supplied to the on-board solenoid through its control unit. To our knowledge, however, there is no known fully automatic magnetic valve that operates in response to an off-board or existing source of changing magnetic field without any additional electronic control unit. The novelty of our invention is that our magnetic valve does not require external controls or additional electrical power source to operate. Compare FIGS. 1A-B to 2A-B.

The actuator in solenoid-based valves responds to a varying magnetic field, and either is the valve plug (the element that restricts or allows flow relative a value seat or constriction) or is attached to a valve plug which moves in response to the actuator (and does not have to be magnetic). However, in both the foregoing systems, an on-board dedicated solenoid to generate the magnetic field moving the actuator is required, and must be sized, configured, and installed along the axis of range of movement of, and at or around a substantial portion of the magnetic portion of the actuator. This presents an integrated valving unit with on-board activation element that needs electrical connection to an electrical power source (which could be on-board, but does not have to be). Additionally, if valve operation needs to be synchronized or responsive to an off-board or external event or condition, it adds complexity and uncertainty as to obtaining precise, accurate, and repeatable synchronization.

E. Quandt, K. Seemann, “Fabrication and simulation of magnetostrictive thin-film actuators”, Sensors and Actuators A: Physical, Volume 50, Issues 1-2, 1995, Pages 105-109, ISSN 0924-4247, https://doi.org/10.1016/0924-4247(96)80092-6 (incorporated by reference herein) discusses a thin-film magnetostrictive valve which also uses a magnetic field H (see ref. no. 19′) to actuate a flow valve. A flow valve 10′ that induces magnetostrictive effect to change state of a magnetostrictive valve actuator 17′ is illustrated at FIG. 1D. The work is silent with respect to the source of the magnetic field H. It differs from a magnetic valve in that an active material 17′/18′ (magnetostrictive thin film 17′ on bending beam 18′) is needed to block or unblock a valve seat or seal 15′ to a flow of flowable material 13′ through flow path 14′ rather than simply a ferromagnetic material as described in the current invention. The thin film and bending beam present challenges regarding form factor of all of valve body 11′, flow path 14′, and a plug portion 16′ of magnetostrictive material 17′ and bending beam 18′ relative a magnetic field H for effective flow control through valve 10′.

As is well-known, other types of flow valves may have a valve plug that is moved to a valve seat to stop flow and could be metal, and thus, potentially ferromagnetic and theoretically responsive to a magnetic field. An example would be a steel ball valve 10″ that can be manually, mechanically, or electromechanically rotated between blocking flow and allowing flow of material 13″ through path 14″. See illustration at FIG. 1E. But these are not magnetic valves, in the sense the actuating force to move the valve plug (the ball 17″, which is the valve actuator) relative to seats or seals 15″ in valve body 11″ is not a magnetic force and/or does not depend on or require a variable magnetic field to actuate. There is direct mechanical control 19″ of movement of the valve plug in the valve.

The inventors have recognized that there are a variety of situations where it would be beneficial for a valve element to be responsive to off-board activation, as opposed to on-board. There are situations where including an on-board activation element and/or control circuit, and/or connecting such a circuit to off-board electrical power, is either not desirable or practical (or even possible). A few non-limiting examples are as follows.

Off-board valve actuation can be effective in applications needing tamper-resistant flow control. The valving element and body can be sealed and protected by moving valving control outside it. Similarly, safety risks can be reduced, better access for repair and maintenance provided, and/or valve operation and longevity improved by moving valve actuation outside of pressure vessels. Benefits can exist by using off-board valve actuation for valving control of valves in remote locations from a control center. This includes in the context of the present invention, where the valving plug so to speak, is a magnetic actuator. Instead of having an on-board solenoid with wiring and electrical energy integrated into the valve body, using a time-varying magnetic field generator off-board can provide benefits such as indicated above.

Another example is cases where some force, function, or action not related to valving is available and could be harvested for valve actuation. The inventors have recognized that time-varying magnetic fields generated for a different purpose than valving may be candidates for use as off-board magnetic valve actuation, particularly if the time-varying off-board magnetic field is relevant to desired opening and closing of one or more valves. In such cases, the magnetic field actuated by an off-board variable magnetic field that is not integrated within its magnetic valve body or is external to that body, whether or not the off-board variable magnetic field is originally or principally dedicated to operation of the valve or not.

One non-limiting example of a varying magnetic field available from an existing but separate source is a permanent-magnet rotary refrigerator (“RMR”). See, FIG. 1F, which is from Zimm, et al., “Design and performance of a permanent-magnet rotary refrigerator”, International J. of Refrigeration 29 (2006) 1302-1306, incorporated by reference herein. It uses metallic magnetocaloric materials (“MCMs”) and high field permanent and superconducting magnets in a refrigeration cycle called the active magnetic regenerator (“AMR”). Awheel holding one or more beds of MCMs (e.g. packed gadolinium or Gd spheres) is reciprocated or rotated by a motor through a gap of a 1.5 Tesla (“T”) magnetic field strength permanent magnet to cycle the MCMs between low and high magnetic fields. Simultaneously, hot fluid is transferred from the hot side of a fluid circuit through the bed of Gd spheres to a hot heat exchanger (“hot hex” in FIG. 1F) and cold fluid transferred from a cold side of the beds in the low field direction to a cold heat exchanger (“cold hex”). Disk valves (a type of butterfly valve) (see FIG. 1F) mechanically open and close in response to rotation of the wheel to control the timing of valving of the fluid through the fluid circuit. The ports of the rotating and fixed parts of the disk valves interact to correctly switch fluid flow as the wheel rotates. See also U.S. Pat. No. 6,526,759, incorporated by reference herein, for details. An alternative to rotating MCMs past a fixed permanent magnet is to rotate or reciprocate one or more magnets past fixed beds of MCMs. See, e.g., U.S. Pat. No. 5,182,914 to Barclay et al. and US 2024/0125521A1 to Wakuda, each incorporated by reference herein. In these cases, the primary purpose of the time-varying magnetic field is to generate a magnetocaloric effect from the MCMs. Non-magnetic valves are used to synchronize fluid flow between hot and cold heat exchanges. But such a time-varying magnetic field is in proximity to such valves and, as such, could be considered a stray magnetic field to other components around it. It is certainly off-board any of the valves.

Thus, a technical problem identified by the inventors is how to effectively actuate one or more valves with off-board actuation control, whether dedicated to the valving or not. The inventors have, therefore, identified a need for a solution in this technical field.

### SUMMARY OF THE INVENTION

We describe a fully automatic magnetic valve to manage flow of fluids or other flowable materials without separate control and/or power circuits. The valve has a magnetic actuator moveable in the valve body along a range of motion that includes a flow-blocking position to positions away from the flow-blocking position. Flow blocking position can include effectively complete blocking or partial blocking according desire or need. The valve is actuated by a magnetic field from what will be called an “off-board” source of magnetic force, as opposed to an “on-board” source of magnetic force. In comparison, as discussed above, an integrated solenoid on a solenoid flow valve such as FIGS. 1A-B and 1C is an example of an on-board source of magnetic force. A key aspect of the invention is that the field source is not integrated into our valve but happens external to it. The off-board source of a magnetic field can be an existing variable magnetic field source, for example that provided by a permanent magnet, and does not have to be dedicated only to valve actuation. The off-board source could be other sources or generators of magnetic fields sufficient to move a magnetic valve actuator in our fully automatic valve. For example, the off-board magnetic field source could be an electromagnet that produces a varying magnetic field. Another example of an off-board source is permanent magnets added to oscillating or rotating parts that are external to our valve to produce a varying magnetic field at the magnetic actuator of our valve based on proximity and polarity of the permanent magnet(s). An example of a magnetic valve actuator for our valve is one that includes at least in part permanent magnet material or ferromagnetic material that responds to the off-board magnetic field when its magnetic force is sufficient. As indicated, the off-board magnetic field source can be dedicated to operation of our valve, but it could have other functions, including other primary functions. Non-limiting examples are discussed herein, including with respect to an magnetocaloric heat pump that utilizes rotating permanent magnets to induce magnetocaloric effect for the heat pump; but also needs to control the flow of heat transfer fluid in a manner synchronous with each magnetocaloric cycle as a part of the heat pump process.

In most embodiments of the invention, some type of restoring force is utilized to urge our magnetic actuator to a normal or non-actuated position in the valve body relative to a valve seat or seal. One non-limiting example is a spring. Another is gravity. Its characteristics can be selected by the designer according to desire or need (e.g. in the case of springs, characteristics including type, material, compression versus tension, and spring constant) for a given application.

A fundamental design criteria for at least many embodiments according to the invention is the relationship between the on-board magnetic actuator and restoring force, and the off-board magnetic field. In at least many applications according to the invention, this relationship can be established by solving the following equations:

$${F}_{m} = M \times dH / dx \qquad ( 1 )$$

where Fₘ is the magnetic force, M is the total magnetization of the magnetic actuator, H is the strength of the magnetic field, and x is the distance between the source of the magnetic field and the center of the magnetic actuator.

$${F}_{s} = {F}_{m} \qquad ( 2 )$$

where Fₛ is the restoring force. If the restoring force is a spring, Fₛ=−k×d, where k is the spring constant and d is the maximum distance of movement of the magnetic actuator from its initial position to a second actuated position. If the restoring force is gravity, Fₛ=m×g, where m is the mass of the magnetic actuator and g is the acceleration of gravity at the surface of the earth. Solving these two equations (1) and (2) will provide the threshold for moving the magnetic actuator from its initial or neutral position.

As will be appreciated by those skilled in the art, the designer can select the configuration of the valve components and their relationships relative to the equations according to need or desire. This allows a variety of design options, as well as scalability up or down in terms of size and characteristics of the magnetic actuator, characteristics of the off-board magnetic field, and selection and characteristics of the restoring force.

In one non-limiting example, a valve according to aspects of the invention has a magnetic actuator which comprises a ferromagnetic (including soft and hard ferromagnetic materials) actuator of any shape in operative connection or coupling to a spring (or other restoring force). The ferromagnetic actuator is placed inside of or in communication with a fluid channel or flow path along a portion considered a valve body. The actuator has a range of motion (ROM) relative to the fluid channel or flow path or within the valve body, typically along an axis (can be linear, but is not limited to linear), but is also typically held at or towards one end of the ROM (an initial position) by the spring or other restoring force. The magnetic material of the actuator can be soft ferromagnetic materials or hard ferromagnetic materials (i.e. permanent magnets), or combinations of the same. When there is a small magnetic field gradient, or in the absence thereof, at the magnetic material actuator, the spring or other restoring force keeps the magnetic actuator at a specific initial position which can either allow or block flow of a flowable media. Allowing and blocking can vary continuously between maximum allowable and completely blocked flow area, such as if restriction instead of complete blockage or maximum allowable flow is/are desired. The designer can select the parameters of magnetic actuator (e.g., form factor, total magnetization, mass, etc.), the valve body, flow path, and seat or seal (e.g. form factors, position, orientation relative the off-board generated magnetic field, etc.), and restoring force (e.g., type, restoring force, form factor, etc.); all in relation to the component(s) and characteristics of the off-board generated magnetic field that influences movement of the magnetic actuator in the valve body (e.g., type of magnetic field generated, magnetic gradient over time, position relative the magnetic valve and magnetic actuator, frequency of operation, etc.).

For, e.g., springs as the restoring force, when the magnetic field gradient is raised above a certain threshold, a magnetic force, proportional to the gradient of the magnetic field and the total magnetization of the magnetic actuator as described by equation (1), is exerted on the magnetic actuator in the direction opposing the force from the spring. When the magnetic force overcomes the spring force defined by Hook's law, the actuator moves along its ROM displacing the spring in a way that increases the restoring force provided by the spring. The maximum displacement occurs when either the motion of the actuator is mechanically stopped by the design of the valve or the magnetic attraction force balances the spring's restoring force. Either method can be used to size the opening for the fluid flow. When the magnetic field gradient is reduced, the spring drives the magnetic actuator along its ROM back to its original initial position. The displacement of the magnetic actuator along its ROM can be controlled by tuning the balance between the magnetic force and the spring force.

For tension springs as the restoring force, when the magnetic field gradient is raised above a certain threshold, a magnetic force, proportional to the gradient of the magnetic field and the total magnetization of the magnetic actuator, is exerted on the magnetic actuator in the direction opposing the force from the spring. When the magnetic force overcomes the spring force defined by the Hook's law, the actuator moves along its ROM away from the spring, tensioning it. The maximum displacement occurs when either the motion of the actuator is mechanically stopped by the design of the valve or the magnetic attraction force balances the spring's restoring force. Either method can be used to size the opening for the fluid flow. When the magnetic field gradient is reduced, the spring drives the magnetic actuator along its ROM back to its original initial position. The displacement of the magnetic actuator along its ROM can be controlled by tuning the balance between the magnetic force and the spring force.

Alternatives to springs are possible as restoring force(s). Non-limiting examples are elastic or resilient materials or members having a change in force (e.g. linear or non-linear) with displacement over the ROM. Another alternative example is use of gravity as a restoring force by positioning the valve with the ROM at least substantially in line with the center of the earth when the valve is in operating position. Other possible alternative examples of restoring force(s) could be centripetal or centrifugal.

For gravity as the restoring force, when the magnetic field gradient is raised above a certain threshold, a magnetic force, proportional to the gradient of the magnetic field and the total magnetization of the magnetic actuator as described by equation (1), is exerted on the magnetic actuator in the direction opposing the gravitational force on the mass of the magnetic actuator. When the magnetic force overcomes the gravitational force on the actuator, the actuator moves along its ROM away from its original or neutral position. The maximum displacement occurs when either the motion of the actuator is mechanically stopped by the design of the valve or the magnetic attraction force balances gravitational force on the actuator. Either method can be used to size the opening for the fluid flow. When the magnetic field gradient is reduced, gravitational force moves the magnetic actuator along its ROM back to its original initial neutral position. The displacement of the magnetic actuator along its ROM can be controlled by tuning the balance between the magnetic force and gravitational force.

As opposed to standard solenoid valves (e.g., US 2017/0175917 A1) that require electrical power to energize an on-board coil to generate the desired magnetic field for actuating the valve, embodiments of this invention place the valve in a position that can be selectively effectively magnetically coupled to an off-board source of a magnetic field. Though the off-board source is not integrated with, and external of the valve body and its on-board internal magnetic material actuator, the off-board source of the magnetic field must be positioned or available to provide an effective magnetic field force to act on the on-board magnetic material actuator of the automatic magnetic valve. Thus, the valve function automatically follows the off-board magnetic field changes without the need for a dedicated control unit even as the frequency of the magnetic field increases or decreases. The off-board source can be an existing variable magnetic field source used for another purpose. Or it can be dedicated to valve operation.

The concepts of the invention can be applied to a variety of different flow control applications. One simple example is to intermittently open and close, or otherwise restrict, flow of a flowable material along a flow path. The external, off-board source of the magnetic field is selectively raised or lowered to effect the desired movement of the magnetic actuator. In one non-limiting example of a water faucet, an off-board proximity sensor can touchlessly sense presence of a human at or near the faucet, and open an off-board electrical circuit connected to generated or battery electrical power, where a portion of the circuit is near enough a magnetic value actuator according to the present invention to generate a magnetic field with enough magnetic force to move the magnetic actuator relative its restoring force. As such, the magnetic valve, without any on-board control circuit or power source, can open a water flow path at least during the sensed proximity (or a predetermined time) of a human at the faucet.

The concepts of the invention can be used for more complex flow control applications. One example related to application with a magnetocaloric refrigerator (as discussed here) is time-varying (from around 1 Hz to 5 Hz) periodic increase and reduction of flow. In principle, a system could be designed to actuate as fast as the off-board magnet can be spun or other varying magnetic field can be switched. For example, in the case of a rotating magnet, a reasonable range for electric motors extends from the everyday value of 60 Hz upwards of 300 Hz. One non-limiting example is the time-varying active magnetic generator (AMR) cycle in magnetocaloric heat pumps. While the concept is readily applied to magnetocaloric heat pump devices, it will be useful for any system that requires coordinated fluid flow in response to changing an existing magnetic field. In magnetocaloric heat pumps, a varying magnetic field is used to induce magnetocaloric effect cycles which alternatively heat up the magnetocaloric materials in the presence of the magnetic field, and cool down the magnetocaloric materials when the magnetic field is removed and/or alternatively heat up and cool down the magnetocaloric materials when the magnitude of the magnetic field increases or decreases respectively. A liquid can be valved during each cycle to pump heat. Thus, in this context, when positioned and configured appropriately, one aspect of the invention can take advantage of that off-board, existing varying magnetic field to automatically control the needed fluid valving in concert with the magnetocaloric cycles. A similar result can be found if magnets are added to a rotating or oscillating device to use it with this type of system—or add permanent magnets to any system that has rotation or oscillation to change a magnetic field. An interesting aspect of the invention is that sets of automatic magnetic valves according to the invention can be synchronized to the off-board magnetic field. In one example, pairs of automatic magnetic valves according to the invention have different unactuated states (e.g. one normally open (NO) and the other normally closed (NC)). The pair can be positioned relative to a time-varying off-board magnetic field to actuate synchronously (e.g. close and open) or in some tuned offset in timing. In the example of AMR, a slight offset in actuating such a pair of valves is effective for each AMR cycle; namely, coordinating the timing with the fluid flow needed for each AMR cycle.

Several examples of applications of aspects of the invention have been discussed earlier, including but not limited to tamper-resistant valves, valves used with pressure vessels, and remotely located valves. A few other non-limiting examples where a valve operated by an off-board permanent magnet or other magnetic field source can be useful include: a faucet; a sprinkler; a concealed mechanism to control flow of a gas or a liquid, including flammable and corrosive, and in a plastic pipe. For example, in the context of a faucet or sprinkler, the external off-board magnetic field can be introduced to open or close a tamper-resistant valve that has no visible means of operation (e.g., a handle or lever). Other non-limiting examples of end-use applications of aspects of the present invention are discussed herein.

As will be appreciated by those skilled in this technical art, the automatic magnetic valve with on-board magnetic material actuator according to the invention can work as a valve to open or close the fluid (or other flowable material) channel or path, including following a time-dependent variation of magnetic field created by an off-board dedicated or existing variable magnetic field source, including but not limited to a rotating or reciprocating bar, block or horseshoe magnet, or any rotating permanent magnet array derived from a standard Halbach-like arrangement. When the valve is placed in the proximity of the off-board magnetic field source, its operation automatically follows the changing magnetic field profile and, thus, is an automatic magnetic valve. Thus, no other control or power unit is needed to operate the valve. Furthermore, this magnetic valve can work for both slowly and rapidly oscillating magnetic fields. Other sources of the off-board magnetic field are possible.

In one aspect of the invention, an automatic magnetic valve comprises:
a. a housing or valve body to direct a flowable material along a flow path through the housing or valve body;
b. an on-board actuator of magnetic material at least in part (magnetic actuator or magnetic material actuator), the magnetic actuator having freedom of movement along the ROM in the housing or valve body and that at least either partially allows or blocks the flow path of the flowable material in response to a first direction and magnitude of an off-board or external magnetic field; and
c. a restoring force or component in or at the housing or valve body that urges or holds the magnetic actuator to or at an initial position and opposes movement of the magnetic actuator caused by the first direction and magnitude of the off-board magnetic field;
d. so that control of flow of flowable material through the housing or valve body can be automatic in response to the off-board magnetic field without requiring any on-board magnetic field source, control circuit, or power connection or source.

Variations of the foregoing valve according to aspects of the invention can include controlling liquid, gas, or solid phase flowable material. The magnetic actuator can be in whole or part of ferromagnetic (soft or hard) material. The restoring force or component can be selected from a variety of techniques or materials or combinations of materials that oppose the off-board magnetic force on the magnetic actuator. The source of the restoring force or component can be selected based on not only consideration of what magnitude of restoring force is needed to urge the magnetic material actuator to an initial position along its ROM relative to the magnitude of any magnetic force from the off-board magnetic field source, but also taking into account any other forces on the magnetic or magnetic material actuator, including but not necessarily limited to, forces on the actuator by the flowable material. As will be further discussed herein, the forces of the flowable material and the restoring force can be aligned, anti-aligned, or oblique (e.g. perpendicular). The direction of the magnetic field gradient determines the direction of the magnetic force on a ferromagnetic material and its relationship to the restoring force is described herein. Magnetic field creating options i.e. including but not limited to a rotating or reciprocating bar, block or horseshoe magnet, or any rotating permanent magnet array derived from a standard Halbach-like arrangement, are possible. Except in very contrived cases, both the magnetic field and the gradient of the magnetic field change direction continuously in the space around these types of magnetic field sources.

In another aspect of the invention, a method of controlling flow of a flowable material comprises:
a. interposing an automatic magnetic actuator along a flow path (along the flow path or at some angle to the flow path as long as it blocks the flow, or at least partially blocks or restricts flow; it can be advantageous to have the actuator perpendicular to the flow path) for the flowable material without any on-board control circuit or electrical power source or even power connection;
b. selecting operating state of the on-board magnetic material actuator to normally-open or normally-closed by configuration of or position of the magnetic material actuator relative to the valve body, flow path, and seat or seal;
c. positioning the valve assembly relative to an off-board or external magnetic field to effectively take advantage of the direction and magnitude of the off-board or external magnetic field; and
d. operatively connecting a flow of the flowable material to the valve assembly.

Variations of the foregoing method can include controlling liquid, gas, or solid phase flowable material. The magnetic material actuator can be in whole or part of ferromagnetic (soft or hard) material. The restoring force or component can be selected from a variety of techniques or materials or combinations of materials that oppose the off-board or external magnetic force on the on-board magnetic material actuator. The restoring force can be selected based on consideration of any force on the magnetic material actuator, including by the flowable material, and the force of the flowable material relative to the restoring force can be aligned, anti-aligned, or oblique (e.g. perpendicular) depending on design. The method can be used to control one or a plurality of automatic magnetic valves with the same off-board or external magnetic field for a variety of end uses or applications. One example of plural automatic magnetic valve control is coordinated fluid flow in a magnetocaloric heat pump.

In another aspect of the invention, a system controlling flow of a flowable material comprises:
a. an off-board or external magnetic field subsystem comprising:
   i. a source of variable magnetic field generating a magnetic force;
   ii. whether or not dedicated to valve operation and/or for an off-board purpose; and
b. an automatic magnetic valving subsystem:
   iii. comprising an automatic magnetic valve assembly positioned in effective proximity to the source of the variable magnetic field for magnetic coupling to an on-board or internal magnetic material actuator in the valve assembly; and
   iv. in operative communication with a source of a flowable material along a flow path wherein the on-board or internal magnetic material actuator of the automatic magnetic valve assembly is positioned relative to the off-board or external magnetic field to effectively take advantage of the direction and magnitude of the off-board or external magnetic field to control flow of the flowable material through the automatic magnetic valve assembly.

Variations of the foregoing system can include controlling liquid, gas, or solid phase flowable material. The magnetic actuator can be in whole or part of ferromagnetic (soft or hard) material. The restoring force or component can be selected from a variety of techniques or materials or combinations of materials that oppose the off-board or external magnetic force on the actuator. The restoring force can be selected based on consideration of any force on the actuator, including by the flowable material, and the force of the flowable material and the restoring force can be aligned, anti-aligned, or perpendicular. The system can be used to control one or a plurality of automatic magnetic valve assemblies with the same off-board or external magnetic field for a variety of end uses or applications. Alternatively, individual automatic magnetic actuators of a plurality of automatic magnetic valve assemblies could each have its own source of off-board or external magnetic field, whether or not dedicated to valving or to both valving and another purpose. End use applications include but are not limited to fluid flow control in a magnetocaloric heat pump or with other subsystems that generate a magnetic field for some function or purpose other than the automatic magnetic valve assembly(ies), where the generated off-board or external magnetic field has a direction, magnetic force, and variation to effectively move the magnetic actuator of at least one of the automatic magnetic valve assemby(ies) along a constrained range of motion.

In another variation and aspect of the invention, what will be called a “magnetic cam” configuration is disclosed. It utilizes the general principles of a magnetic material (e.g. ferromagnetic material) actuator in a valve body that automatically follows an effective off-board or external magnetic field changes to coordinate flow through the valve in response to changes in that off-board or external magnetic field. The main additional feature of a magnetic cam is an off-board or external field introduced and/or removed expressly for the purpose of actuating at least one or more automatic magnetic valves. In one example, discussed herein, magnets are added to rotating parts (as the varying off-board or external magnetic field) for the express purpose of actuating automatic magnetic valves according to aspects of the invention. This would also be the case for other possible dedicated uses of an off-board or external magnetic field, e.g. an elastocaloric heat pump or even a sprinkler valve.

These and other objects, features, advantages, and aspects of the invention will become more apparent with reference to the accompanying description and drawings.

### BRIEF SUMMARY OF THE DRAWINGS

The patent or application file contains at least one drawing executed in color. Copies of this patent or patent application publication with color drawing(s) will be provided by the Office upon request and payment of the necessary fee.

Reference in this written description will frequently be taken to the appended drawings, which are summarized as follows:

FIGS. 1A-B are diagrammatic views of a solenoid valve in normally open state, and a closed state actuated by a magnetic field from an on-board solenoid, respectively, according to prior art principles of an on-board solenoid to actuate movement of a magnetic material actuator element or plunger.

FIG. 2A-B are diagrammatic views of an exemplary embodiment of an automatic magnetic valve according to the invention in normally open state, and then a closed state actuated by an off-board or external magnetic field, respectively, for comparison to the prior art solenoid valve operation of FIGS. 1A-B.

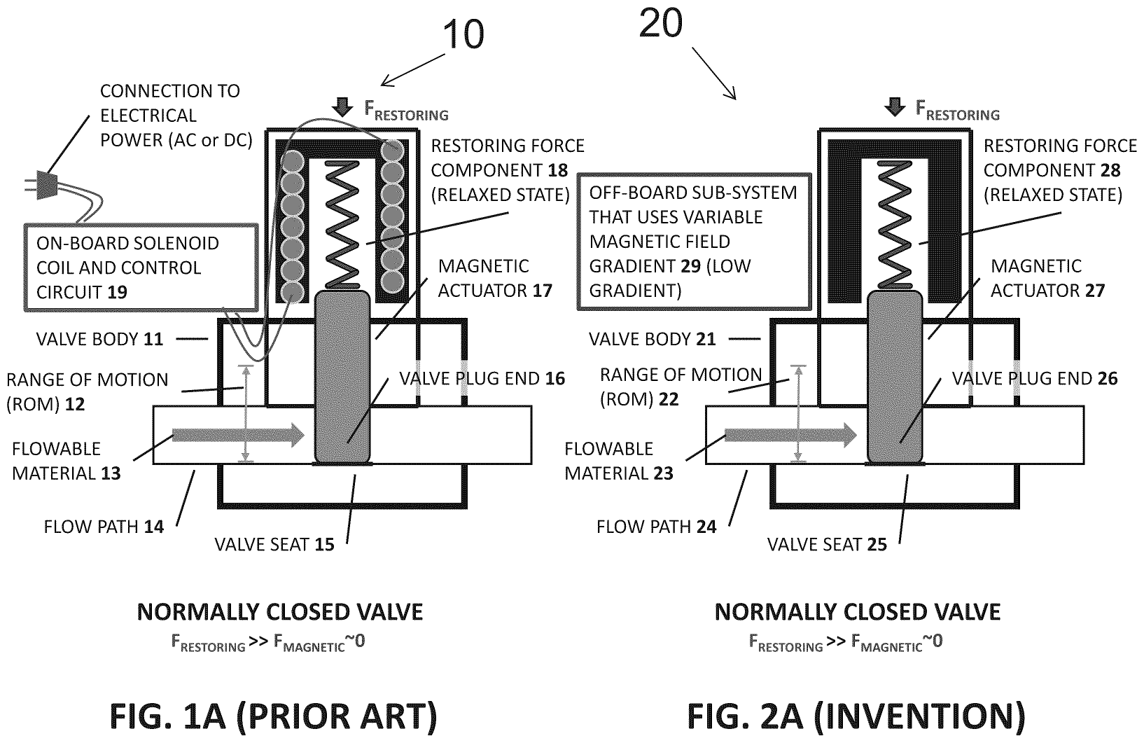

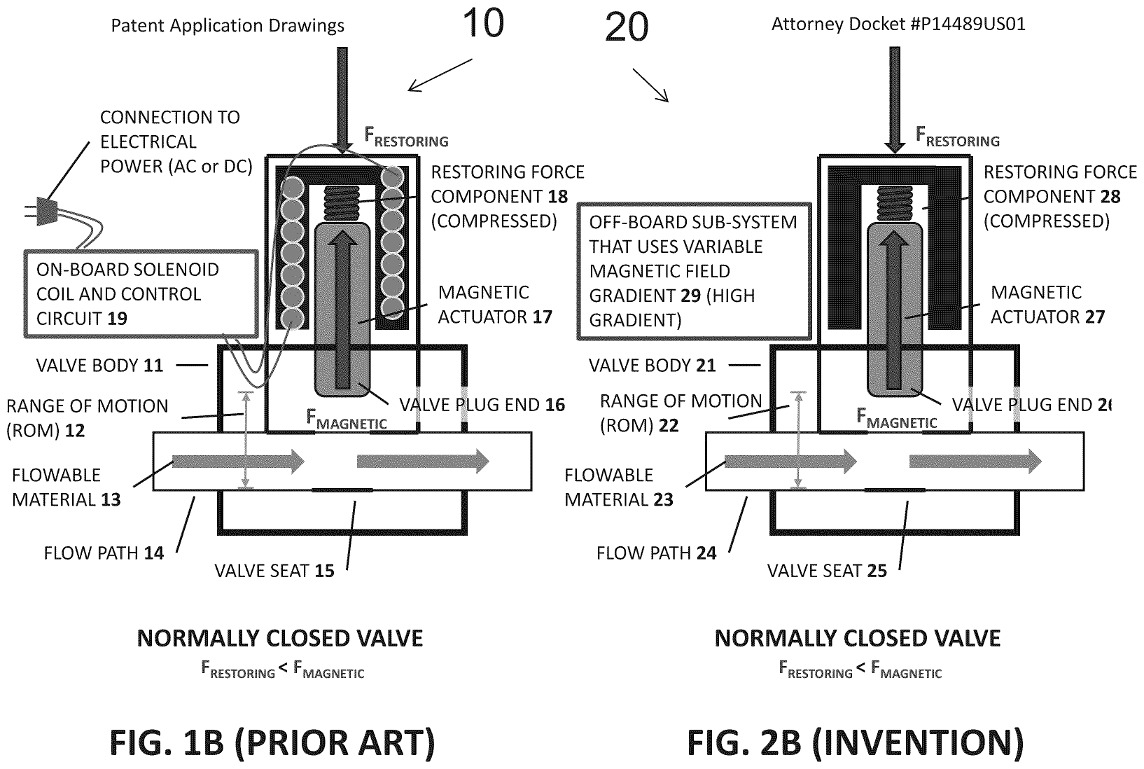

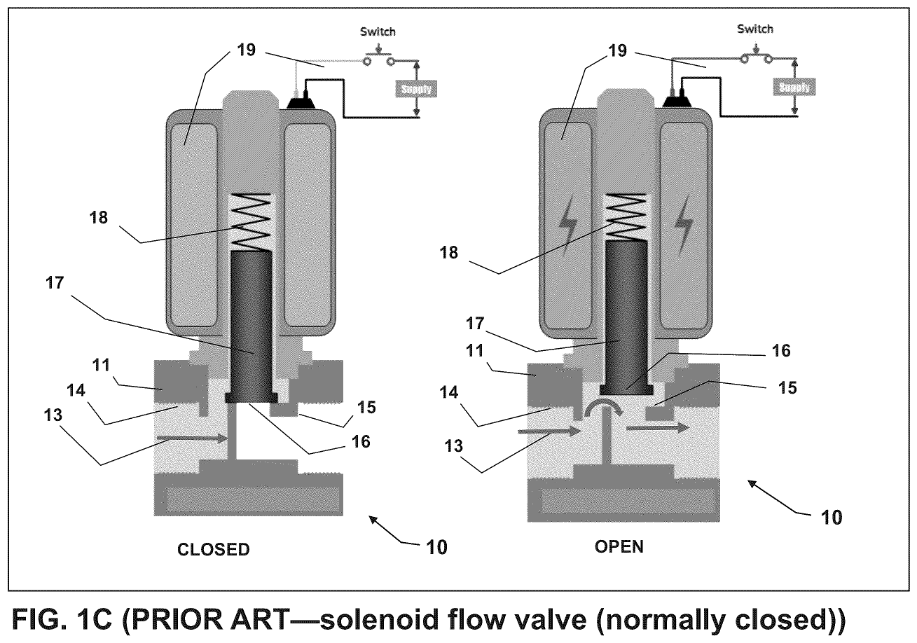

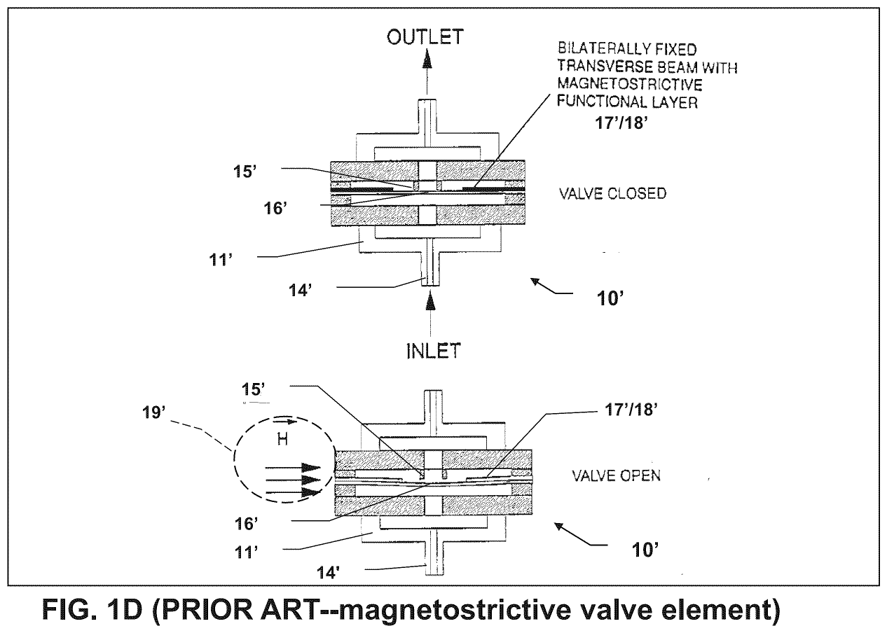

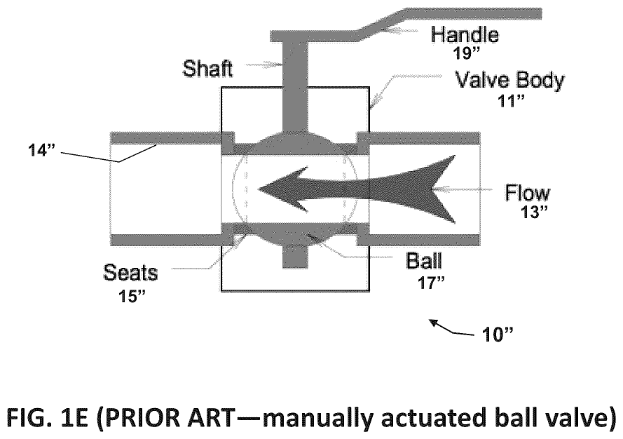

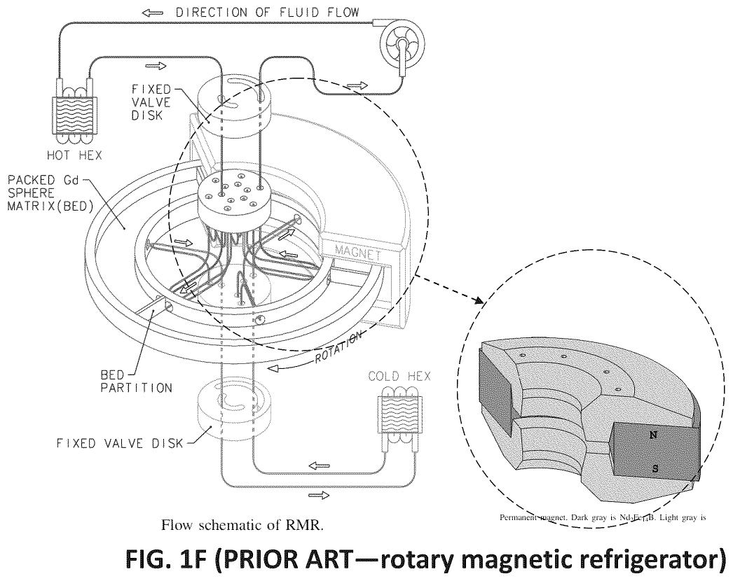

FIG. 1C is further diagrammatic representations of operation of prior art solenoid valves.

FIG. 1D is diagrammatic representations of operation of a prior art magnetostrictive valve which uses a magnetic field to induce magnetostrictive effect in an active magnetostrictive material to function as a valve plug.

FIG. 1E is diagrammatic representations of operation of a prior art ball valve with a metal ball that is manually actuated with an on-board handle.

FIG. 1F is diagrammatic illustrations of one form of a rotary magnetic refrigerator which follows an AMR cycle with beds of magnetocaloric material rotating or reciprocating relative to a magnet, such as is known in the prior art.

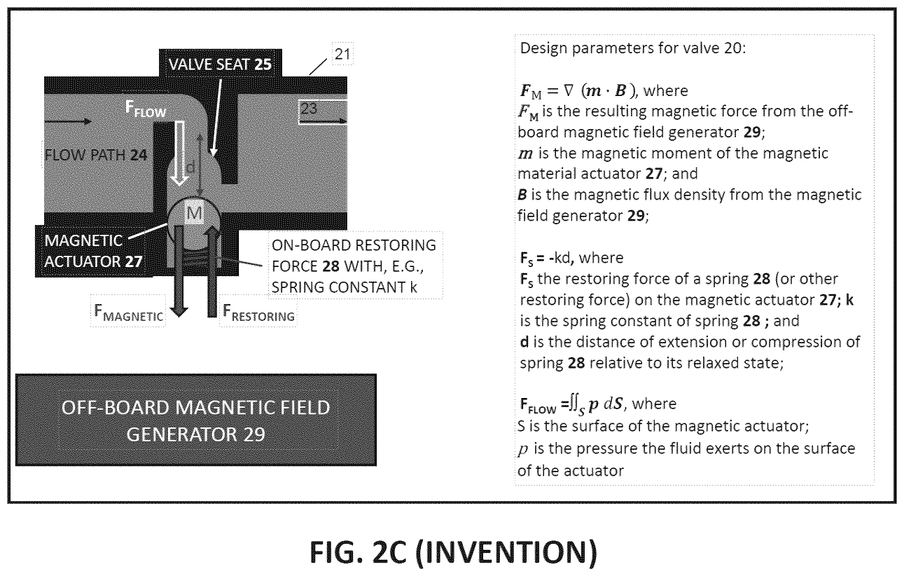

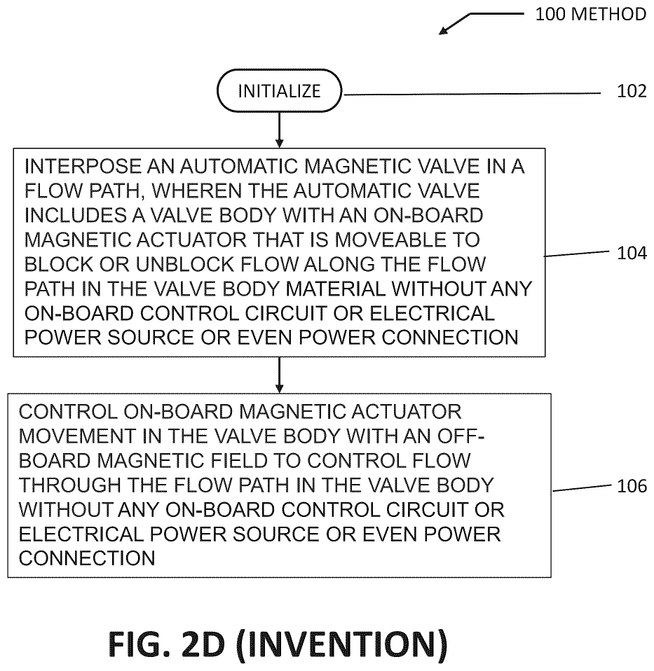

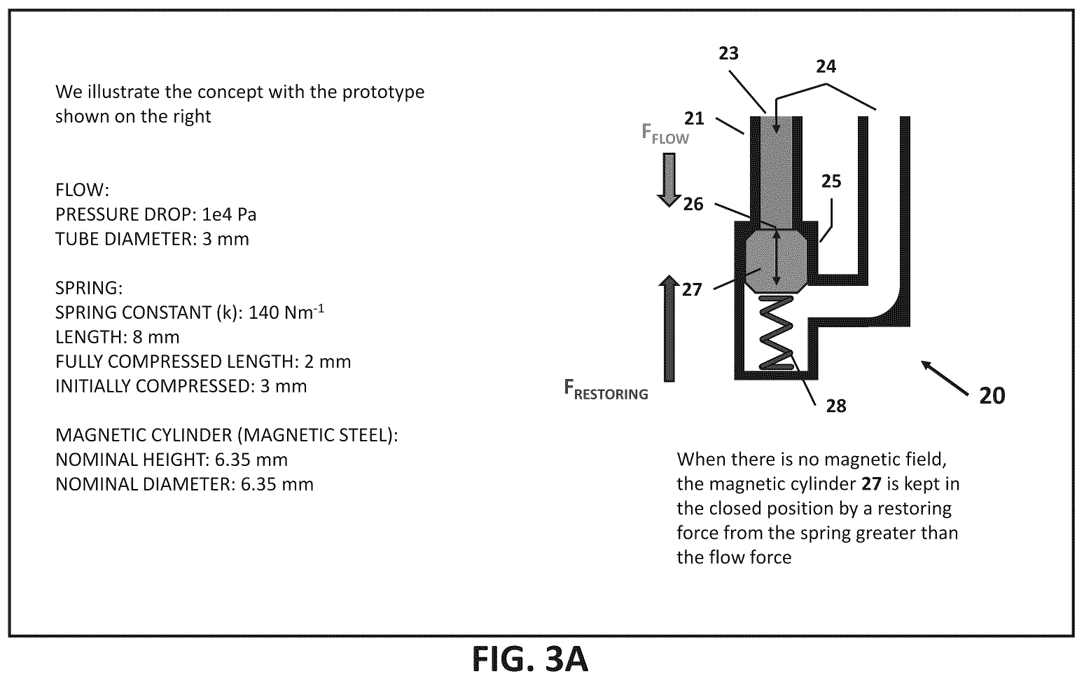

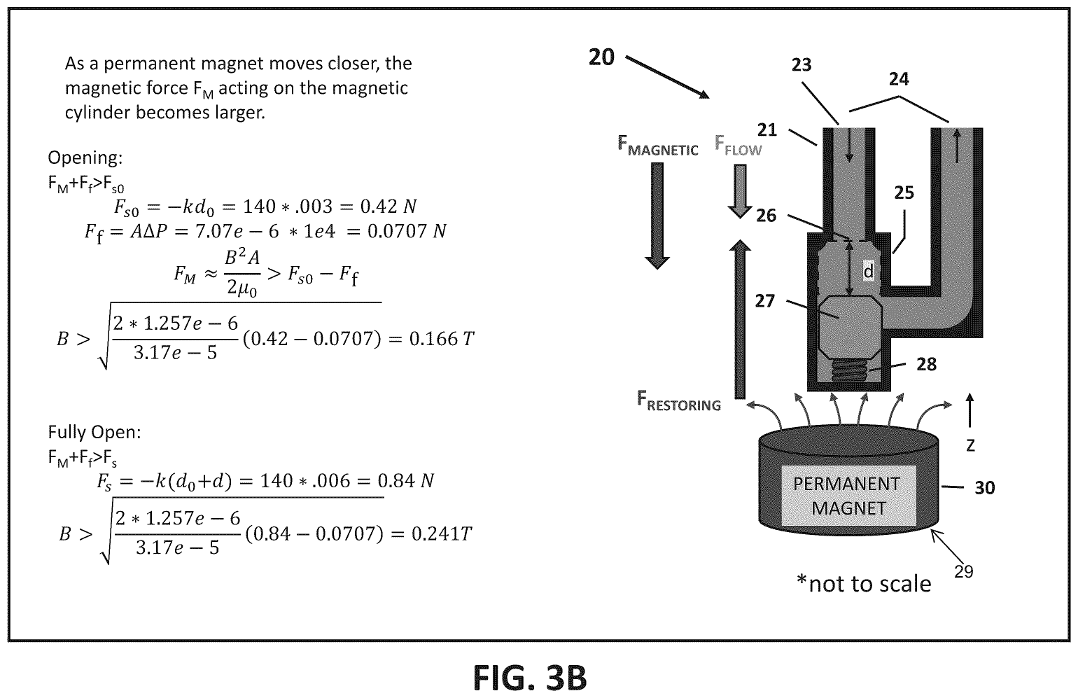

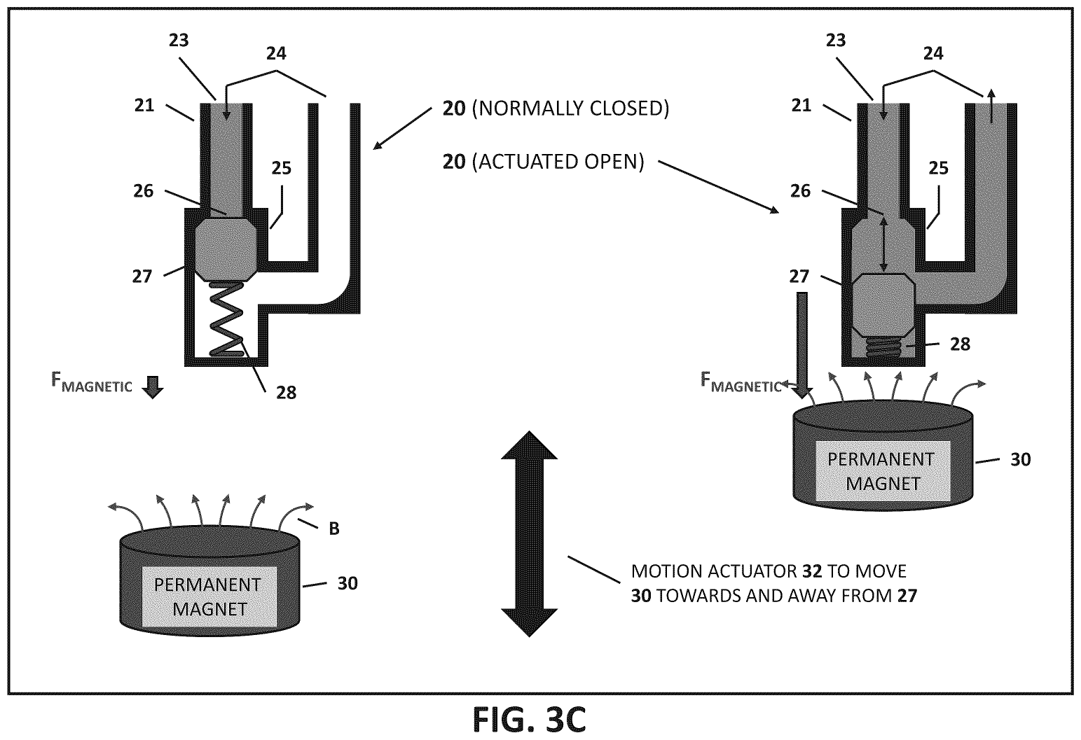

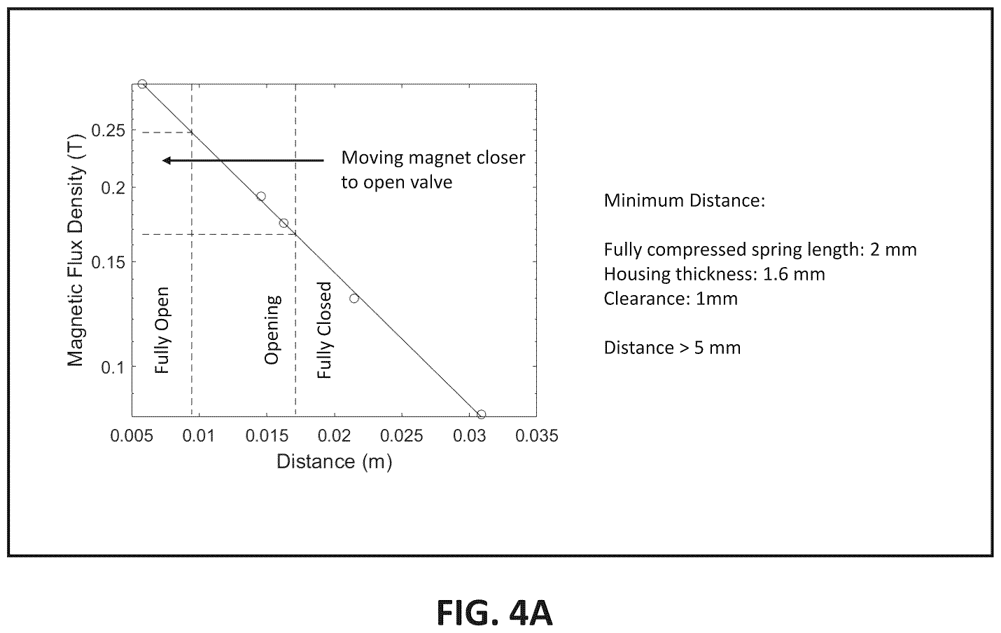

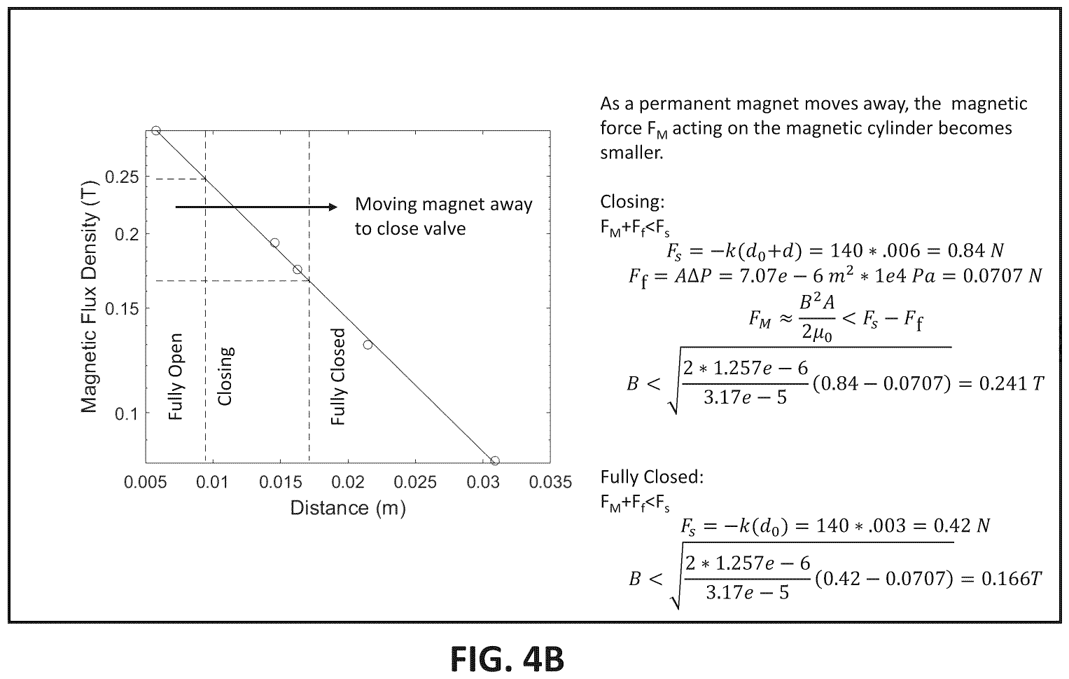

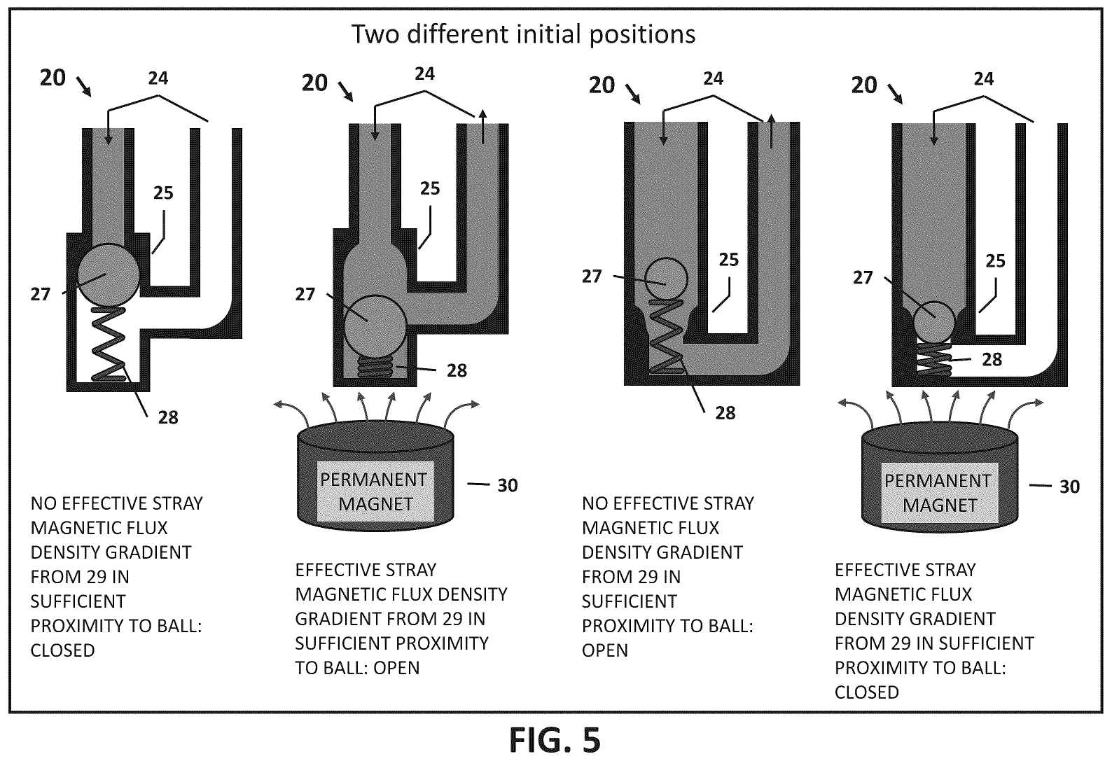

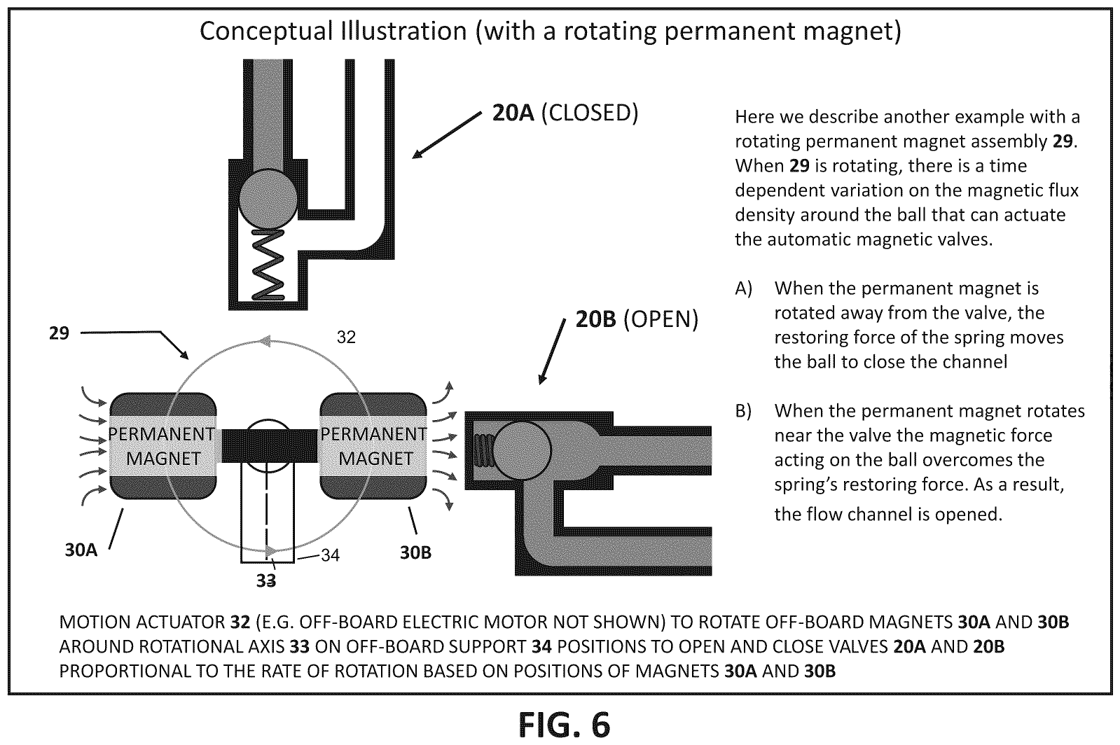

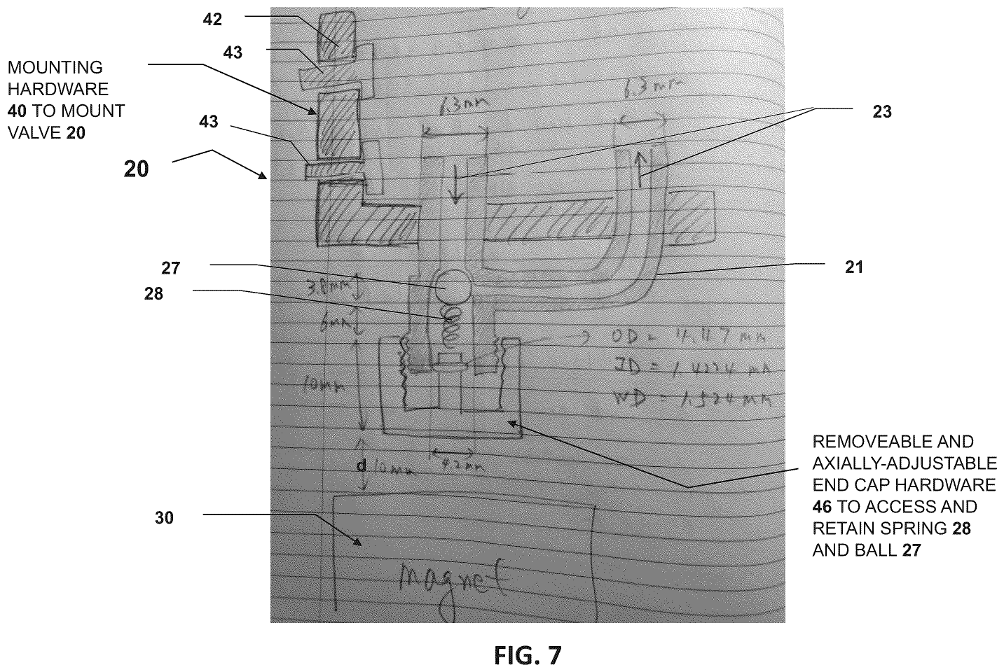

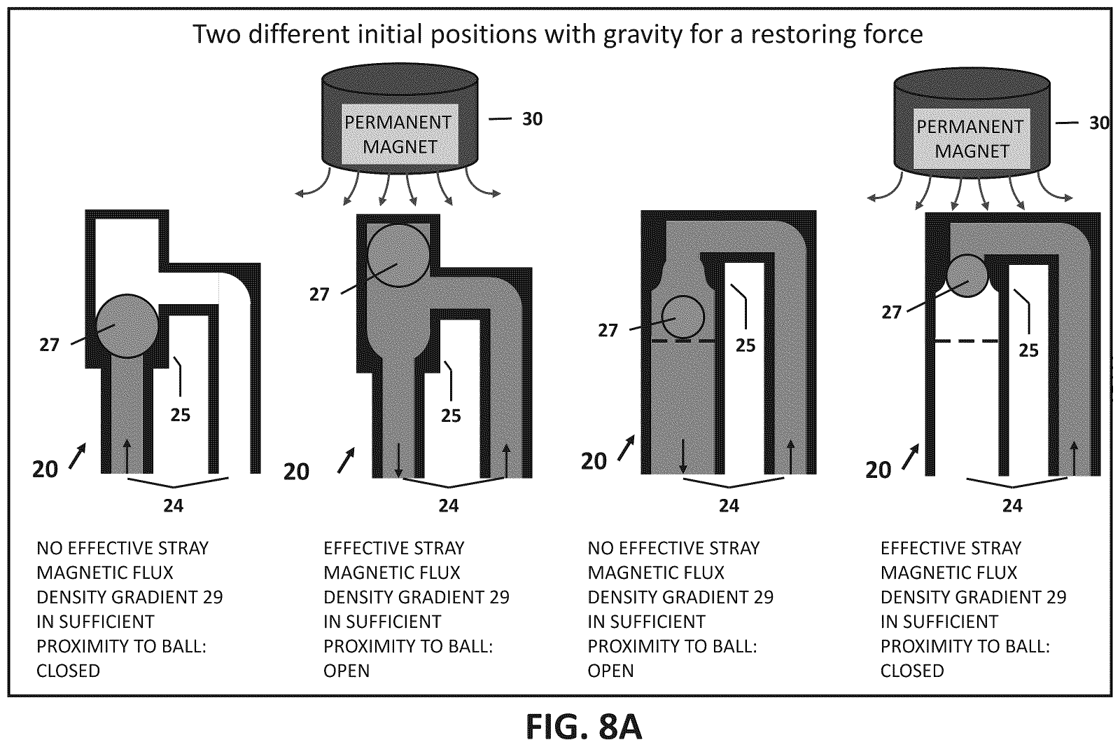

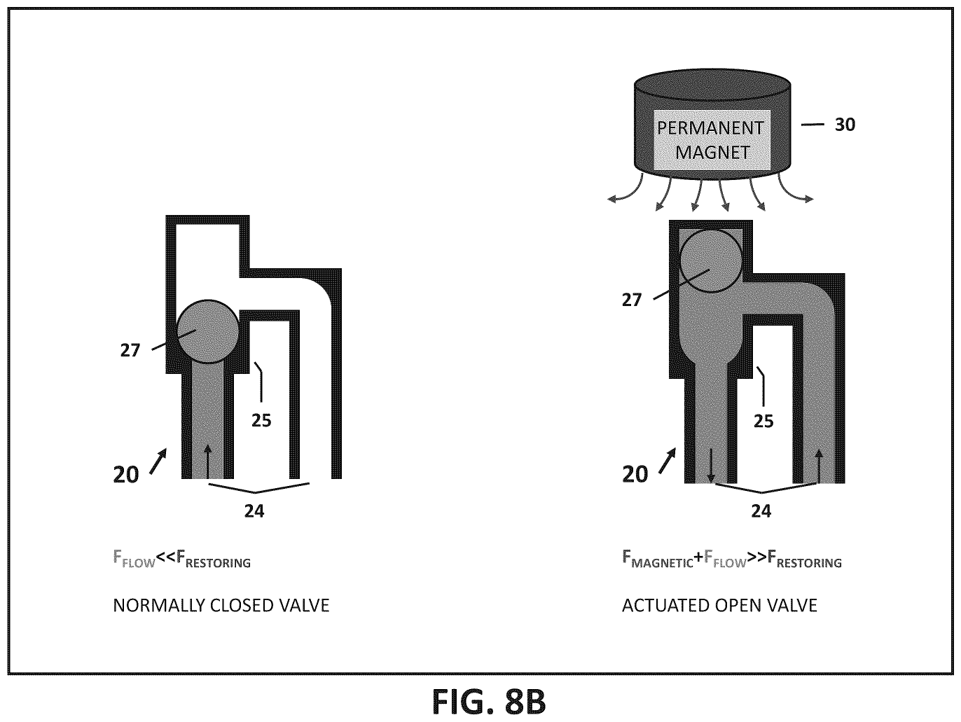

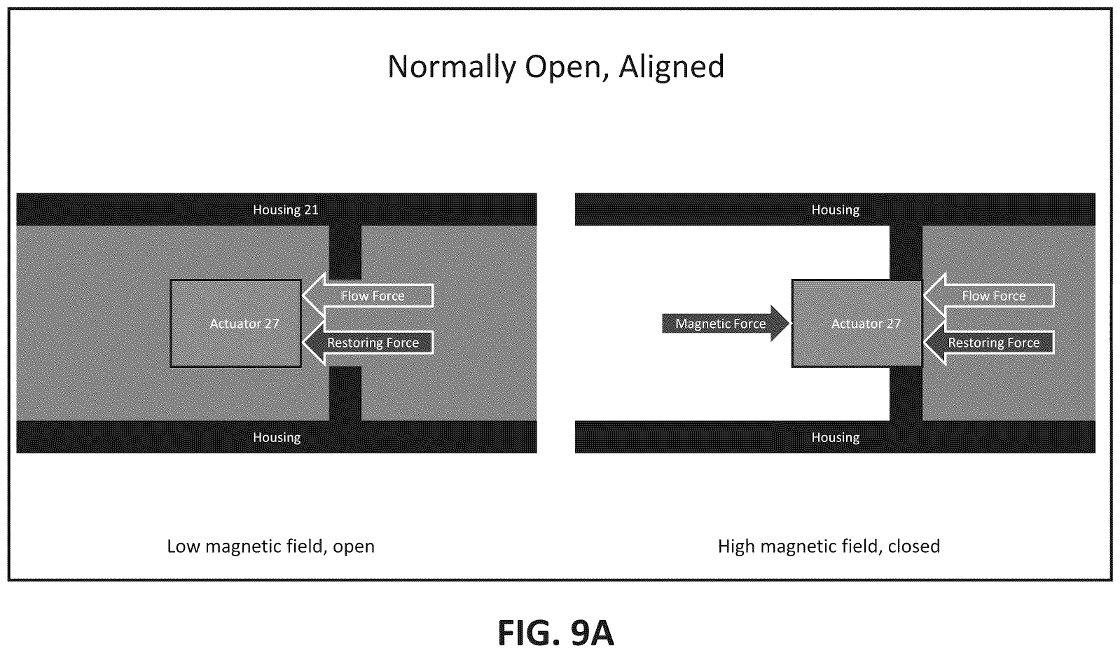

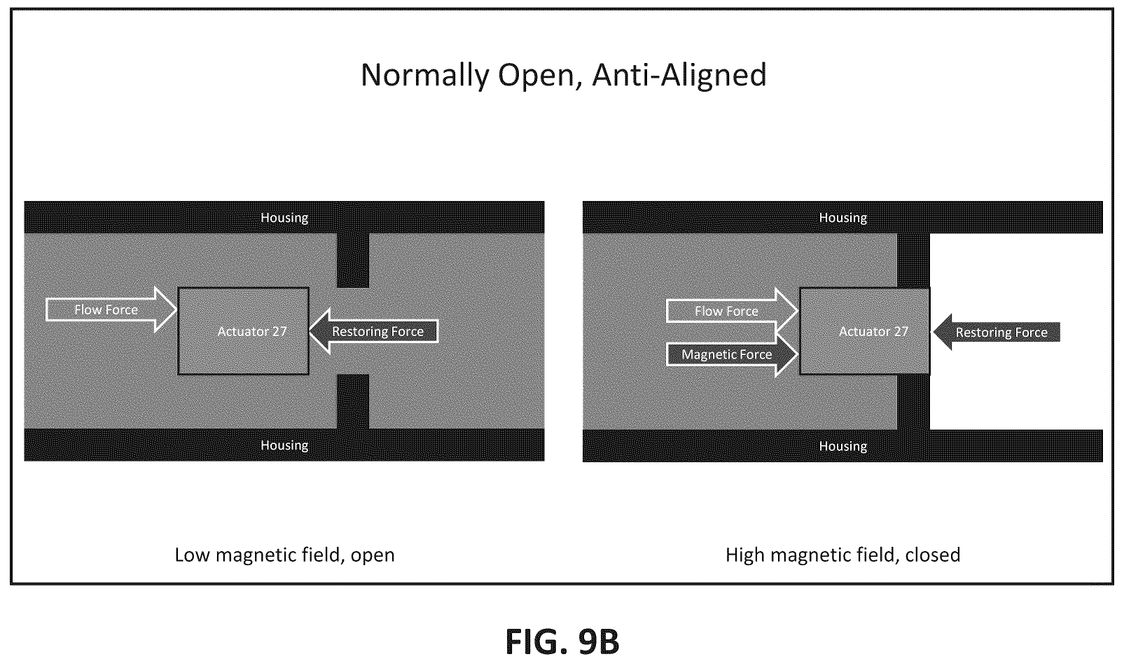

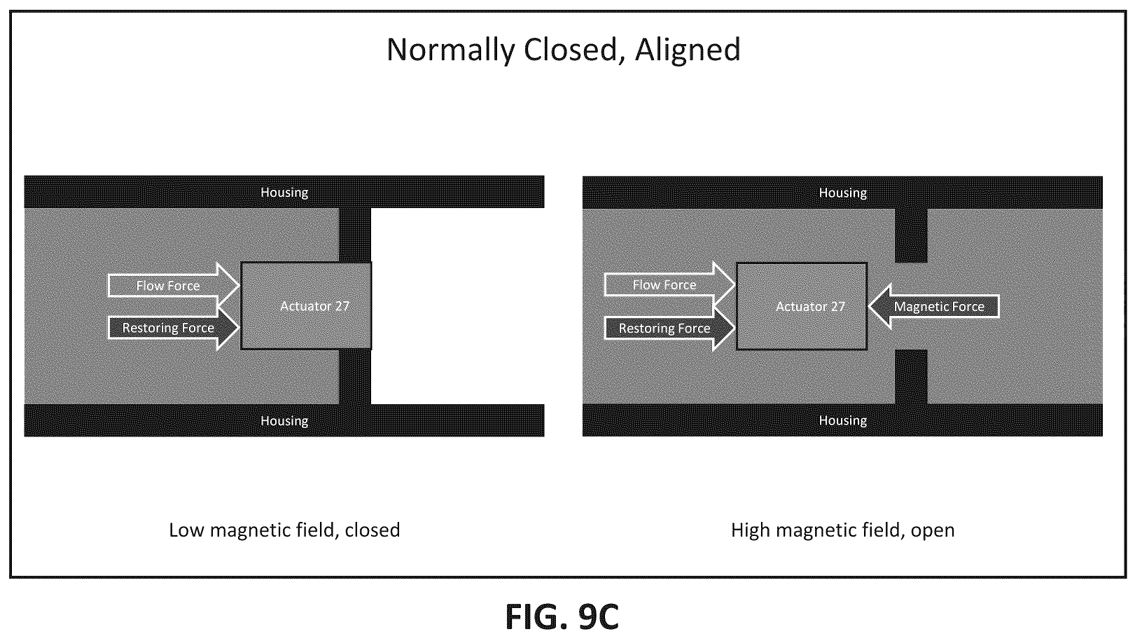

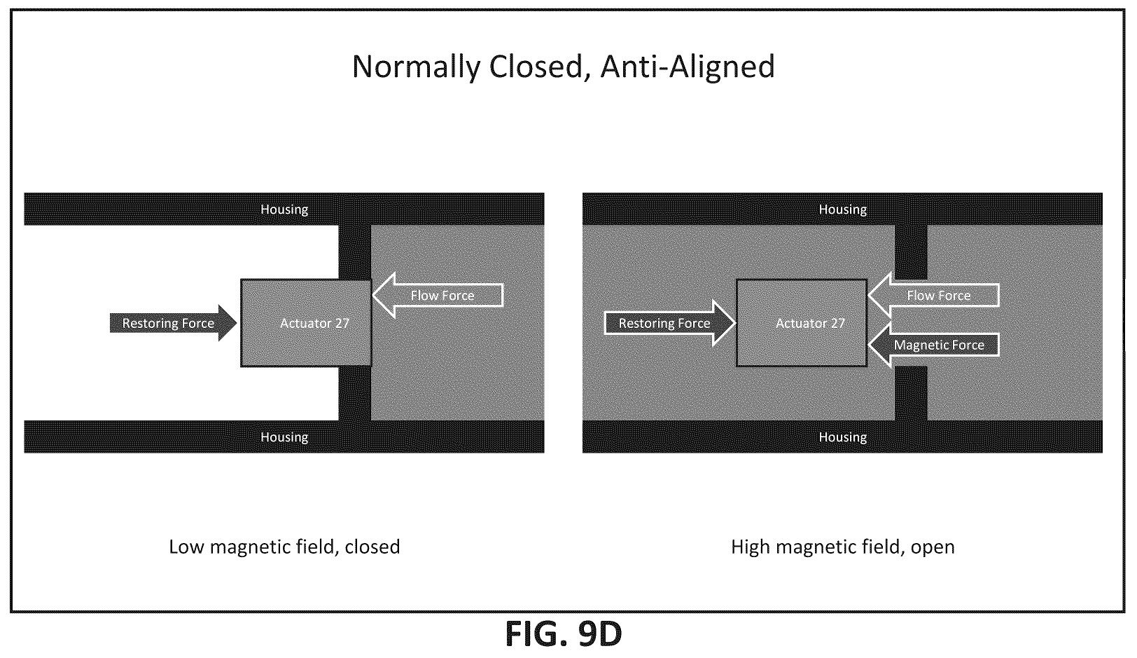

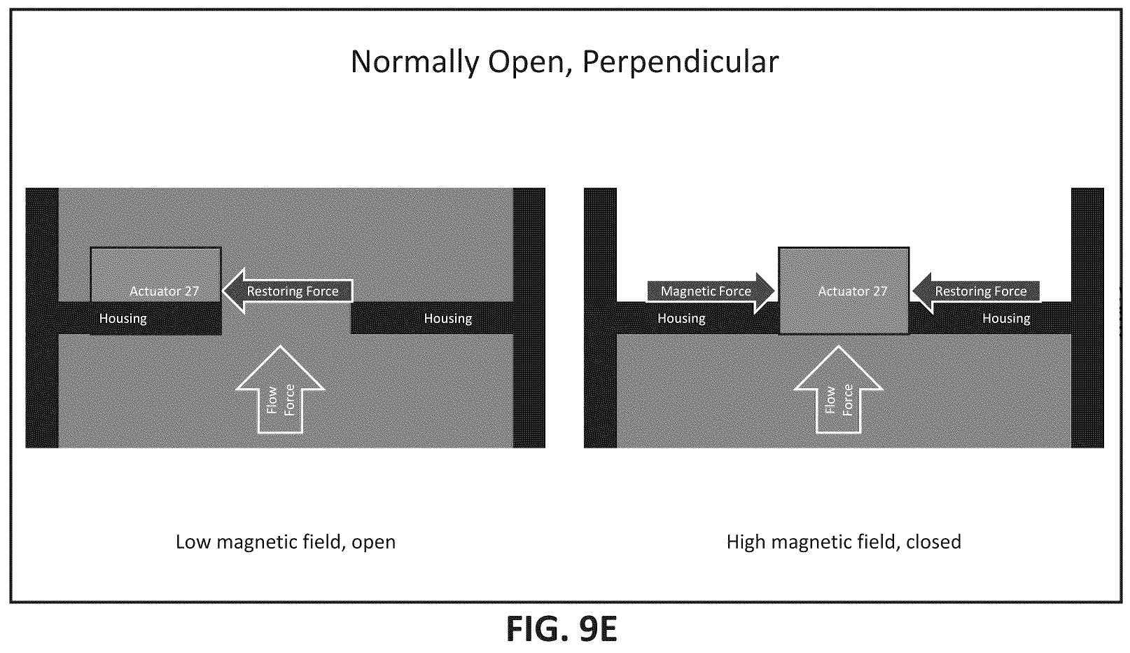

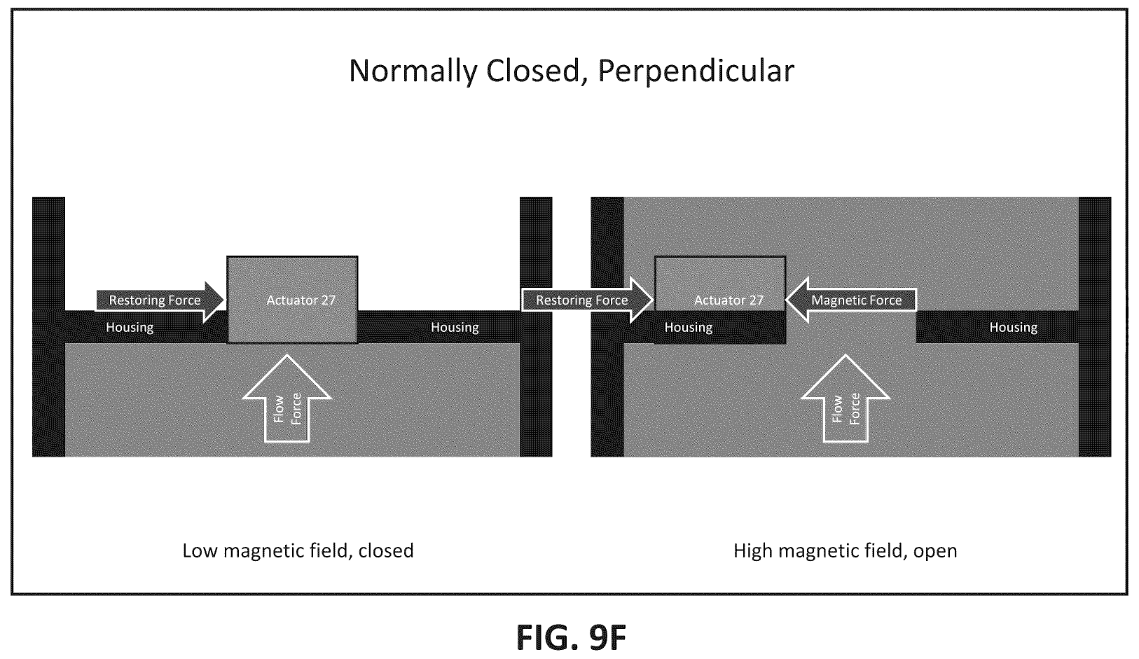

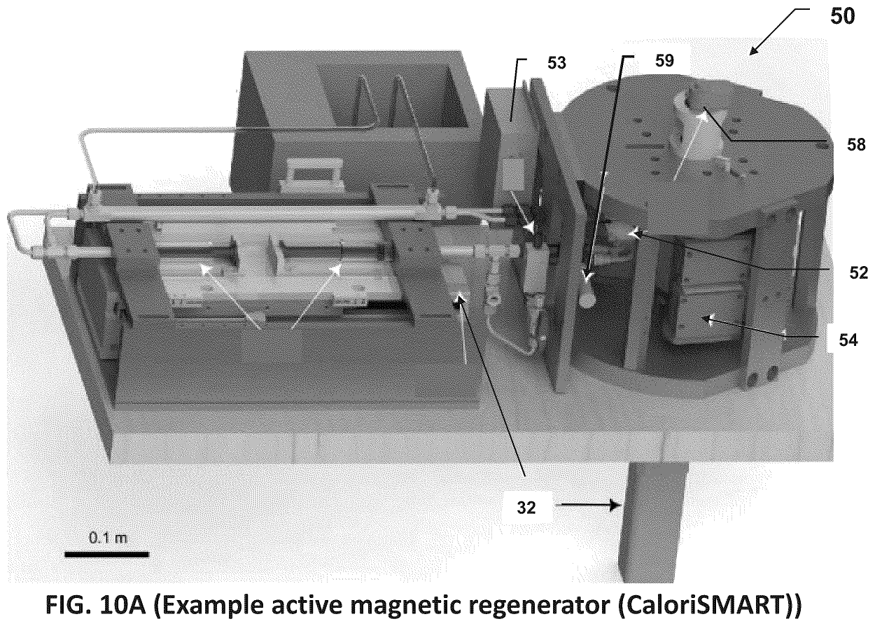

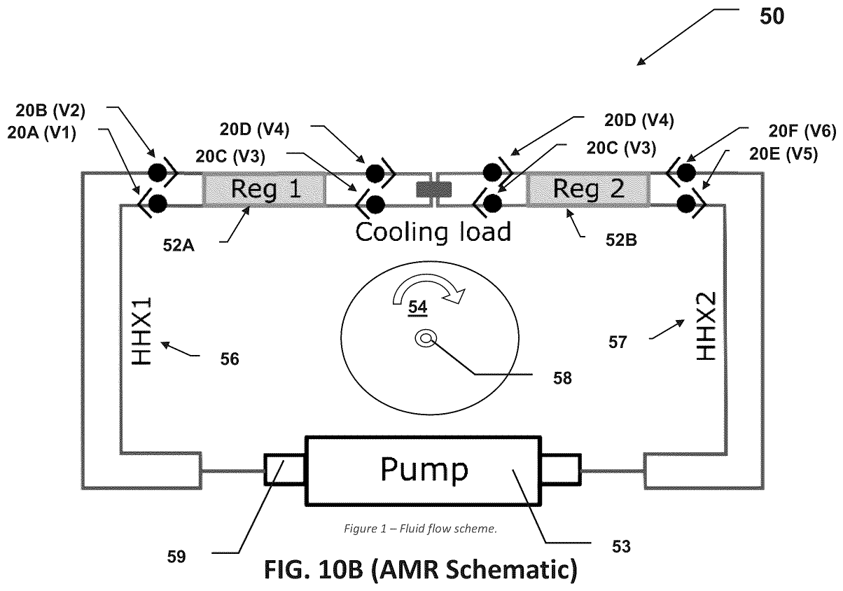

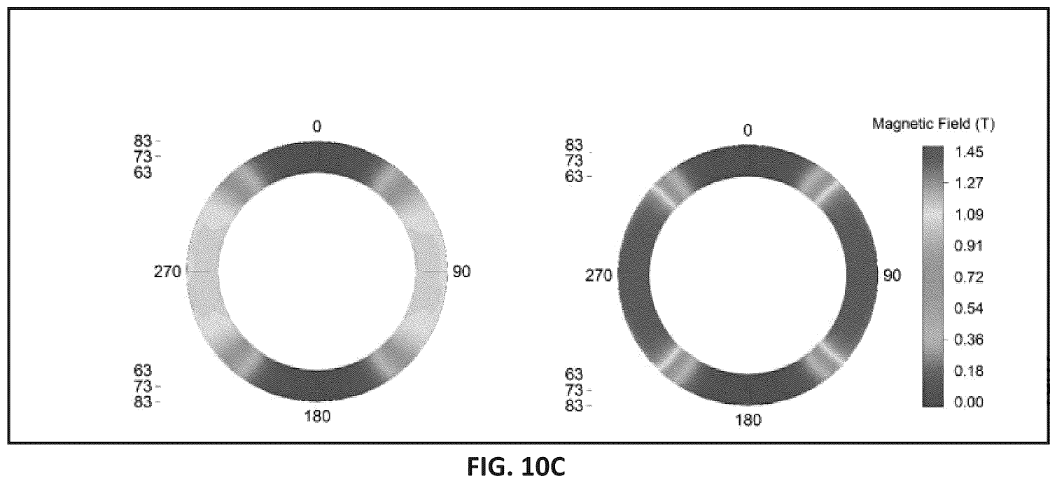

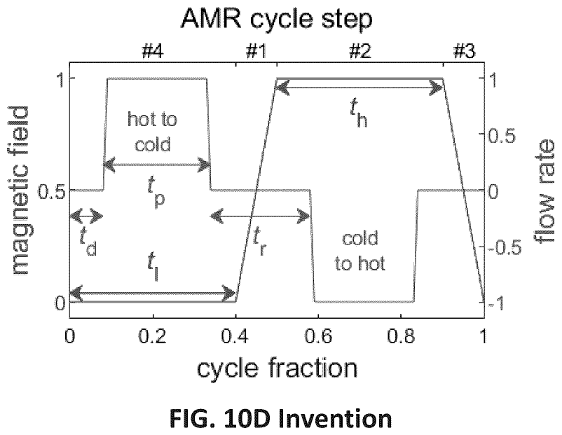

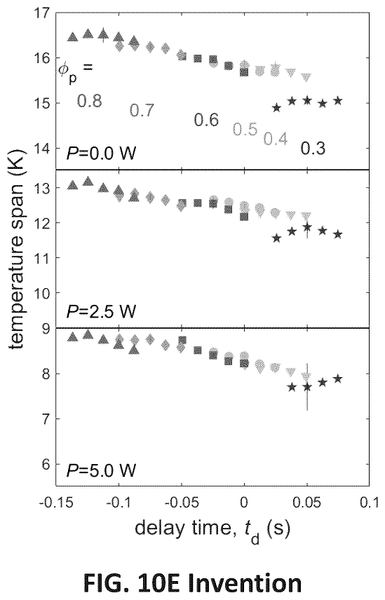

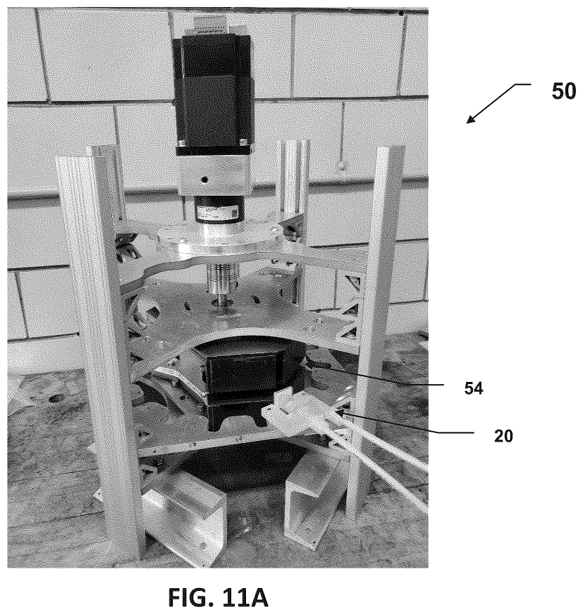

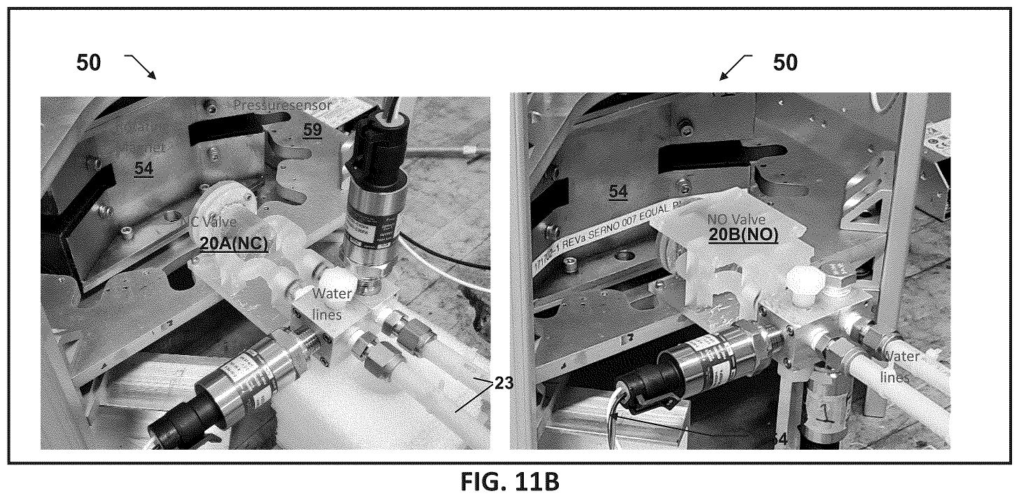

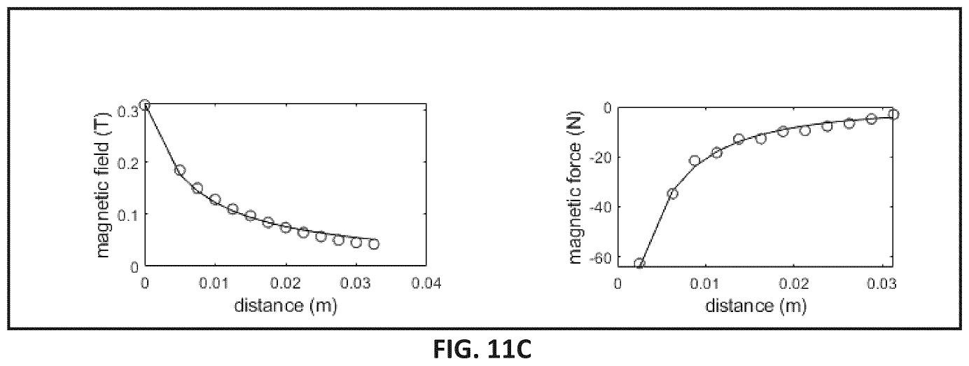

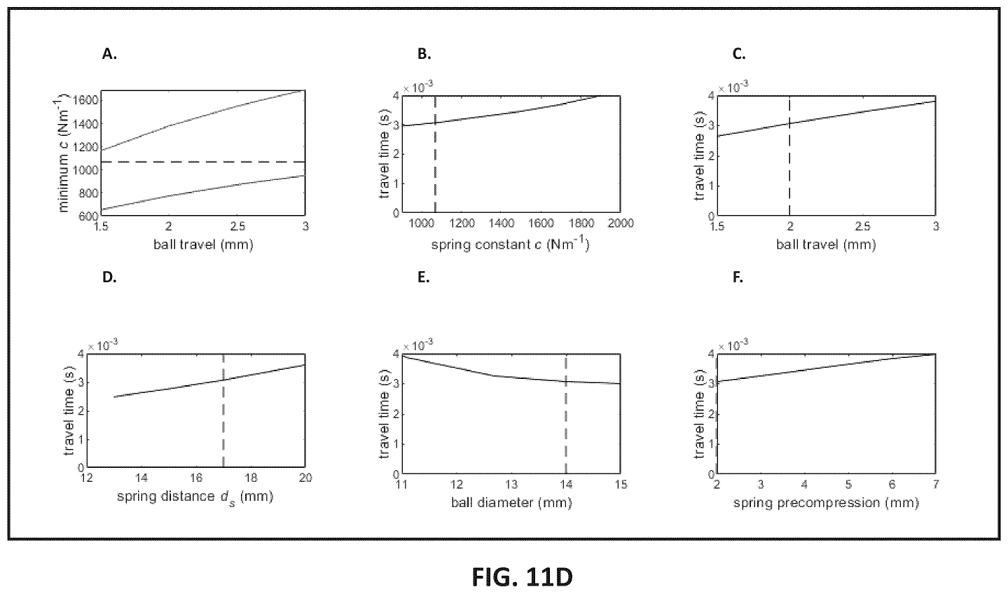

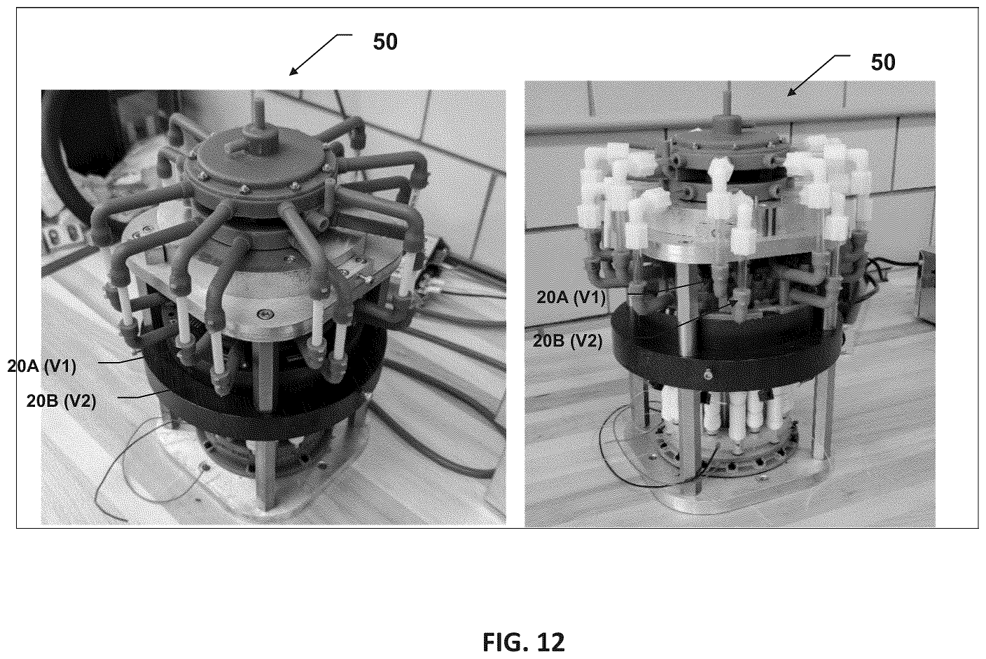

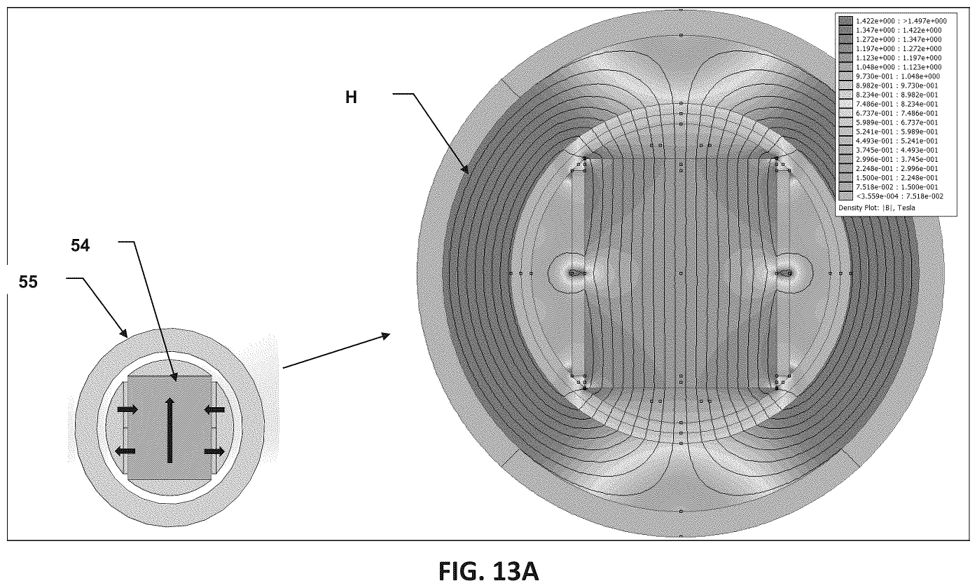

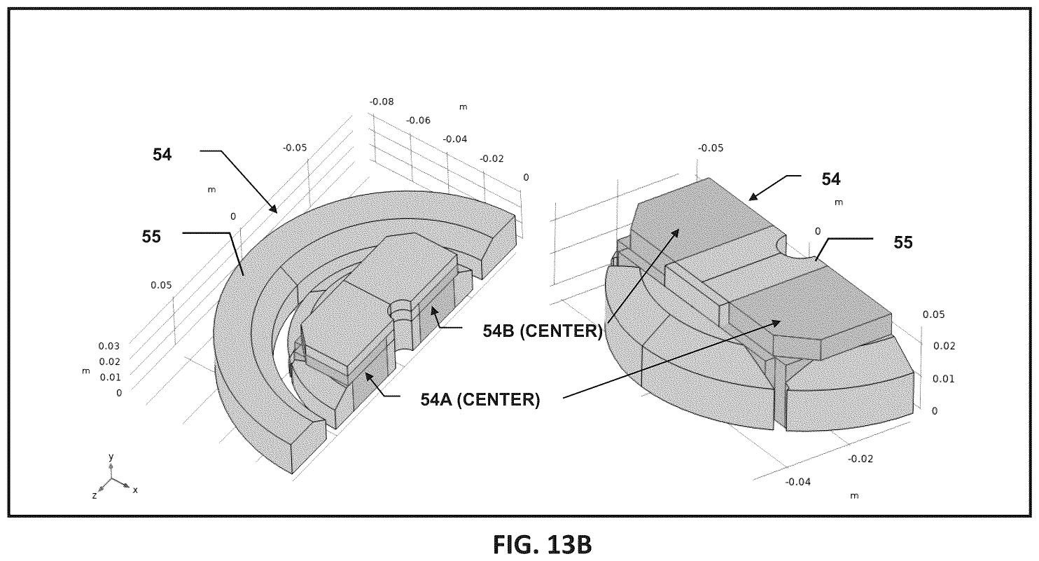

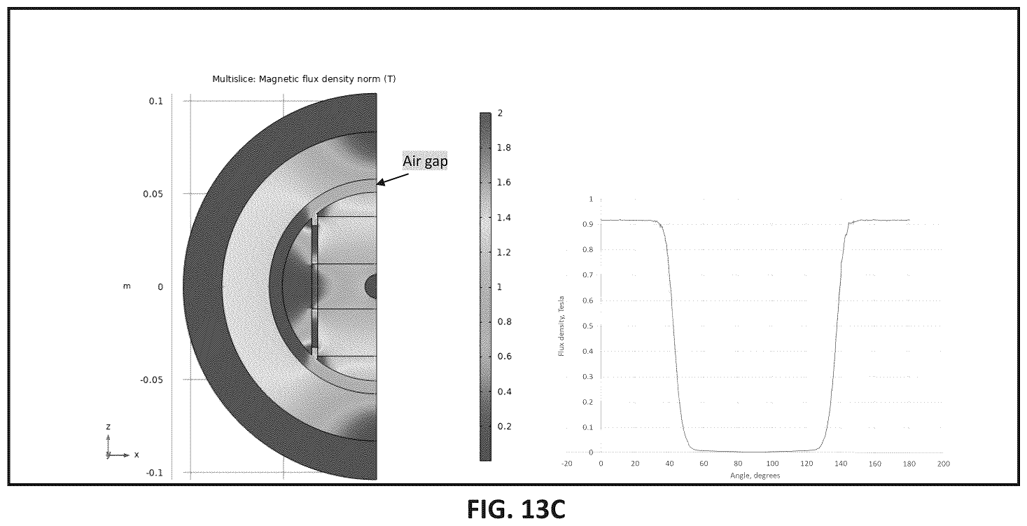

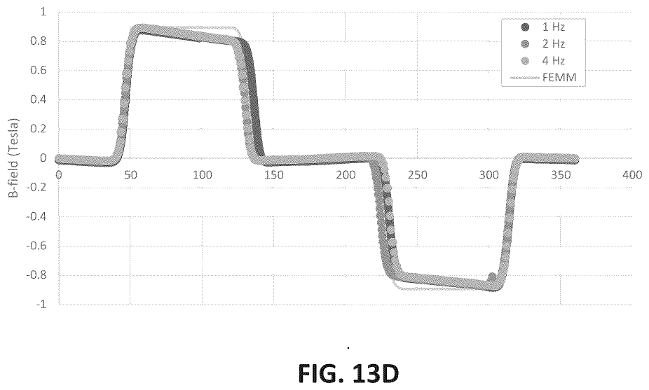

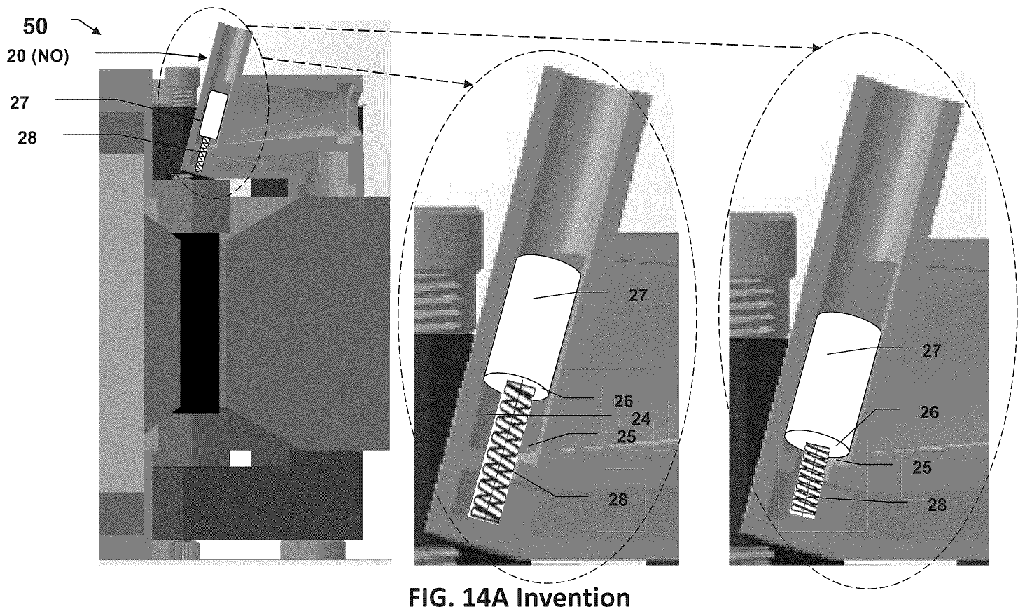

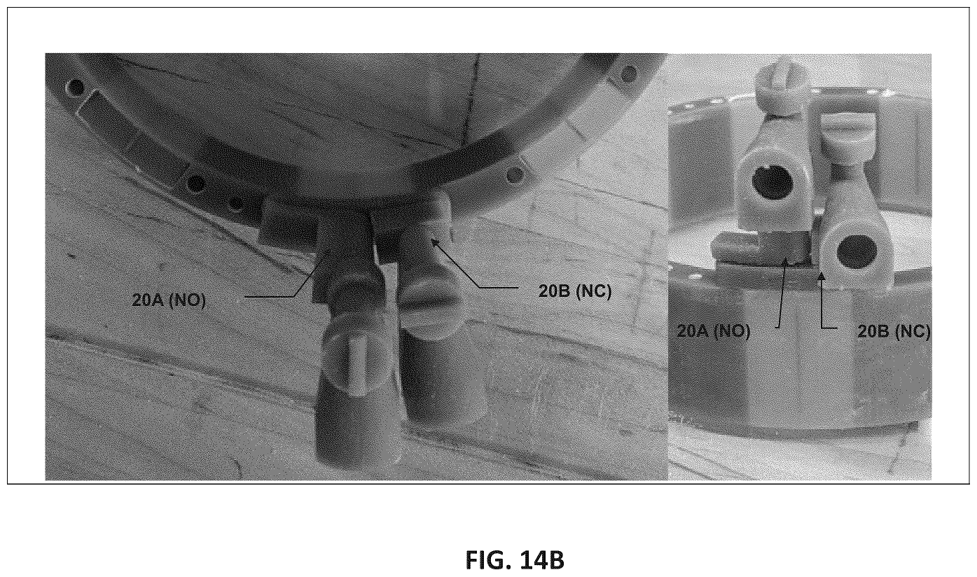

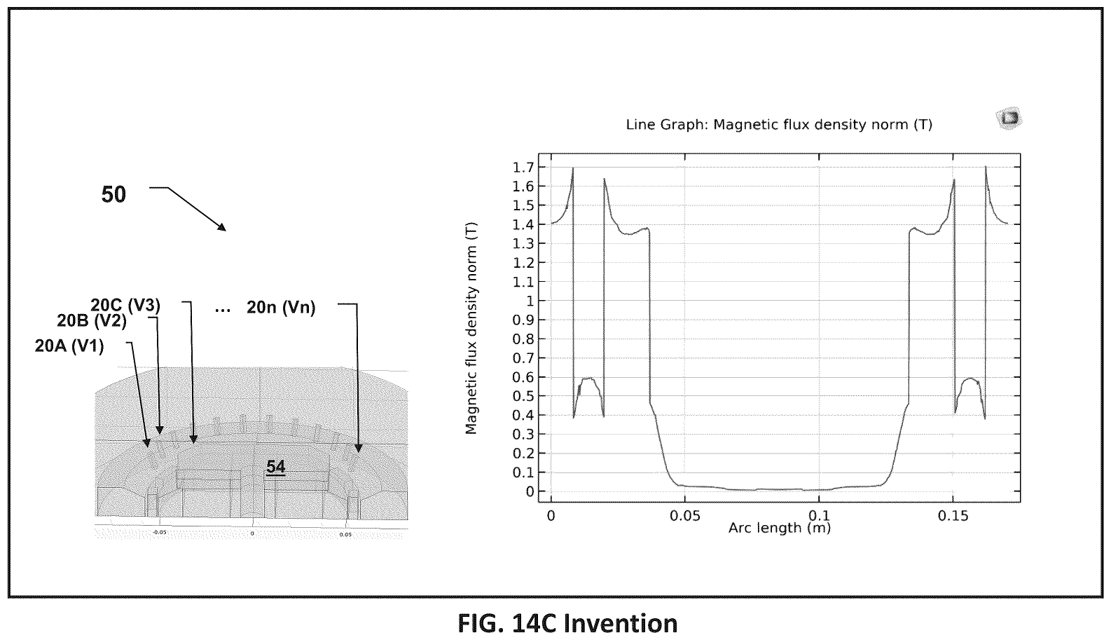

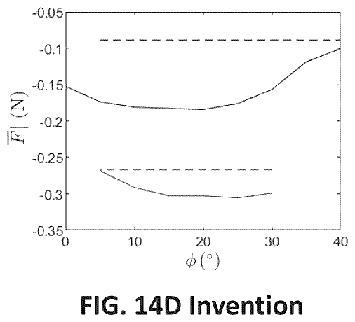

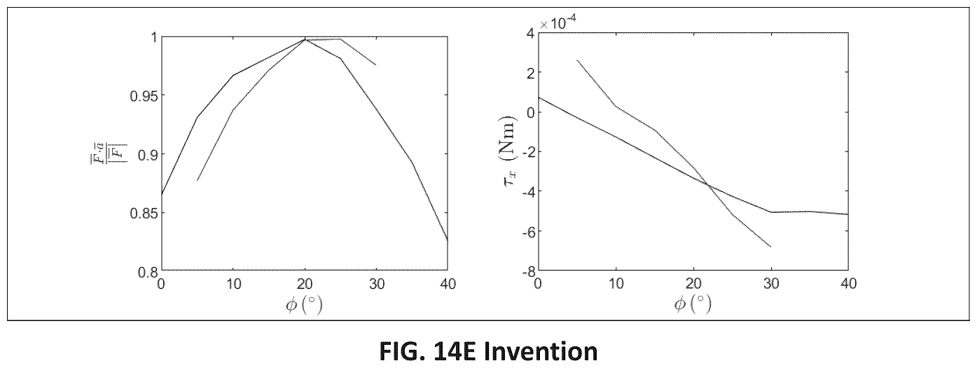

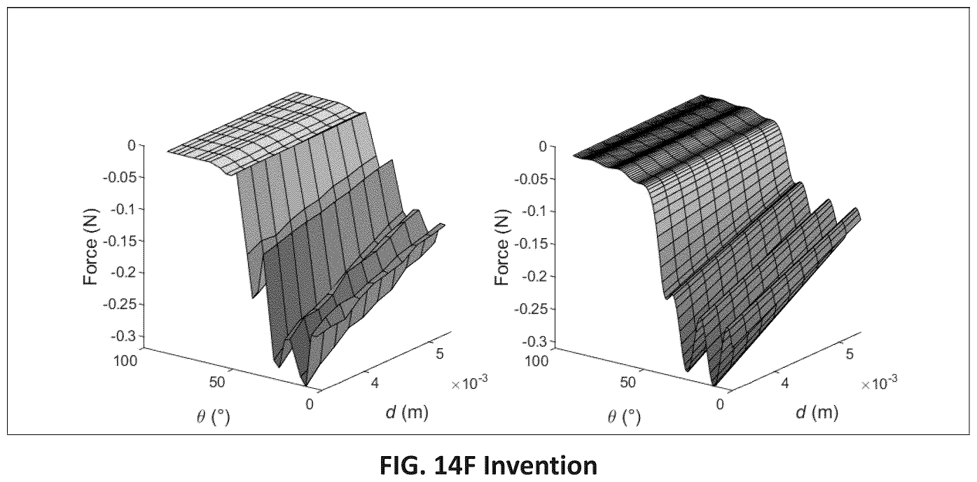

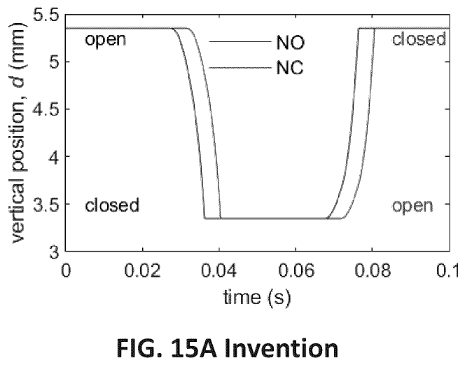

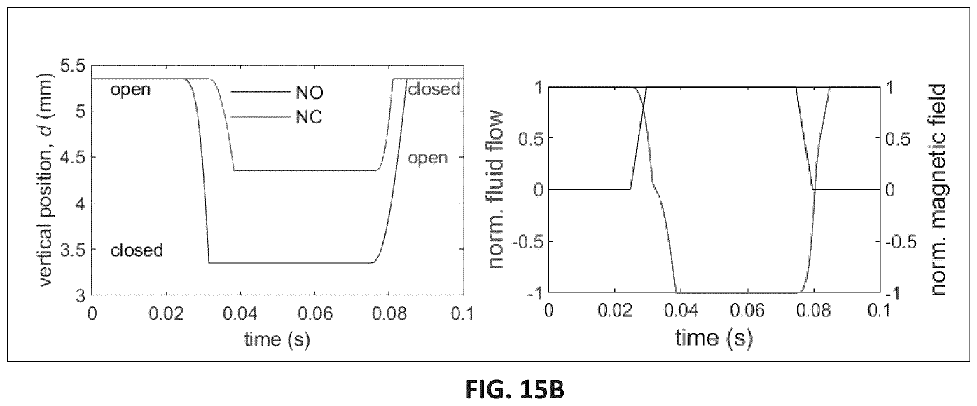

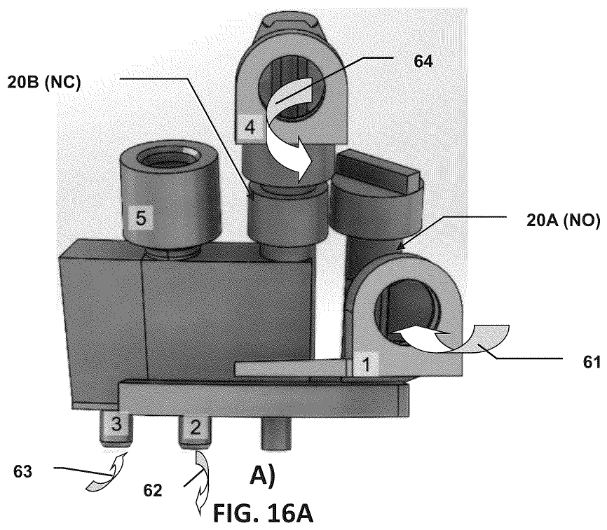

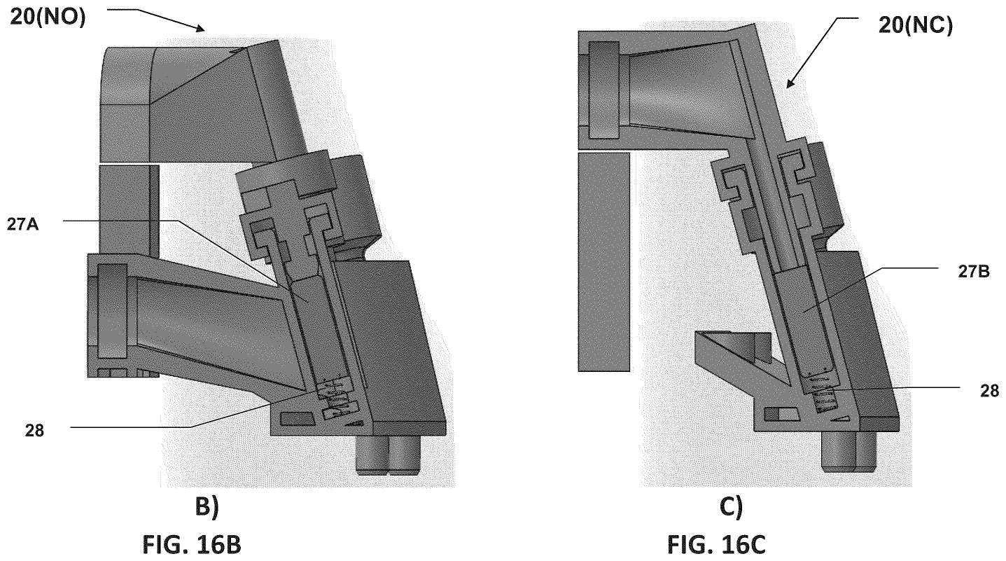

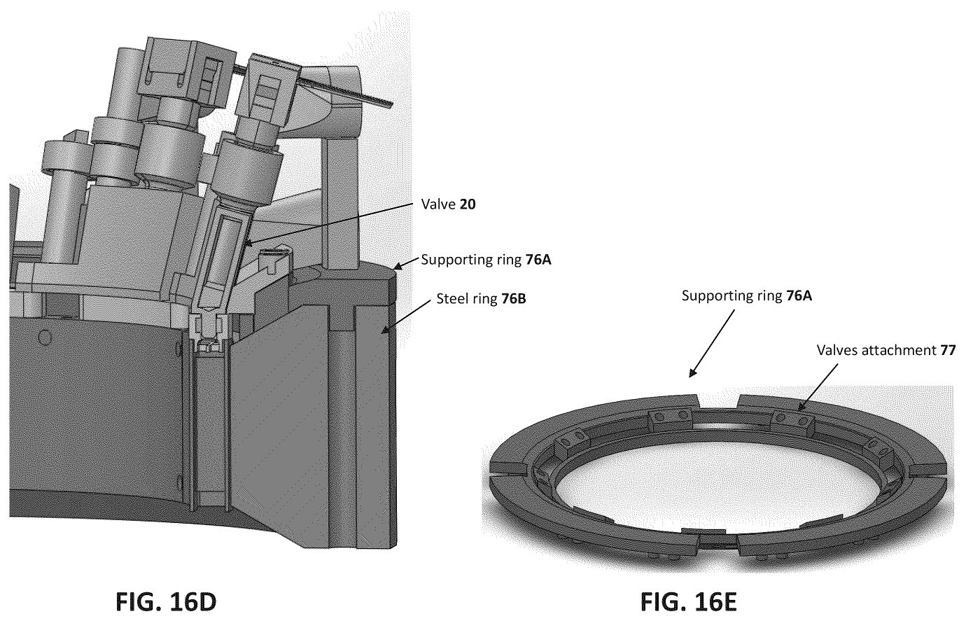

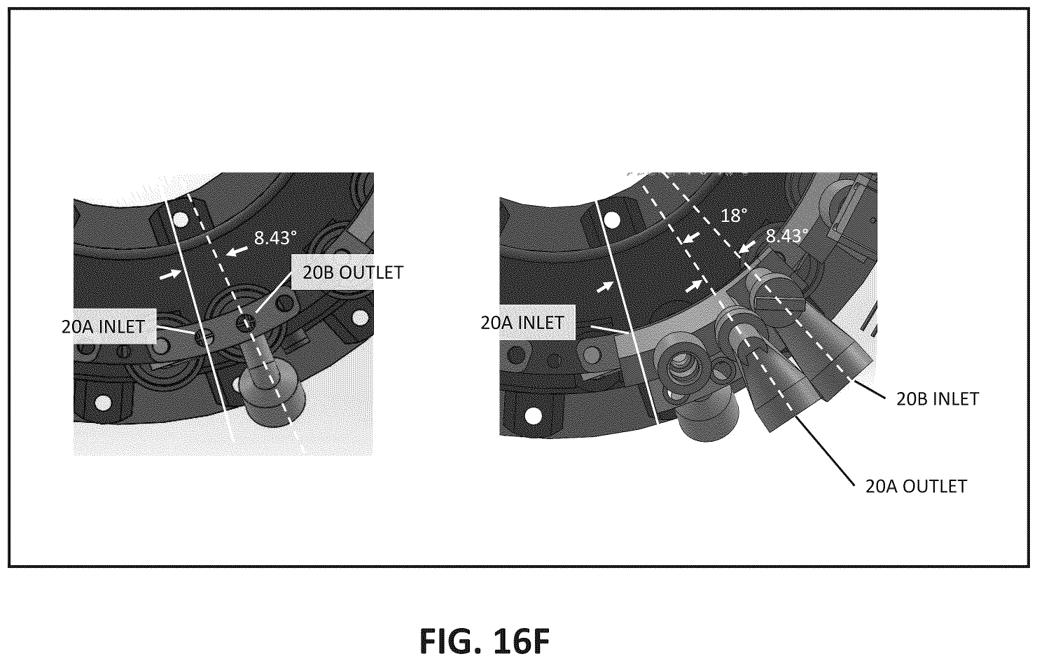

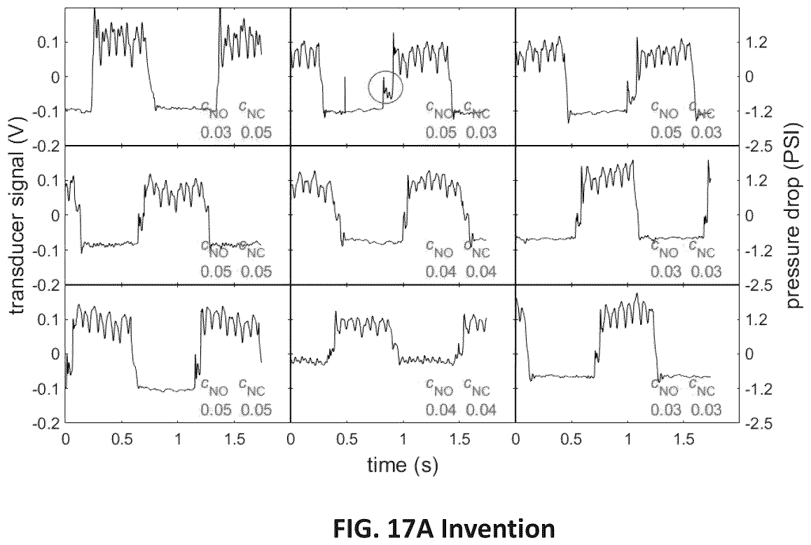

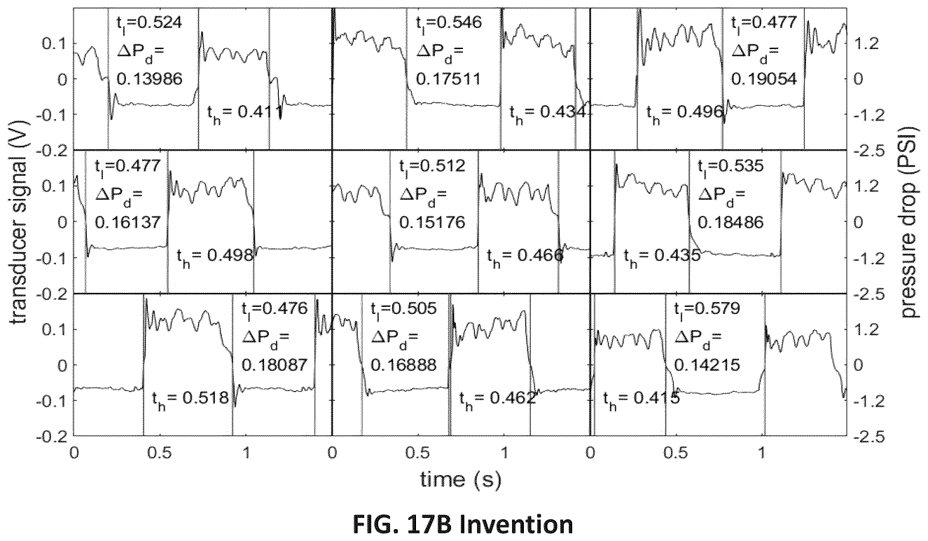

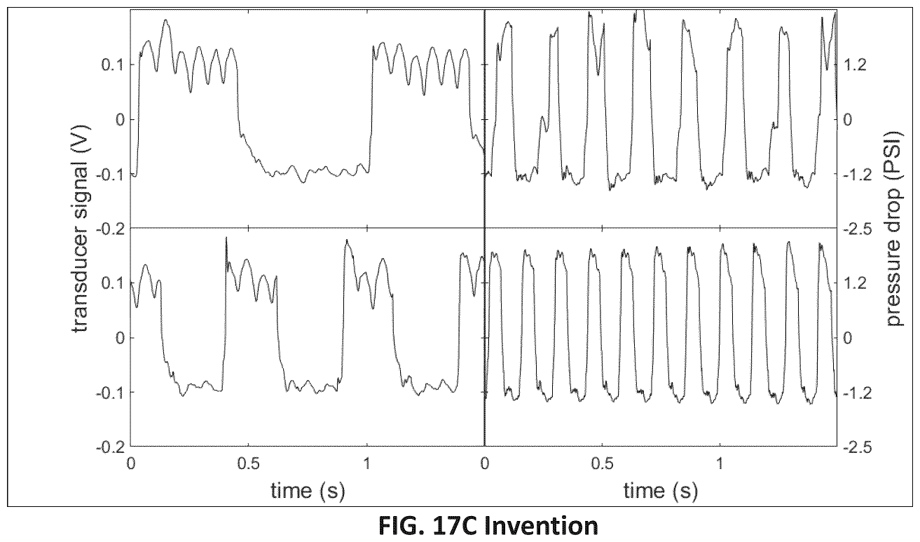

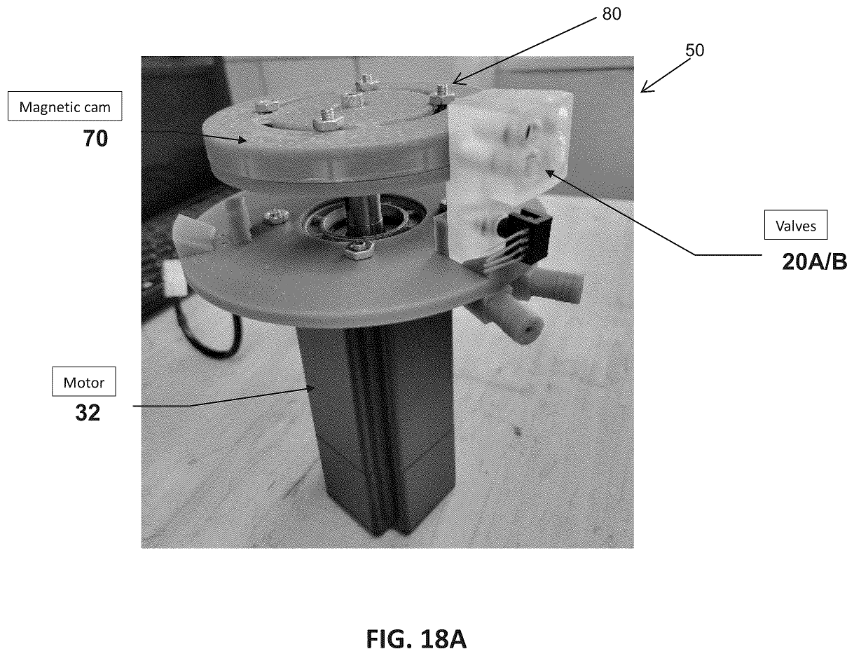

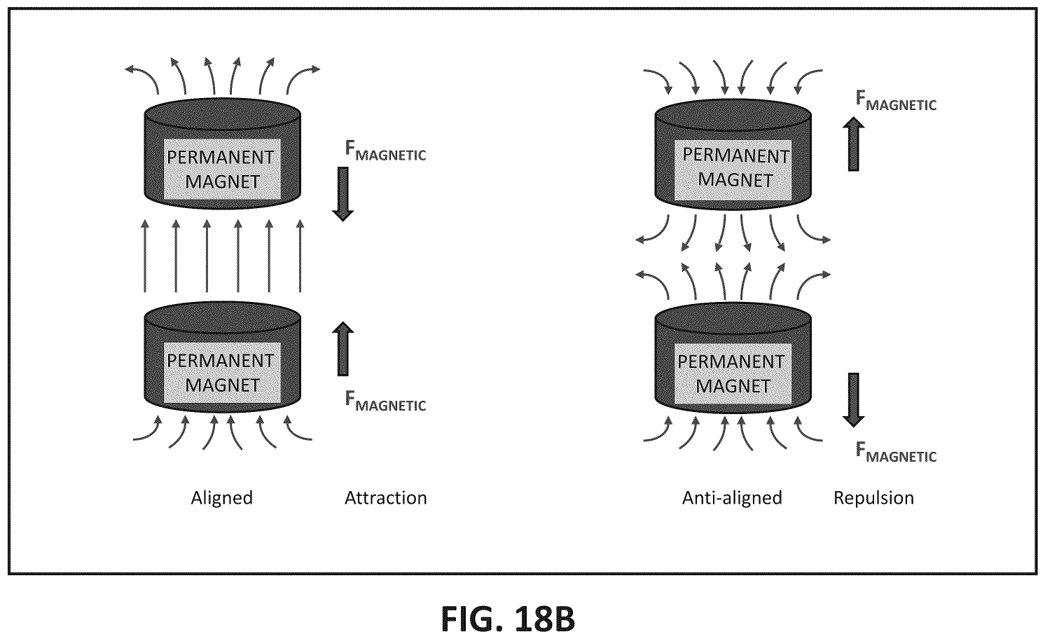

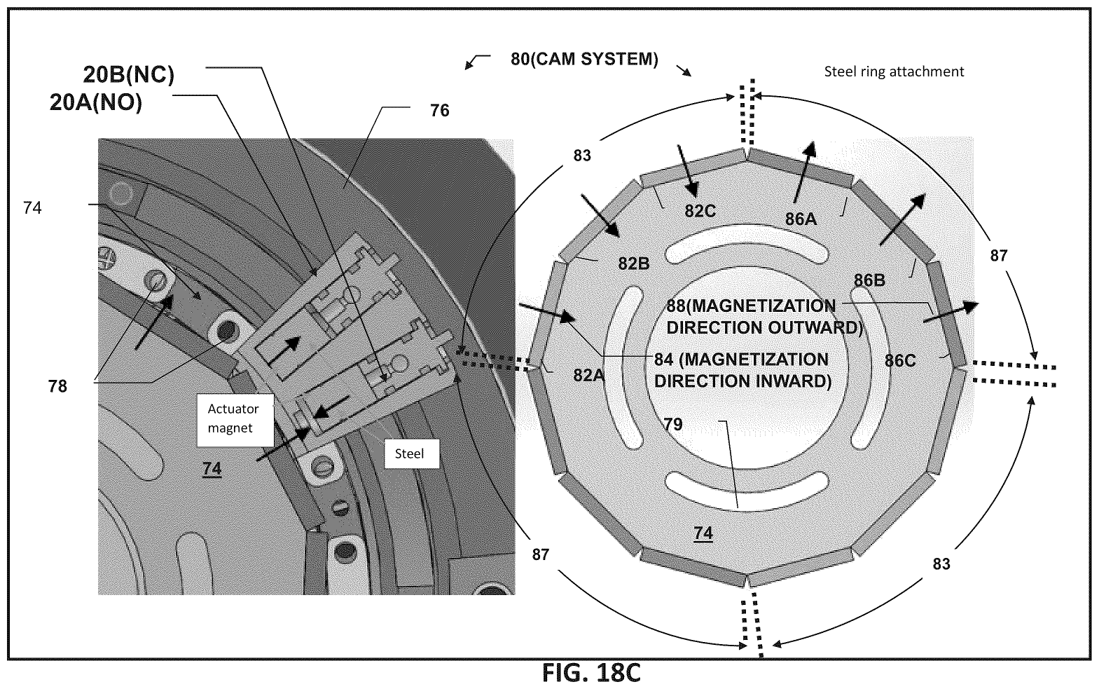

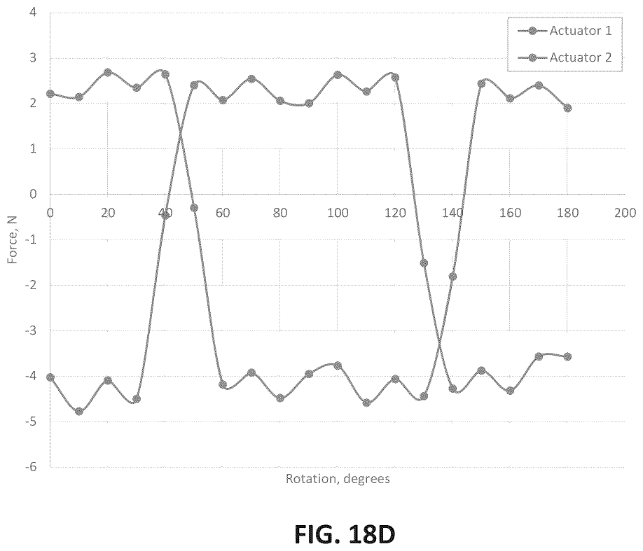

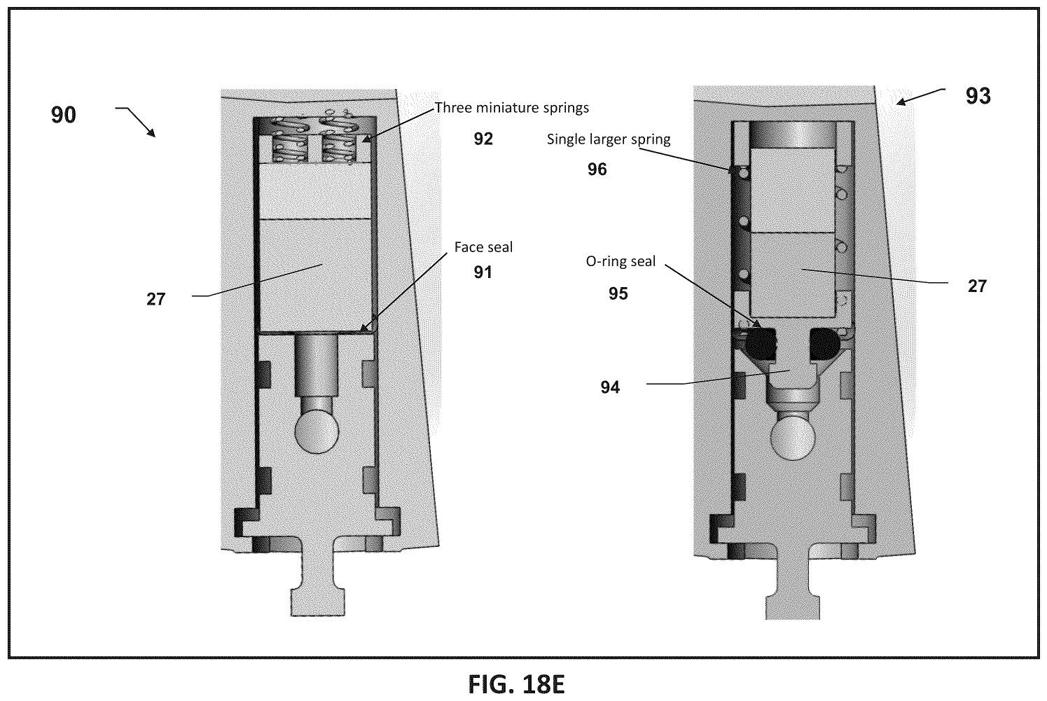

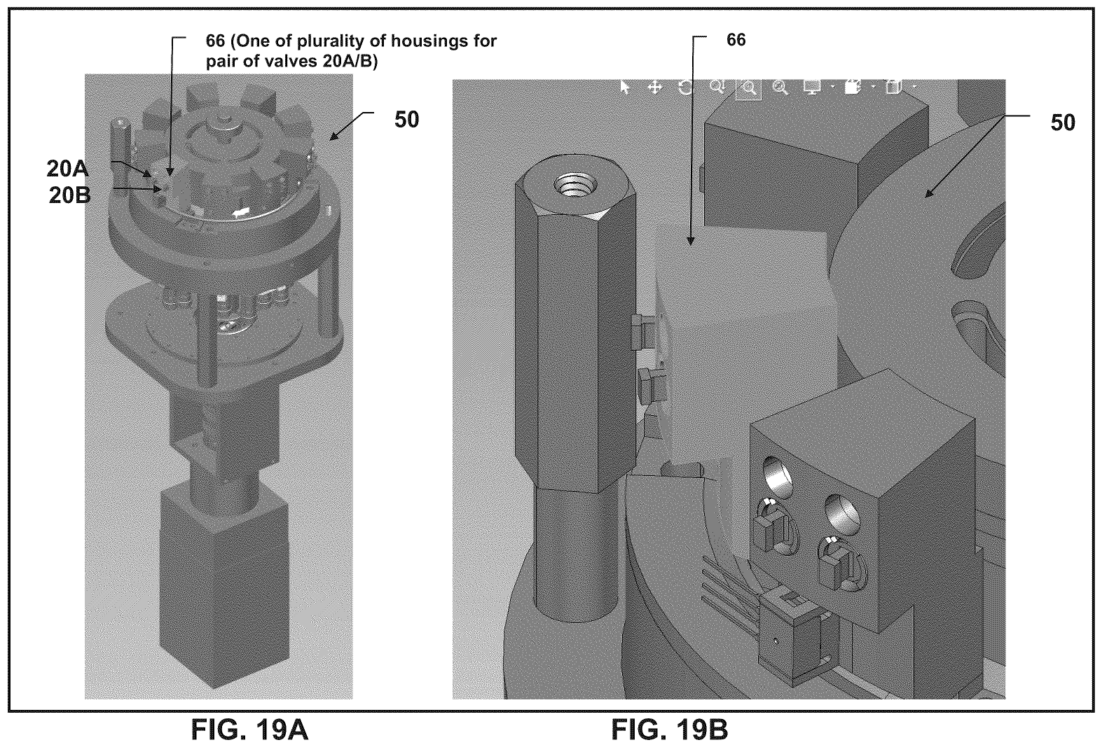

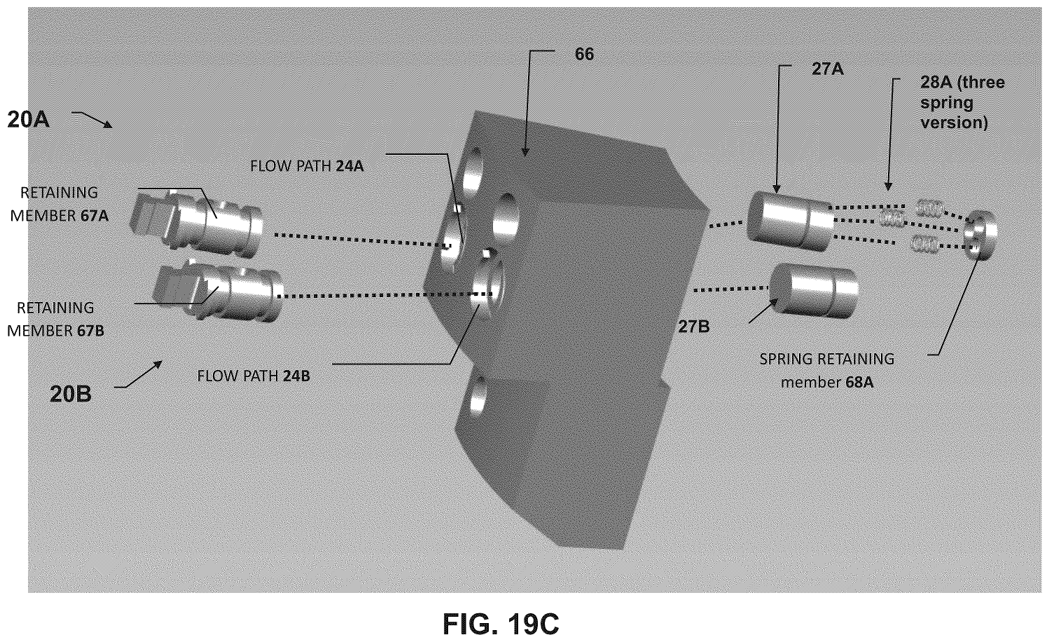

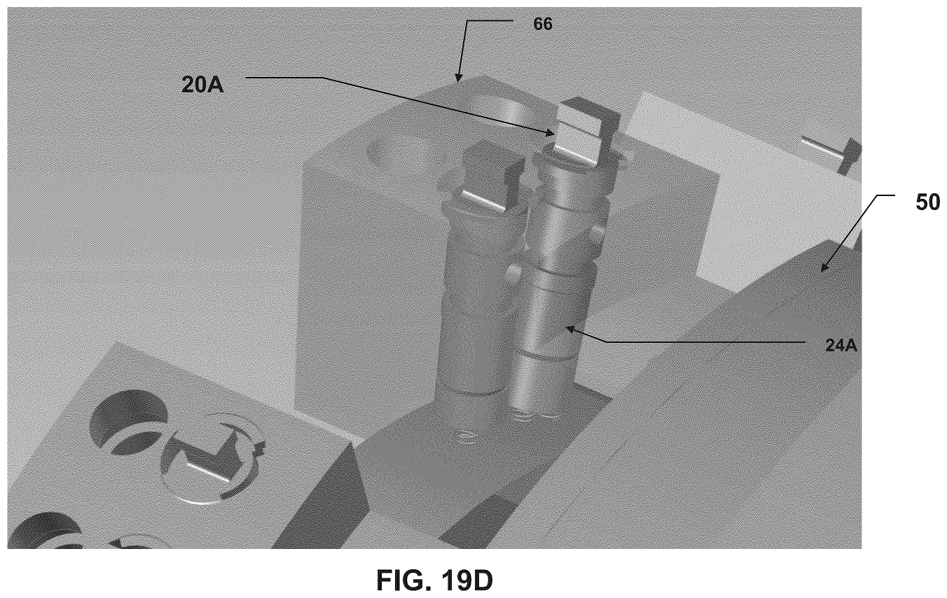

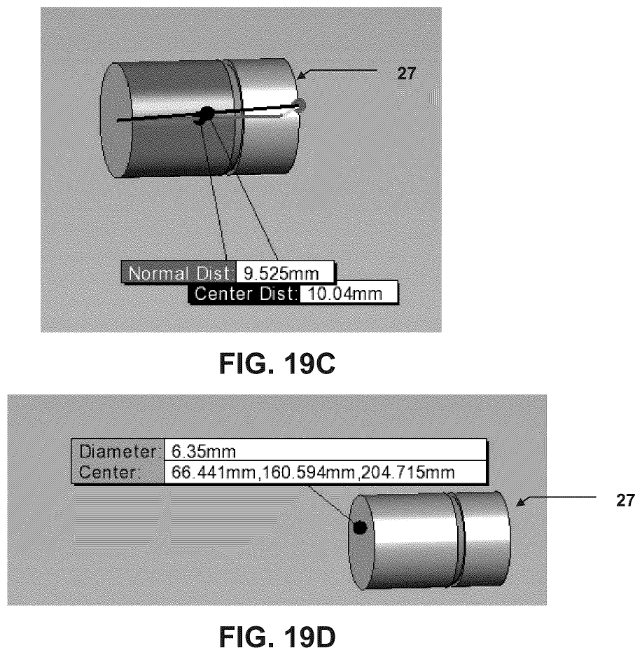

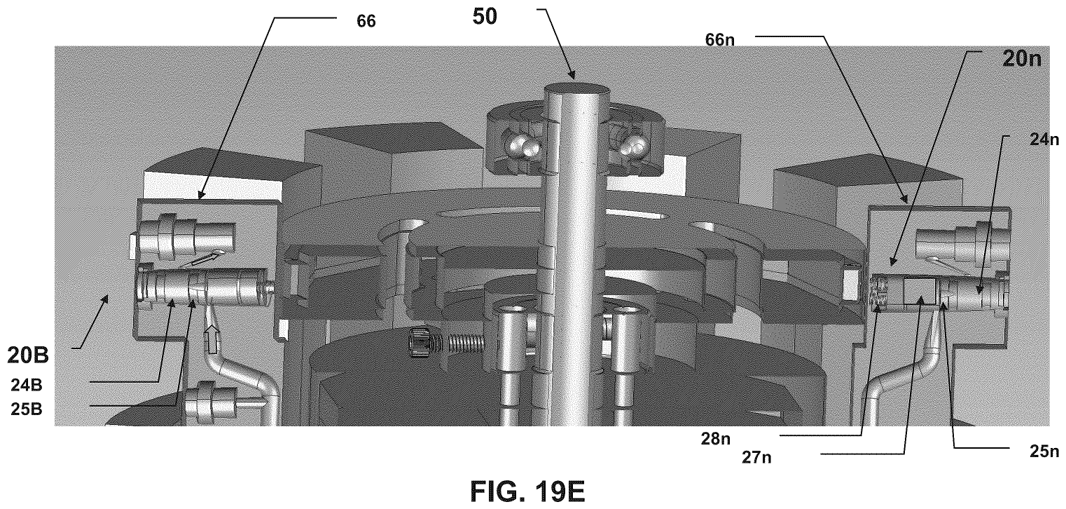

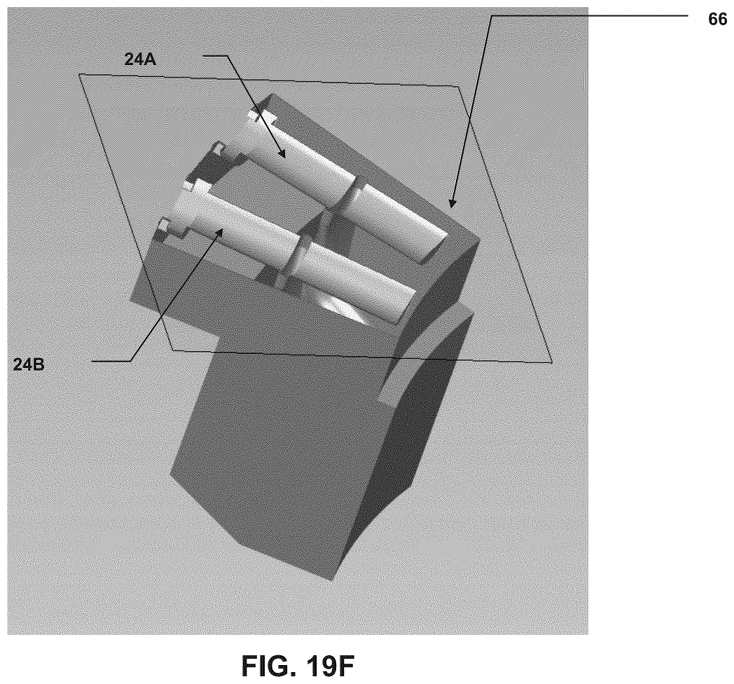

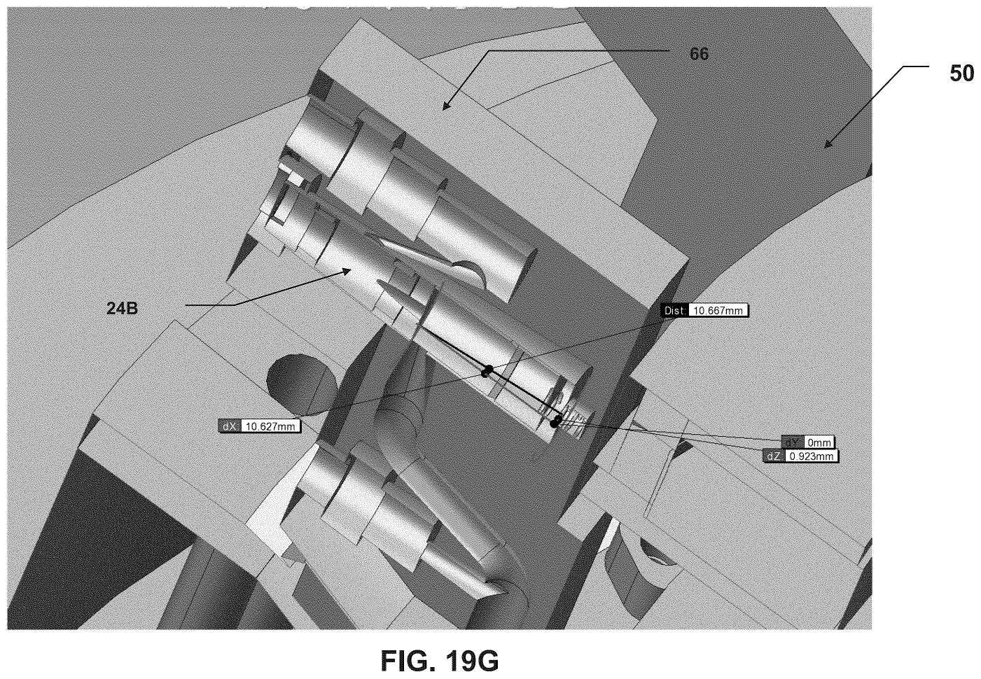

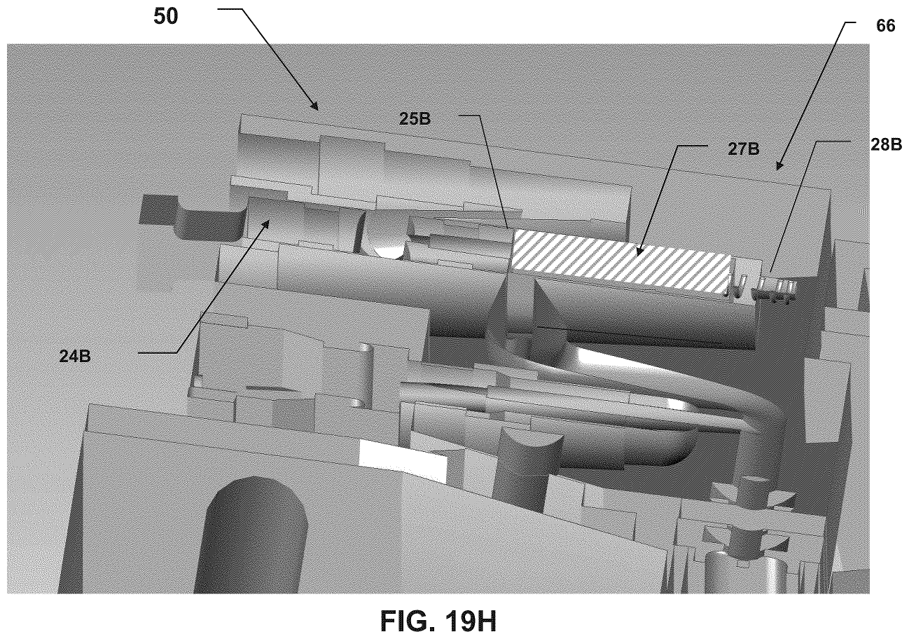

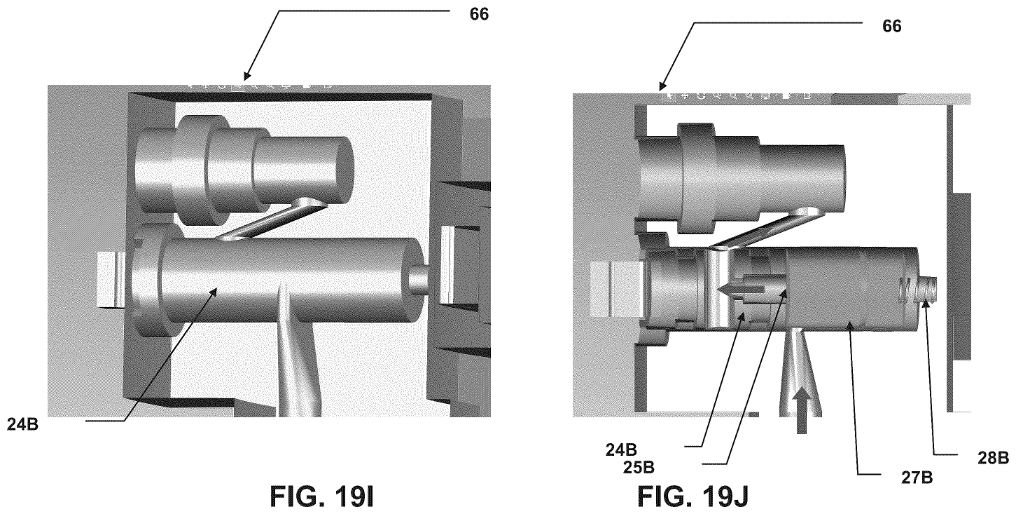

FIGS. 2A-D are illustrations of generalized embodiments of an apparatus and method according to the present invention, namely, an automatic magnetic valve having a moveable magnetic actuator in a valve body, where the magnetic actuator moves in response to an off-board generated magnetic field.

FIGS. 3A-C are cross-section views of a specific embodiment (Specific Embodiment 1, infra) of an automatic magnetic valve according to the present invention, where the actuator is a ferromagnetic cylinder with a constrained range of motion (ROM) within a valve body, and the restoring force is supplied by a spring in a normally closed valve initialization. FIG. 3B includes some exemplary dimensions and characteristics for one non-limiting set up.

FIGS. 4A-B provide an example of specific distances for which an example permanent magnet provides effective magnetic flux density for operation of the valve in FIGS. 3A-C.FIG. 5 illustrates different initialization of a valve of FIGS. 3A-C, including normally open versus normally closed.

FIG. 6 illustrates a pair of normally closed valves of FIG. 3C and response to an off-board magnetic field comprises a set of rotating magnets that provide time-varying stronger and weaker magnetic fields to each valve for valve actuation.

FIG. 7 is one non-limiting illustration of how a valve such as FIG. 3C could be carried on a mounting structure to allow removable mounting relative to an off-board magnetic field generator.

FIGS. 8A-Bare diagrammatical illustrations of alternative embodiments according to the invention similar to FIG. 5D but where the restoring force is gravity, as opposed to a spring or other component on-board the valve such as FIGS. 3A-7.

FIGS. 9A-F are highly diagrammatic illustrations of non-limiting variations of operation of automatic magnetic valves according to aspects of the present invention, each showing the valve, and forces operating on the valve, in two different states.

FIGS. 10A-E, 11A-D, 12, 13A-D, 14A-F, 15A-B, 16A-F, 17A-C, and 18A-E are illustrations regarding a specific implementations of an automatic magnetic valve subsystem according to the invention to control heat exchange fluid flow in a magnetocaloric heat pump (as one non-limiting end use or application), where the automated magnetic valve subsystem valves utilize the varying off-board or external magnetic field generated by the magnetocaloric heat pump subsystem as the actuating force on the ferromagnetic or magnetic material on-board actuators in the automated magnetic valve subsystem valves.

FIGS. 19A-J are illustrations of more specifics about automatic magnetic valves according to aspects of the present invention such as might be used in a magnetocaloric regenerator including that of FIGS. 10A-18E.

### DETAILED DESCRIPTION OF EXEMPLARY EMBODIMENTS OF THE INVENTION

### 4.1 Overview

For a better understanding of the invention, exemplary embodiments according to one or more aspects of the invention will now be described in detail. It is to be understood that these embodiments are neither exclusive nor inclusive of all possible embodiments of the invention.

For example, some embodiments will be described in the context of use of an on-board magnetic material (e.g. permanent or ferromagnetic material in whole or in part) actuator element in a valve body, where the actuator element moves in response to a sufficient off-board or external magnetic force (sufficient and effective to move the on-board magnetic material actuator, including relative to forces from flow of flowable material against it and from any restoring force acting upon it). Other materials responsive to such an off-board or external magnetic field gradient are possible.

For example, some embodiments will be described in the context of the valve controlling fluid flow. Other materials that are flowable are possible.

For example, some embodiments will be described in the context of a specific system which uses or generates a variable magnetic field off-board the valve for existing purposes other than opening or closing of one or more valves according to the invention. This refers to an off-board or external source of a magnetic field that is not originally intended for actuating the valve(s) of the invention. Thus, herein this will be sometimes called a “stray magnetic field” in the sense it is not originally intended or solely dedicated to actuation of the valve of the invention and original exists for some other purpose or function, but “stray magnetic field” is included within the broader term “off-board magnetic field source” or “external magnetic field source” in the sense it is integrated with or internal to the valve of the invention.

Additionally, as will be appreciated, the valve according to the invention is not just any valve body with a movable internal valve plug or actuator that happens to be a magnetic material (e.g. permanent magnet or ferromagnetic material), but rather has an internal or on-board magnetic material actuator that can move automatically along a range-of-movement or motion (ROM) inside the valve body in response to an effective off-board, external, or non-integrated magnetic field source with no on-board control circuit or mechanism, as further shown and discussed herein. In contrast, a typical solenoid flow valve has an on-board magnetic material actuator with internal ROM, but moves that actuator with an on-board source of magnetic field (the solenoid) that requires electrical power to be delivered to the on-board solenoid, as in FIGS. 1A-B and FIG. 1C, not an off-board source of magnetic field. Another contrasting example is a ball valve (see, e.g., FIG. 1E) that might be made of ferromagnetic material but must be actuated by manual, mechanical, or electromechanical on-board components that are mechanically connected to the ball. Other examples exist. Check valves and poppet valves may have at least some automatic or semi-automatic operation, but not based on a magnetic actuator. Check valves respond to pressure against them, not any manual or external/off-board control, and are passive. Poppet valves can operate similarly by responding to some pressure differential but are passive and may have a manual reset.

### 4.2 Generalized Embodiment

In one generalized form and aspect of the invention, control of a flowable material includes:
a. interposing an on-board or internal actuator element of magnetic material of any of a variety of form factors along a flow path for the flowable material through a housing or valve body where the on-board or internal actuator element has freedom of movement along a range of motion between states that at least either partially allows or blocks the flowable material in response to a first direction and magnitude of an off-board or external magnetic field, where the off-board or external magnetic field can relate to a variety of sources and is not an on-board source and does not require a control circuit dedicated to actuating the valve;
b. selecting operating state of the valve to normally-open or normally-closed (or towards normally-open or normally-closed) by configuration of a restoring force or restoring force component relative to the on-board magnetic material actuator element, including accommodating for forces exerted on the actuator element by all of any off-board or external magnetic field, the flowable material, and the restoring force component;
c. positioning the valve relative to an off-board or external magnetic field to effectively take advantage of the direction and magnitude of an off-board or external magnetic field to change states; and
d. operatively connecting a flow of the flowable material to the valve.

One significant difference from solenoid flow valves is that an on-board control circuit and/or electrical power connection is not required, such that the control of flow is actuated by an off-board generated variable magnetic field that provides sufficient magnetic force move the on-board magnetic material actuator element at least in one direction along its range of motion to actuate at least one state of flow control. The sufficient magnetic force can be calibrated or estimated to cause such magnetic material actuator element movement while accounting for other forces on the actuator element, including direction and magnitude of force of the flowable material and direction and magnitude of force of the restoring force or restoring force component, which can vary for each application.

As can be appreciated, this combination can be implemented in a variety of configurations of the components, the off-board magnetic field, and the flowable material.

With particular reference to FIGS. 1A-B (prior art solenoid valve flow valve 10) in comparison to FIGS. 2A-B (diagrammatic illustration of a valve 20 according to aspects of the present invention), a generalized embodiment of the invention will be shown and described with several examples. As can be seen, these examples all have the commonality of:
a. A valve body 11 or 21 with a flow path 14 or 24 for flowable material 13 or 23. The valve body 11 or 21 typically being substantially of materials which would be substantially non-responsive to a desired or selected magnetic field used to actuate the valve element of the valve.
b. A ferromagnetic valve element 17 or 27 having freedom of movement over a range of motion (ROM) 12 or 22(see double-ended arrow) between open (allowing flow) and closed (blocking flow) positions in the valve body, and being responsive to a magnetic field gradient or varying magnetic field to move in at least one direction along a constrained ROM inside the valve body. Examples include from initial closed to actuated open position, or vice versa. In these non-limiting examples, actuators 17 and 27 have a plug end 16 or 26 that seats in a valve seat 15 or 25 to seal off flow, if desired. As will be appreciated by those skilled in the art, there are other configurations for closing the flow path. Further, sometimes the ROM is controlled to just partially close the flow path, as in to regulate flow to some percentage or degree, instead of complete blocking. Also, in these non-limiting illustrations, each valve includes a restoring source component 18 or 28 to urge the actuator 17 or 27 in a certain direction with its ROM. These figures represent component 18 and 28 with a coil spring symbol, but those skilled in the art will appreciate there are a variety of possible restoring force components to supply an effective restoring force that function in an analogous way to a spring. As illustrated by comparing FIGS. 1A-B with FIGS. 2A-B, a main difference of the invention is that:
c. The solenoid valve of FIGS. 1A-B uses an on-board source 19 of magnetic field (solenoid) to actuate its on-board magnetic material actuator 17 which includes a control circuit and/or electrical power source or connection to actuate movement of actuator 17 along its ROM. The inventive embodiment takes advantage of a magnetic field of an off-board magnetic field subsystem 29. There is no required on-board source, control circuit, or electrical power source/connection to actuate the on-board magnetic material actuator 27, as is required by the solenoid valve. Instead, the self-contained passive valve according to the invention eschews any on-board source, control circuit, or electrical power source/connection and is actuated by a magnetic field generated off-board the valve. In some cases, the off-board source 29 may have a pre-existing or different original function than actuating the valve 20. In some cases, off-board source 29 does not, and is dedicated to actuating valve 20. For example, operation using an off-board magnetic field allows for use in applications where wiring is difficult or impossible (e.g., rotating components, components with linear motion, or those located in an inaccessible area such as a closed container).

A few possible benefits of the embodiment of FIGS. 2A-B include:
a. Less complexity and cost without on-board magnetic field source, control circuits or electrical power source or connection, and also possibly smaller form factor size.
b. Passive automatic action without need for a control circuit.
c. Flexibility in possible variations on form factor of the actuator (not necessarily restricted to limitations with a solenoid coil actuated actuator), including but not limited to shape, materials, ROM, and flow path.
d. With a single off-board magnetic field and source, the ability to control one flow path or a plurality of flow paths.
e. An ability to tune flow control by selection of any of the form factor, weight/mass, materials, ROM, and flow path.
f. Flexibility in possible variations relative to restoring force types and magnitudes, flow forces, flow regulation (i.e., full open versus partially open and full closed versus partially closed), as well as relative directions and magnitudes of forces acting on the actuator, including the off-board magnetic field magnetic force versus a restoring force versus a flow force.
g. Flexibility in end use or application, including a range of frequencies of operation, a range of types and magnitudes of off-board magnetic fields, and a range of flowable materials; in particular without the challenges or complexities of matching any on-board control circuit or electrical power source to the effective operation of the flow control.
h. Flexibility for use in applications where wiring is difficult or impossible (e.g., rotating components, components with linear motion, or those located in an inaccessible area such as a closed container).

In the present context, as diagrammatically illustrated at FIGS. 2A-B, a usable off-board magnetic field/source 29 must have sufficient magnitude (magnetic force F_{magnetic} or sometimes also Fₘ) to move the magnetic material actuator 27 to overcome any resisting forces such as flow force F_{flow} (sometimes herein F_{f}) against the actuator 27 caused by a particular flowing flowable material 23, and restoring force F_{restoring} (or sometimes also Fₛ) associated with the actuator 27 provided by a restoring force component or source 28. In some cases, gravitational forces might have to also be compensated. In some cases, with appropriate configuration, gravity alone could be the restoring force.

As mentioned earlier, the off-board magnetic field in some senses can be considered a stray magnetic field in the context it is not generated on-board valve 20 and is external to valve 20. But this use of “stray magnetic field” does not include any connotation of very weak extraneous or irrelevant magnetic fields (either nearby or distant, and either alternating or static) such as generated from power supplies, fluorescent lamps, other current-carrying conductors, geomagnetism, non-periodic magnetic fields that are not intended to or effective to move the on-board magnetic material actuator 27 as needed for valving action, and might be ignored in favor of another stray magnetic field that is effective to do so; which are sometimes referred to in some contexts as stray magnetic fields. But depending on the make-up of components of the automatic magnetic valve according to aspects of the invention, some magnetic fields that might be considered weak could be used to actuate the valve. As such, most times herein, the magnetic field/source 29 effective to controllably move magnetic material actuator 27 in valve 20 will be referred to as an off-board or external magnetic field/source.

As further illustrated at FIGS. 2A-B, a designer will typically have to consider all forces acting upon actuator 27 to ensure that the F_{magnetic} (sometimes also Fₘ) of an effective off-board or external magnetic field to be used has sufficient magnitude and direction to move actuator 27 relative to any opposing components of F_{restoring} and/or F_{flow}. As will be appreciated by those skilled in this technical field, depending on valve set-up and intended operation, F_{restoring} and F_{flow} can be aligned or anti-aligned. Also, F_{restoring} can vary depending on whether the valve is normally-open (NO) or normally-closed (NC).

FIG. 2C is a generalized diagrammatic illustration (left side) of an automatic magnetic valve 20 according to aspects of the invention with on-board magnetic actuator 27 and restoring force 28 relative a flow path 24. FIG. 2C (right side) illustrates design parameters for a designer in selecting the components and operation of valve 20 according to aspects of the invention. As can be appreciated by those skilled in this technical art, basic parameters of the magnetic actuator 27 and restoring force component 28 can be correlated to the off-board magnetic field direction and strength of off-board generator 29 to calculate the required movement of magnetic actuator 27 in valve body 21 to effectively control flow through flow path 24. As will be appreciated, the parameters of FIG. 2C are neither inclusive nor exclusive of all design parameters and factors for a valve designer, but provide important insights into relevant design relationships. For example, depending on orientation of valve body 21 and the type of flowable material 23 to be controlled through flow path 24, parameters such as gravity, mass of magnetic actuator 27, and force of flow of the flowable material against magnetic actuator 27 may be relevant to design. Sometimes they are negligible or not relevant.

FIG. 2D illustrates the general methodology paradigm according to aspects of the invention. Method 100 includes an initialization step 102. Non-limiting aspects of initialization could include selection of the end application for valve 20, including form factor and scale (e.g. cross-section of flow path 24), type of flowable material to control (e.g. solid, liquid, or gas phase), orientation in operation of actuator 27 (e.g. vertical, horizontal, or other angles relative to earth), from factor and size/mass of actuator 27 (e.g. ball shape, rod shape, disk shape, or others), friction between actuator 27 and valve body, needed range of movement of actuator 27, technique, material, and form factor of sealing or seating the plug end 26 of actuator 27 relative to a valve seat or seal 25 in valve 20, and type, control, and strength of magnetic flux density generated by off-board generator 29. Those skilled in this technical art will appreciate how such parameters can be used in design of a valve 20 according to need or desire for a given end application for valve 20.

Selected and configured automatic magnetic valve 20 is interposed in a flow path 24 effective to reduce or block flow with magnetic actuator 27 at a valve seat or seal 25, or increase or unblock flow (step 104) by control of an off-board magnetic field (step 106).

### 4.3 Specific Embodiment 1—Specific Form Factor of the Valve

With particular reference to FIGS. 3A-C, several non-limiting examples of a specific valve 20 and its internal passive magnetic actuator 27 form factor (cylinder-shaped) are illustrated to further assist in showing how to make and use aspects of the invention.

This embodiment operates under the same or analogous paradigms as the Generalized Embodiment described with respect to FIGS. 2A-D. Some main variations of this Specific Embodiment 1 are as follows.

The valve body 21 in FIGS. 3A-C has adjacent, anti-aligned input and output to flow path 24. But any of a variety of relative positions of inlet(s) and outlet(s) are possible. The material of body 21 can be any of a variety of types effective to contain over a useful operating life span the flow of a flowable materials (e.g., resistant to degradation or failure from pressure range, friction, flow forces, chemicals in the flowable material, etc.). Preferable, the material of body 21 is at least substantially non-responsive to the desired or selected off-board or external magnetic field to be used with the valve to move ferromagnetic actuator 27 from its normal or initial position. While most of the valve body should be nonmagnetic, ferromagnetic material can be added in key areas to enhance the magnetic field interacting with the actuator.

Actuator 27 is ferromagnetic, at least in part, and has a solid-cylinder shape or cylindrical form factor. A valve seat 25 built into body 21 has a complimentary shape to cylinder 27 so that when cylinder 27 is seated in seat 25, flow is at least substantially blocked, and here fully blocked. As can be appreciated, actuator shape as well as valve seat shape can vary. Non-limiting examples include form factors with a regular spherical, conical, ellipsoid, triangular prism, cuboid, pyramid, or tetrahedron plug end. The shape can be irregular, symmetrical, asymmetrical, or almost any shape so that it is effective to block or partially block or restrict flow in one state or position, and effectively unblock flow, fully or partially, in another state. The shapes can also interact with the flow path form factor and/or any valve seat form factor to cause progressive amounts of blocking or unblocking at various positions along the ROM in the valve body.

In this example, a restoring force component 28 is a spring (metal helical coil spring) that supplies a restoring force proportional to the displacement from its equilibrium length. As will be appreciated, depending on valve set-up the spring can be an extension or compression helical spring. Other types of springs are possible, including but not necessarily limited to, torsion, compression, spiral, leaf, disk, and flat. Helical springs can be metal or metal alloy, but also other materials that exhibit elasticity with a restoring force. Non-limiting examples are ceramic, rubber/plastic, fiber composite, or others exhibiting elasticity and a spring constant over a normal useful operating life for a given set-up and application.

In one non-limiting example, details about a valve like that of FIG. 3A-C are as follows:
(a) Fluid channel defined by portions of valve body 21 which is substantially non-responsive to an off-board or external magnetic field, or at least does not substantially disrupt the effectiveness of that off-board or external magnetic field, but in certain optional embodiments can use materials or techniques to enhance the effectiveness (e.g. ferromagnetic material added in key areas to enhance the magnetic field interacting with the actuator 27). In this non-limiting example the fluid channel flow path is circular in cross section with a diameter of 3 mm.
(b) Flowable material with a difference in pressure between the inlet (24 left) and outlet (24 right) of 1e4 Pa.
(c) Magnetic cylinder. Low carbon steel; height of 6.35 mm; diameter of 6.35 mm.
(d) Spring. Spring constant (k) of 140 N/m; length of 8 mm; fully compressed length 2 mm; being initially compressed 3 mm.

As shown in FIG. 3A, cylinder 27 has an initial, normally-closed (NC) state with no off-board magnetic field effectively acting upon cylinder 27, such that cylinder 27 is seated to block flow with the restoring force spring 28 urging it to that position.

As diagrammatically indicated in FIGS. 3A-E, when subsystem 29 that can generate an off-board magnetic flux density B with an effective magnetic force to move cylinder 27 from its initial position is operated to magnetically couple magnetic flux density B with that effective magnetic force to cylinder 27, that magnetic force (in this case an attracting magnetic force relative to cylinder 27) overcomes the restoring force of spring 28 and unseats cylinder 27 to open flow past it. The designer must meet the requirement of F_{magnetic}+F_{flow}>>F_{restoring} to move cylinder 27 from its seated initial position to unblock the flow path. In this example, the off-board magnetic field created by an off-board magnetic-field generating subsystem 29 is that of a permanent magnet 30 with magnetic flux density B of sufficient magnitude that when the magnet 30 is brought into close enough proximity to cylinder 27 along its range of motion (ROM) axis and below spring 28, that its magnetic force Fₘ, in this case acting in conjunction with the flow force F_{f}, overcomes Fₛ in the closed position and begins moving cylinder 27 out of the initial blocking position. Continuing to bring the magnet into closer proximity to cylinder 27 increases the magnetic force further, supplying the additional force to compress spring 28 until the spring reaches the end of its ROM, which opens the flow path to the maximum extent allowed by the specific design to allow flowable material flow (light blue fill and black arrow at the outlet) between valve inlet and outlet. This opened state will subsist for as long as that effective off-board magnetic flux density remains in close enough proximity to cylinder 27. Sufficient proximity or sufficient magnetic force of the off-board generated magnetic field from subsystem 29 will depend upon, inter alia, the nature of cylinder 27 (materials, cross sectional area, etc. of cylinder 27 or other form factor for actuator 27), the amount of restoring force and flow force acting on actuator 27, and the direction and magnitude of off-board generated magnetic field of subsystem 29.

Once the off-board magnetic field is no longer effective (e.g. is removed, is turned off, or otherwise is reduced so that it no longer qualifies as effective to meet the requirements to unseat cylinder 27) relative to cylinder 27, the restoring force of spring 28 returns/restores cylinder 27 back to NC seated position of FIG. 3A. The effective off-board field can become ineffective by a number of techniques. One is simply movement of permanent magnet 29 sufficiently away from cylinder 27 that Fₘ+F_{f}>>Fₛ is no longer satisfied. Several non-limiting examples could be as follows. Permanent magnet 30 could be mounted on a source of rotational movement having a rotational axis that brings magnet into effective proximity and then out of effective proximity. Another example would be mounting magnet on a linear motion source that does the same. Those skilled in the art will appreciate there would be a variety of possible ways, with a variety of actuator types to cause such motion. A variety of actuators 32 are, of course, possible.

In this specific example, when magnetic flux density, B, is applied and the magnetic force, Fₘ, acting on the magnetic cylinder 27 becomes larger than the spring's 28 restoring force in the initially closed position, Fₛ₀, the magnetic cylinder 27 is attracted toward the permanent magnet 30 of subsystem 29. As a result, the flow channel begins to open, as shown in the following relationships:
Fₛ for initial displacement d₀:

$${F}_{s} = - k \times {d}_{0} ( k = 140 N / m ) = 0.4 \; 20 N$$

F_{f} from the fluid:

$${F}_{f} = A Δ P = 7.07 e - 6 {m}^{2} ⋆ 1 e 4 = 0.0 \; 707 N$$

Fₘ from the magnet:

$${F}_{m} \approx {B}^{2} A / 2 {μ}_{0} > {F}_{s} - {F}_{f}$$

Solving for B

$$B > \sqrt{\frac{2 {μ}_{0} ( {F}_{s} - {F}_{f} )}{A}} = 0.1 \; 66 T$$

Opening the channel to the maximum extent allowed by the ROM requires a higher magnetic force to increase the displacement of the spring. Assuming the F_{f} remains unchanged through valve actuation:
Fₛ for the maximum displacement of the spring d+d₀:

$${F}_{s} = - k \times ( {d}_{0} + d ) ( k = 140 N / m ) = 0.8 \; 40 N$$

Fₘ from the magnet:

$${F}_{m} \approx {B}^{2} A / 2 {μ}_{0} > {F}_{s} - {F}_{f}$$

Solving for B

$$B > \sqrt{\frac{2 {μ}_{0} ( {F}_{s} - {F}_{f} )}{A}} = 0.2 \; 41 T$$

Thus, the fluid channel is opened due to a 3 mm displacement of the magnetic cylinder 27. As will be appreciated by those skilled in the art, a designer can use the above relationships analogously to design other automatic magnetic valves.

Thus, as shown at FIG. 3C in side-by-side comparison, a normally closed valve 20 would have cylinder 27 seated (blocking) when off-board magnetic field subsystem 29 does not supply effective magnetic force Fₘ to overcome restoring spring force Fₛ plus any flow force F_{f} (left side of FIG. 3C). When off-board magnetic field subsystem 29 does supply effective magnetic force Fₘ to overcome restoring spring force Fₛ, acting in conjunction with any flow force F_{f} (right side of FIG. 3C), the flow path is unblocked allowing the flowable material (light blue fill and black arrow at the outlet) to flow between inlet and outlet of valve body 21.

FIGS. 4A and 4B, in conjunction with FIGS. 3A-C, illustrate an example of actuating the valve 20 by controlling the position of a permanent magnet 30 relative to the cylinder 27. Measurements of the magnetic flux density at fixed distances away from a permanent magnet (o) are plotted on a semi-log plot with a best fit to the data plotted as a solid line and the specific distances where the magnetic force Fₘ balances the restoring force Fₛ at the fully open and fully closed extents of the ROM for the example in FIGS. 3A-C, shown as vertical dashed lines. Any position between the vertical dashed lines could by set to target a partial opening or closing of the valve to achieve some desired flow through the valve. As will be appreciated, variations obvious to those skilled in this technical art, informed by the teachings of this example, are possible.

Some possible non-limiting variations are discussed below.

FIG. 5 illustrates, in side-by-side fashion, the difference between initial valve 20 set up as a Normally-Closed (NC) valve versus Normally-Open (NO). In this example, magnetic actuator 27 is a ball or spherical form factor. The two illustrations on the left side relate to a NC valve (showing initial closed position without an effective off-board magnetic field and opening upon generation of or imposition and coupling of an effective off-board magnetic field from source 29 with ball 27); whereas the two illustrations on the right side related to a NO valve (showing initial open position without an effective off-board magnetic field and closing upon generation of or imposition and coupling of an effective off-board magnetic field with ball 27). Upon application of an effective off-board magnetic field by subsystem 29, the state of the valve changes to closed/blocking flow (as off-board field from subsystem 29 in this example attracts ball 27 and overcomes any restoring force or flow force.

As can further be appreciated, the selection of materials, sizes, spring force, and flow path, at a range of possible values of F_{flow} or F_{f} for a given type of flowable material, can be selected by a designer according to need or desire.

FIG. 6 diagrammatically shows the concept of a rotating permanent magnet 30 (in this non-limiting example two spaced apart permanent magnets 30A and B carried on a common off-board structural support 34 which is rotated around a common rotational axis 33 by motion actuator 32) as the varying off-board magnetic field. Here we describe another example with a rotating permanent magnet. When the permanent magnet is rotating, there is a time dependent variation of magnetic field around the ball created by the frequency of rotation of the pair of permanent magnets towards and away from ball 27. The off-board magnetic field of each permanent magnet becomes “effective” to (a) attract, (b) overcome the spring's restoring force, and (c) unseat ball 27 when any of the permanent magnets is in closest position to valve body 21. The off-board magnetic field of each permanent magnet 30A/B becomes “ineffective” to (a) attract, (b) overcome the spring's 28 restoring force, and (c) unseat ball 27 when any of the permanent magnets 30A/B is sufficiently away from closest position to valve body 21 (which would be at least when farthest away from valve body 21). This variation of magnetic field can automatically actuate the operation of magnetic valves.
(A) When the permanent magnet 30A/B is away from the valve body 21, the magnetic ball 27 closes the flow path 24 due to the spring's 28 restoring force.
(B) When the permanent magnet 30A/B is near the valve body 21 and the magnetic force acting on the magnetic ball 27 becomes larger than the spring's 28 restoring force, the magnetic ball 27 is attracted to the magnet 30A or 30B. As a result, the flow path 24 is opened.

To further impart understanding of how various parameters of each design for valve 20 can interact with one another, and one non-limiting example of a particular version of a ball type valve 20, FIG. 3B includes in annotations certain dimensions, including a possible configuration showing sufficient proximity of stray magnetic field B from off-board subsystem 29 to be effective to move the indicated ball 27 to overcome both spring force Fₛ and flow force F_{f} to be effective to move ball 27 from initial position (NC) to an open position. As will be appreciated, these dimensions will vary depending on valve parameters.

FIG. 3B also shows calculations related to the relationships of FIG. 4 for the particular characteristics of the cylindrical actuator 27 of FIG. 3A.

Of course, those skilled in the art can extrapolate from this specific example in the design of variations on the valve 20.

FIG. 7 illustrates in section view a valve 20 with ball actuator 27 and some exemplary possible non-limiting dimensions. It also shows one way to mount valve body 21 by, e.g., mounting hardware 40, here including mounting plate 42 and fasteners 43. Those skilled in the art will understand there are many ways to mount or position a valve 20 relative to other apparatus. This figure also shows an optional removable cap 46 or similar structure that can provide selective access to the interior of valve body 21, if needed, but close of the interior of valve body 21 when in place.

### 4.4 Specific Embodiments 2—Operational Variations

With reference to FIGS. 9A-F, several non-limiting variations in operational configuration are illustrated. Those skilled in the art will appreciate how a valve 20 could be configured for these variations, or others. The illustrations are diagrammatic and intended to diagrammatically show actuator 27 between flow blocking and unblocking positions, and not intended to show specific structure or specific valve actuator versus valve seat or seal structure.

The relationship between the forces to move actuator 27 for each are summarized below:

| | Relationship of forces |
|---|---|
| Set-up | to actuate actuator 27 |
| FIG. 9A-Normally open, aligned | F_{magnetic} >> F_{restoring} + F_{flow} |
| FIG. 9B-Normally open, anti-aligned | F_{magnetic} + F_{flow} >> F_{restoring} |
| FIG. 9C-Normally closed, aligned | F_{magnetic} >> F_{restoring} + F_{flow} |
| FIG. 9D-Normally closed, anti-aligned | F_{magnetic} + F_{flow} >> F_{restoring} |
| FIG. 9E-Normally open, perpendicular | F_{magnetic} >> F_{restoring} |
| FIG. 9F-Normally closed, perpendicular | F_{magnetic} >> F_{restoring} |

Subsystems that produce an effective off-board or external magnetic field useable by the automatic magnetic valve according to aspects of the invention can vary. One example is a permanent magnet that either moves towards and away from the valve, or vice versa, or both. Another is a permanent magnet, or set or array of permanent magnets, that move sequentially or otherwise past the valve. Another example of a subsystem to produce an effective off-board or external magnetic field useable by the automatic magnetic valve according to aspects of the invention can be an electromagnet intended for a purpose other than valve actuation, to be distinct from a solenoid valve. And, as mentioned, other possible examples of a subsystem to produce an effective off-board or external magnetic field useable by the automatic magnetic valve according to aspects of the invention can be other current-carrying conductors, including motors, transformers, electrical wires, etc.

The material included in the actuator of the automatic magnetic valve that is responsive to an effective off-board or external magnetic field according to aspects of the invention include a variety of magnetic materials. One example is ferromagnetic material, including magnetically “soft” materials like annealed iron, which can be magnetized but do not tend to stay magnetized, and magnetically “hard” materials, can be magnetized and tend to stay magnetized. “Hard” materials have high coercivity, whereas “soft” materials have low coercivity. The overall strength of a magnet is measured by its magnetic moment or, alternatively, the total magnetic flux it produces. The local strength of magnetism in a material is measured by its magnetization.

### 4.5 Specific Embodiments 3-5—Magnetocaloric Cooling Systems

The general principles discussed supra regarding the Generalized Embodiment and Specific Embodiments 1-2 can be applied to a variety of end uses or applications that utilize valve 20 to automatically follow a source 29 of an off-board magnetic field that effectively changes to coordinate flow of a flowable material through the valve 20 in response to variations in that existing magnetic field of a direction and magnitude to move actuator 27 of valve 20. To assist understanding, these principles are discussed in the context of valves 20 used in a magnetocaloric heat pump, which generates a magnetic field to induce magnetocaloric effect in magnetocaloric material(s).

An example of an active magnetic regenerator system is known as the CaloriSMART It is described at www.caloricool.org/area/calorismart-small-modular-advanced-research-scale-test-station or https://www.caloricool.org/area/calorismart-small-modular-advanced-research-scale-test-station (accessed 7 PM on Jul. 24, 2024), incorporated by reference herein. One example 50 is illustrated at FIG. 10A. A housing supports a rotating magnet assembly 54, which uses an electrical motor 32 to rotate the magnet assembly 54 around a vertical axis. A set of fixed magnetocaloric material beds 52 are in the housing. Magnet assembly 54 rotates permanent magnets past those beds 52. A network of fluid flow channels, valves, and a fluid pump 53 coordinate fluid flow between hot and cold heat exchangers 55/56 according to an AMR cycle (see, e.g., FIGS. 10B and 10D-E). Pressure transducers 59 measure the fluid pressure on either side of the magnetocaloric material beds 52. A control circuit (not shown) uses a digital encoder 58 and to modulate position of the dual-opposed syringe pump to realize operation of system 50. The primary purpose of the rotating permanent magnet, which generates a time-varying magnetic field around its axis of rotation, is to be used for the AMR cycle. FIG. 10C illustrates the varying magnetic field in a central gap in the magnet assembly 54 vs. angular position. The measured magnetic field vs. position in the mid-plane of the magnet assembly 54 with the magnetic flux guides removed (left) and inserted (right) are shown. Further discussion can be found at Lucas Griffith, Agata Czernuszewicz, Julie Slaughter, Vitalij Pecharsky “CaloriSMART: Small-scale test-stand for rapid evaluation of active magnetic regenerator performance”, Energy Conversion and Management vo. 199, 1 Nov. 2019, 111948, incorporated by reference herein. The CaloriSMART uses one bed 52, four check valves, and a dual-opposed syringe pump to coordinate fluid flow with the time-varying magnetic field achieved by rotating the permanent magnet assembly. But it generates a time-varying magnetic field.

As can be seen from FIG. 10B, to increase the number of beds 52 from one to two, sets (pairs) of valves 20A/B, 20C/D, and 20E/F must be coordinated in operation to effectuate the correct direction and timing of fluid flow for each AMR cycle. One valve of each pair is normally open (NO) and the other (NC). Thus, rotation of a permanent magnet by each set of valves actuates a closing of the NO valve and an opening of the NC valve. The radial angular position of each valve of the pair can vary slightly relative to the rotational axis of the magnet (and its magnetic field) to design in any timing offset between each valve of the pair. There are reasons a slight offset is beneficial to the AMR cycle. See FIGS. 10D-E for one non-limiting example of valve pair timing relative to an AMR cycle.

FIG. 10D is a schematic of magnetic field and fluid flow profiles normalized by the corresponding maximum values showing the time at high field (tₕ), the time at low field (tₗ), the pumping time (tₚ), the rest time (tᵣ) and the delay time (t_{d}) for an example of an AMR cycle.

FIG. 10E is temperature span as a function of delay time, t_{d}, for cooling powers from 0 to 5 W and pump fractions of 0.8 (▴), 0.7 (♦), 0.6 (▪), 0.5 (♥), 0.4, (▾), & 0.3 (★). Vertical lines (in most cases smaller than the size of the symbol) for the center point of each set show representative standard deviation for three runs.

Valves 20 can be configured to automatically follow the time-varying magnetic field changes used by that heat pump to generate magnetocaloric effect in magnetocaloric material(s) to also open or close, in a coordinated fashion, a set of automatic magnetic valves 20 to effectuate the needed fluid flow to transfer heat according to known principles of magnetocaloric heat pump operation. See, e.g., the following references, each of which is incorporated by reference herein, for background information on magnetocaloric processes,

| | Bibliography |
|---|---|
| Description | ref [#] |
| U.S. Pat. No. 5,743,095 to inventors Gschneidner and Pecharsky entitled | |
| “Active Magnetic Refrigerants Based on GD-SI-GE Material and | |
| Refrigeration Apparatus and Process” (background information on | |
| magnetocaloric heat pumps and flow control). | |
| J. A. Barclay and W. A. Steyert. U.S. Pat. No. 4,332,135, 1982. | [5] |
| C. Zimm, A. Boeder, J. Chell, A. Sternberg, A. Fujita, S. Fujieda and K. | [6] |
| Fukamichi, “Design and performance of a permanent-magnet rotary | |
| refrigerator,” International Journal of Refrigeration, vol. 29, no. 8, pp. | |
| 1302-1306, 2006. | |
| D. Eriksen, K. Engelbrecht, C. Bahl, R. Bjørk and K. Nielsen, “Effects of | [10] |
| flow balancing on active magnetic regenerator performance,” Applied | |
| Thermal Engineering, vol. 103, pp. 1-8, 2016. | |
| L. Griffith, A. Czernuszewicz, J. Slaughter and V. Pecharsky, “Active | [11] |
| magnetic regenerative cooling with smaller magnets,” International | |
| Journal of Refrigeration, vol. 125, pp. 44-51, 2021. | |
| L. Griffith, A. Czernuszewicz, J. Slaughter and V. Pecharsky, | |
| CaloriSMART: Small-scale test-stand for rapid evaluation of active | |
| magnetic regenerator performance, Energy Conversion and | |
| Management 199 (2019) 111948. | |

Specific Embodiments 3, 4, and 5 are described with particular reference to FIGS. 11A-C, 12, 13A-D, 14A-F, 15A-B, 16, and 17A-F. Each of these FIGS. is summarized below to help in understanding of implementation of the inventive automatic magnetic valves into a rotating magnet AMR system, as one non-limiting end application for valves 20.

FIG. 11A is a photo of one non-limiting embodiment of a high-speed magnet 54 with valve 20 and fluid lines attached for an AMR system 50. Hardware has been demonstrated at 300 rpm, with two high field regions, this speed is equal to 10 Hz operation.

FIG. 11B shows a normally closed valve 20A (left) and normally open valve 20B (right) shown during operation with a rotating magnet 54 and with water flow.

FIG. 11C are (left) measurements (∘) and a best-fit line show the magnitude of the magnetic flux density in the region outside the central gap, stray magnetic field, for the regenerator bed and (right) corresponding magnetic force for a specific actuator 27 from a midpoint slope of the experimentally measured magnetic field (∘) and predicted by the best-fit line in black.

FIG. 11D illustrates some design variables of the ball actuator 27 related to FIG. 11C.

FIG. 12 illustrates a picture of the fully assembled Specific Embodiment 4: nine instances of two non-limiting configurations of pairs of 20A(NO) and 20B(NC) valves 20 for flow control for a rotating magnet AMR system 50.

FIG. 13A is a cross-section of the compact magnet concept for Specific Embodiment 4: (left) permanent magnet material 54 is shown in pink and light blue, and soft iron 55 is in grey, with the arrows indicating magnetization directions) and (right) corresponding magnetic flux density B calculations.

FIG. 13B shows geometry of the magnetic circuit with one non-limiting example of magnets 54 for a system 50 shown in blue, steel flux 55 paths in gray, and direction of magnetization shown by arrows. Sketch on the right has some steel pieces 55 removed to better show magnets 54.

FIG. 13C illustrates an example of magnetic flux density at the center cross-section of the magnetic circuit of FIG. 13A and a line plot of the flux density at the radial center of the air gap.

FIG. 13D illustrates magnetic field measured at a fixed point (in the center plane of the magnet assembly 54, at a fixed distance from the magnet shaft) as a function of angular position while the magnet spins at rates corresponding to 1(•), 2(♥) and 4(♥) Hz compared with finite element results shown as a solid grey line.

FIG. 14A is a conceptual drawing of Specific Embodiment 4 with the direction of fluid flow shown in light blue arrows. Whereas Specific Embodiment 3 demonstrated modulation of fluid flow through the valve, Specific Embodiment 4 is designed to also control flow timing (FIGS. 10A-E), as demonstrated infra. FIG. 14A is a sectional view of valve body 21, flow path 24, and valve seat 25 with a diagrammatic view of a full, unsanctioned actuator 27 and its plug end, as well as relative to spring 28.

FIG. 14B is an early prototype in isolated view of a pair of valves 20A/B of the design that connects directly to the regenerator.

FIG. 14C illustrates a cutaway view of the geometry for finite element physics modeling of plural (here twelve) spaced apart magnetic actuators 27 for valves 20A-n (where here n=12) positioned in proximity to the high magnetic flux region occupied by blocks with a permeability of 5 to approximate Gd below its Curie temperature (left). Including the blocks approximating the magnetic behavior of Gd is important because they tend to reduce the stray field in the proximity of the actuators as demonstrated by the increase in magnetic flux density shown by the line plot around the centerline of the high-magnetic-field region (right).

FIG. 14D illustrates the magnitude of the magnetic body force acting on the actuator 27 (solid lines) at the maximum (black) and minimum (blue) distance from the permanent magnet array 54 compared to the force of the spring 28 in the same position (dashed lines) as a function of the actuator tilt with respect to vertical, ϕ. For smooth actuation, the magnetic force should align with the direction of the actuator, ā, and the torque, τ, should be minimal.

FIG. 14E shows, for the actuator nearest the magnet (blue) and farthest from the magnet (black), (left) the fraction of the body force acting normal to the actuator, F̅·ā/|F̅| and (right) the largest component of the torque as functions of ϕ. A ϕ of 15° provides a good compromise between a strong, well-aligned attractive force and near-zero torque acting on the actuator.

FIG. 14F illustrates magnetic force acting on an actuator 27 for a magnet assembly 54 as a function of angular and vertical position as calculated in COMSOL (left) and the fit function used for simulating valve actuation (right).

FIG. 15A illustrates a configuration where the positions of two identical valves 20 around the permanent magnet array 54 lead to a delay in actuation in one valve, e.g., NC, compared to the other. This leads to times when both valves are open regardless of valve orientation with respect to magnet rotation, which is detrimental to fluid flow control.

FIG. 15B shows an actuator position as a function of time for valves 20 with different spring constants and travel distances (left) enable fluid flow profiles that are balanced with a promising pump fraction, though somewhat less than ideal alignment with the magnetic field profile (right).

FIGS. 16A-F illustrate one example of a combined pair of valves 20A (NC) and 20B (NO) that are configured to provide a beneficial angle of ROM of the magnetic actuators 27 in each relative to rotating magnet assembly 54 of an AMR system 50. Heat exchange fluid 61 from the hot-side heat exchanger enters the magnetic valve housing at location “1” in FIG. 16A, flows past the NO actuator 20A when the magnetic field from magnet assembly 54 is low, and leaves the magnetic valve housing for the regenerator at location “2” (fluid flow at 62). Heat exchange fluid 63 from the regenerator 50 enters at location “3”, flows past the NC actuator 20B when the magnetic field is high, and leaves the magnetic valve housing for the hot-side heat exchanger at location “4” (fluid flow at 64). Port “5” connects to a pressure transducer 59. FIGS. 16A-C show valve 20A in section.

The foregoing can be used by those skilled in the art to appreciate design criteria and variations for use of automatic magnetic valves 20 according to the present invention in an AMR system 50, as further discussed below.

### Introduction

Global economic growth is giving more people access to the comforts provided by near-room-temperature cooling, such as safe, comfortable temperatures inside homes and the ability to store and transport food. With the projected additional millions, if not billions, of units predicted to become active by 2050, it is now more important than ever to ensure that this growth is sustainable.

The century-old vapor compression technology presently meeting cooling demands is operating near its efficiency limits [1] (bracketed numbers here refer to the citations in the “References” section infra.) and employs refrigerants that are typically potent greenhouse gases [2] or hazardous. In the United States, where the market growth is relatively stable, commercial, and residential air conditioning, refrigeration, and freezing use many quads (each quad equal to 1 quadrillion (10¹⁵)BTU)% of energy, equivalent to about half of electricity generation. Magnetocaloric cooling has the potential to increase efficiency by an estimated 20%, which would lower electricity demand by at least a significant number of quads, saving trillions of dollars in the United States alone. By replacing vapor-compression systems with more efficient magnetocaloric cooling systems [3], the elimination of direct emissions and reduction in indirect emissions, from more efficient use of electricity from coal-fired power plants, could reduce annual CO₂ emissions owing to near-room-temperature cooling by about two thirds.

At the heart of the promise of magnetocaloric cooling is that it leverages quantum effects to achieve cooling, rather than the mechanical work used by vapor-compression devices. Materials exhibiting the direct magnetocaloric effect [4], held near their Curie temperature, undergo a reversible increase in temperature when the magnetic field is increased under adiabatic conditions, i.e., they return to their initial temperature when the magnetic field returns to its initial state if also done under adiabatic conditions. Harnessing this effect in the Active Magnetic Regenerator (AMR) cycle [5] allows heat to be lifted across a span that can be several times higher than the adiabatic temperature change of the refrigerant. The AMR cycle consists of four steps:
1. Apply a magnetic field that causes the magnetocaloric refrigerant to warm up.
2. Flow heat transfer fluid from the cold side, toward the hot side, carrying that heat outside the regenerator where it can be exhausted.
3. Remove the magnetic field, causing the magnetocaloric refrigerant to cool down.
4. Flow heat transfer fluid from the hot side, toward the cold side where the fluid, cooled by the refrigerant, can absorb heat from an external load.

Great gains in the efficiency of AMR cooling devices have been achieved [6] [7], and there are promising pathways to further improvements. At present the high capital cost of magnetocaloric cooling, largely driven by the permanent magnet array [8], limits its economic viability.

A key principle in recent permanent magnet array designs is alternating high and low magnetic field volumes that can be spun around a nearly continuous band of refrigerant [9]. The advantage of this design is that it can reduce the torque, and therefore power, required to spin the permanent magnet array to apply the alternating high and low magnetic fields [7]. To achieve the flow from the hot to the cold end of the regenerator when the magnetic field is low and from the cold to the hot end of the regenerator when the magnetic field is high, however, it is necessary to have walls separating portions of the refrigerant band into multiple regenerators to allow the cyclically opposing flows. Ensuring equal flow to all the regenerators [10] that is properly synchronized with the changes in magnetic field [11] requires a flow distribution system, similar to intake manifolds in internal combustion engines.

Throughout magnetic refrigeration development, a handful of different flow distribution systems have been used. Early designs used a rotating seal that suffered from friction heating and reductions in seal efficacy at operating frequencies of around 4 Hz [6]. Electronic control of flow distribution with solenoid valves eliminated these problems [9], but we estimate the power to drive the valves, neglecting control circuitry, lowered device COP by about 5-10%. Poppet valves run by a camshaft provide relatively efficient, robust solution lowering the COP by only about 1% [7]. We seek to achieve further reduction in system complexity, cost, and losses in a way that is also scalable across a range of system cooling powers.

We describe the design of a valve that uses stray (off-board or external of the valve) magnetic field from the rotating magnet used to generate heat in magnetocaloric refrigerant to directly couple flow through the regenerators with changes in the applied magnetic field as the permanent magnet array spins. We will describe how such a valve can be compact, cheap, and efficient, especially for AMRs that are small relative to standard plumbing sizes.

The valve comprises a ferromagnetic actuator or element and a spring that are placed inside of the fluid channel, therefore, the main forces acting on the actuator are those from pressure of a static or flowing fluid, the force from the spring, and the varying magnetic attractive force owing to the spinning permanent magnet array.

Design considerations for the system led the control valves to be placed on the hot side of the regenerators. To achieve the desired AMR flow profile in multiple regenerators with flow control on the hot side of the system, the regenerator inlets must be open in low magnetic field and closed in high magnetic field, i.e., Normally Open Valve (NOV), and the regenerator outlets must be closed in low magnetic field and open in high magnetic field, i.e., Normally Closed Valve (NCV). A NOV can be constructed such that either the spring force and magnetic force are aligned, opposing the fluid pressure drop across the valve or such that the magnetic force and static pressure are aligned, opposing the spring force. In the former case the spring sets the absolute minimum pressure drop across the valve, commonly referred to as a cracking pressure, and the combination of the spring and magnetic forces set the maximum pressure drop across the valve. In the latter case, the minimum pressure drop across the valve is determined by the flow path alone, while the maximum pressure drop across the valve is determined by the strength of the spring, which must also be weak enough to be closed in the high magnetic field. Similar arguments hold for the NCV design.

Since a low pressure drop across the entire system is crucially important for efficient magnetic refrigeration, the NOV is constructed with the magnetic field and pressure drop forces aligned against that of the spring, and the NCV is constructed with the spring and pressure drop forces aligned against that of the magnetic force. In this example, the valves are designed for about 1 PSI pressure drop across each regenerator. Estimating spring and magnetic forces on a valve actuator as a function of position around the permanent magnet assembly, then integrating those forces numerically provides an estimate of valve operation that aids in sizing and design. Using this information, a valve is designed and tested in a multi-regenerator magnetic refrigerator system. Pressure drop across the valve housings is measured outside the system. Valve operation at AMR cycle frequencies from 1 to 7 Hz is demonstrated with measurements of differential pressure across the nine regenerators.

### Modeling

Simple solutions of Newton's second law given known forces acting on the actuator provided a useful guide for actuator and spring sizing. In low magnetic field, Hook's law gives the net force acting on the actuator, Fₛ, at some position, d, relative the equilibrium position of the spring, dₑ, allowing a range of actuator masses and compatible spring constants, c, to be determined from the target 4 ms actuation time, assuming a given actuator travel between open and closed positions. See Equation (1) as follows:

$${F}_{s} = c ( d - {d}_{e} ) \qquad Eq . ( 1 )$$

A permanent magnet array designed for a system 50 described supra provides a starting point for valve design. In addition to the block neodymium iron boron magnets and magnetic steel flux return ring, blocks with a magnetic permeability of 5 estimate the effect of regenerator beds on the stray (off-board) magnetic field, defined as the magnetic field around the permanent magnet in the volume outside the regenerator beds. The magnitude of the stray (off-board) magnetic field gradient allows estimation of the attractive force, F, on a soft magnetic material with bulk magnetization M, and volume V according to Equation (2) as follows:

$${F}_{m} = - MV ∇ B \qquad Eq . ( 2 )$$

Preliminary estimates suggested a ⅛″ diameter 1 cm long magnetic stainless-steel cylinder be used as the actuator. Fluid fittings required the end of the spring be elevated at least 6 mm above the top of the regenerator bed. To maximize the attractive force, 4 mm long compression springs, were assumed. With a minimum spring length of about 2 mm, the forces on the actuators were first modeled at 8 and 10 mm above the regenerator bed ends. The resulting magnitude of the forces and the largest component of the torque are shown as a function of the angle with which the cylinder is rotated about an axis through its center of mass, in a direction tangent to the permanent magnet array face, ϕₐ. A ϕₐ of 15° provides a good compromise between a high actuation force to give good control authority, and a low torque that could cause the actuator to bind. To estimate valve timing, the operation of the valves can be simulated by integrating the forces acting on them while the magnet spins. This requires force estimates as a function of the angular position of the actuator relative to the permanent magnet array, θ, and the distance along the actuation path, d. By definition, θ is 0 when the center of the actuator aligns with the center of the high magnetic field region. A handful of simulations are sufficient to get a decent picture of the angular dependence of the force at a set d. Ten different values of d are calculated. This process yields force estimates at 240 different positions around the magnet with 40 COMSOL magnetostatic solutions. The results, as summarized in FIG. 14F, showed that there is a significant oscillation in the force with angular position. This is a consequence of the impact of the regenerator beds on the magnetic field distribution. The force is estimated as an arctangent function with a sinusoidal oscillation imposed which closely follows the shape of the finite element results as a function of 6 and d.

This function provides a way to estimate the force at any angular or vertical position, however, it underestimates the steep drop in attractive force closest to 50° then overestimates others. This feature is challenging to fit directly but could potentially be estimated more accurately by using COMSOL to compute a denser grid of force values and interpolating that directly.

The sum of the magnetic and spring forces is integrated for an initially stationary actuator in the low-magnetic-field region. The integration runs until the actuator reaches the extreme of the travel. The velocity is set to zero and then integration continues until the actuator reaches the initial position. This scheme assumes perfect stops, omitting any “ringing” the actuator may do. The angular separation between the NOV and NCV results in different actuation times for each, as summarized in FIG. 15A-B. This presents a challenge for controlling fluid flow. Sensitivity of the device performance to the timing between the magnetic field and fluid flow profiles must be considered by the designer.

The following changes can, in principle, give the necessary control over the fluid flow timing:
varying the distance between the valves and the permanent magnet assembly,
varying the angular positions of the valves,
varying the spring pre-compression,
varying the actuator travel, or
using different spring constants in the two valves.

Moving the valves further away will reduce the available force of attraction, making fast actuation difficult if not impossible. Similarly, for Specific Embodiment 3 the housing prevents altering the angular position of the valves in any meaningful way. Given the targets and constraints of the present system design, the most promising options are varying the actuator travel and making the spring constants of the two valves different.

A smaller spring constant in the NCV means that it opens and closes at lower magnetic fields, which can result in a corresponding improvement in timing. Since each valve provides flow across the regenerator in a different direction, a fluid flow profile can be visualized by assigning values of zero to both valves when they are closed, a value of 1 to the NOV when it is opened, and a value of −1 to the NCV when it is opened. This gives a rough sense of what a fluid flow profile may look like. For example, selected values of 70 and 20 Nm⁻¹ for the spring constants for the NOV 20 and NCV 20 discussed herein, respectively, essentially eliminates periods when both valves are open. These values are at the extreme low-end of the commercially available range and may require a custom order to get the necessary length, material construction, etc. The balance between flow in the positive and negative directions is also promising. The pump fraction is large, which can reduce pumping losses if aligned properly. Unfortunately, the flow periods persist through the periods where the magnetic field changes, which is known to be detrimental to regenerator performance. Modifying the clamps to allow rotating the valves slightly with respect to the regenerators could fix the alignment.

This means that when the magnetic field transitions from low to high, the inlet closes before the outlet opens, i.e., both inlet and outlet are briefly closed, as is desired. However, when the magnetic field transitions from high to low, the inlet valve can open before the outlet valve closes, i.e., both inlet and outlet are briefly open. Given the large flow resistance of the packed-spherical-particle-bed regenerators, this will result in recirculation of fluid on the hot side of the regenerator, raising pumping losses and reducing system performance.

### Housing Design

The MV 20 housing design was modified to adjust the timing between the field and the flow and fully parameterized in Solidworks solid modeling computer-aided design (CAD) and computer-aided engineering (CAE) application published by Dassault Systèmes of Vèlizy-Villacoublay, France to allow fast modifications. The magnetic material actuators 27 are positioned such that the transition in magnetic field passes them ahead of the regenerator bed for a clockwise (when looking down from the hot-side heat exchanger) permanent magnet assembly 5x rotation, ensuring fluid flows in the proper direction when the magnetic field in the regenerator changes. FIGS. 16A-C show the ports where fluid: 1) enters the MV housing 21 from the hot-side heat exchanger and flows past the Normally Open, NO, actuator 27A, when the magnetic field is low, 2) exits the MV housing for the regenerator, 3) enters the MV housing from the regenerator and flows past the Normally Closed, NC, actuator 27B, when the magnetic field is high, 4) exits the MV housing for the hot-side heat exchanger, and 5) pressure transducers are connected. The perspective is such that transitions in magnetic field proceed from right to left in FIGS. 16A-C when the magnet spins.

FIGS. 16D-E show how a valve set like FIG. 16A can be mounted to system 50 with supporting ring 76A and steel ring 76B. FIG. 11F shows details of angular relationship of mounting positions of valves 20A and B relative to each other and to a rotating magnet or magnets.

Joining the NOV and NCV actuators 27A and B in a single MV housing 21 has the benefits of being compact and providing the largest flat, square surface for setting the angle of the regenerators with respect to the permanent magnet assembly 29. The drawback is that, during the development phase, a new MV housing 21 must be printed for each combination of actuator length, spring diameter, and spring length.

### Experiments

Preliminary tests for the magnetic valves aimed to determine their ability to modulate flow in a functioning system and to what extent the initial design achieved the target flow profile: long periods of pumping starting around the time of a magnetic field transition and ending before the next magnetic field transition.

Springs of the same length with different nominal constants, c, of 0.03, 0.04, and 0.05 lbf mm⁻¹, were sorted into pairs for the NOVs and NCVs 20A and B and assembled into the system. Since the valves were designed around a low-pressure drop regenerator geometry (parallel plates), the flow through the beds of packed spherical particles was limited so that at moderate inlet pressures, the NOV spring could not open against the flow force F_{f}. FIG. 17A shows a representative set of the measured differential signals (wired as pressure on the hot side minus pressure on the cold side) for the indicated spring constants for the NOVs and NCVs. Pressure measurement is not synchronized with magnet position for this system, so about 1.5 periods are measured to ensure that at least one full period is clearly visible. Data taken when the magnet is not spinning, not shown here, indicate that the large pressure fluctuations when the pressure is high on the hot side are due to pulsed flow from the diaphragm pump. In these measurements, the pressure transducers did not all give the same value at the same pressure, which shifts the pressure drop measurements uniformly so different regenerators cannot be directly compared. Nevertheless, the resulting pressure drop measurements are useful for qualitatively evaluating valve function.

FIG. 17A illustrates measured differences between the hot side and cold side pressures for 2 V applied to the pump and 1 Hz operating frequency, showing that the combination of c_{NO} of 0.03 lbf mm⁻¹ and c_{NC} of 0.05 lbf mm⁻¹ (top left) minimizes the time that both valves are open, while that of c_{NO} of 0.05 lbf mm⁻¹ and c_{NC} of 0.03 lbf mm⁻¹ (top middle and right) results in the longest time where both valves are open, as highlighted with the red circle.

All valves except one, in the middle of the bottom row of FIG. 17A, show alternating periods of positive and negative differential pressure, indicating alternating flow across eight of the nine regenerators. At this stage, the small signals and relatively large oscillations make gauging the balance of flow in each direction difficult. The red circle in the top center panel highlights a feature present in many of the plots where oscillations in pressure drop are large and overall pressure drop is small. Taking this as periods when both NOVs and NCVs are open and estimating this time from a few datasets shows that, as expected, the pair with the stiffer NCV spring, shown in the top left of FIG. 17A, has the lowest average time, 0.013 s; pairs with identical spring constants have a longer average time, 0.036 s; and pairs where the NCV spring is softer than the NOV spring has the longest average time, 0.066 s.

Based on these data, all the valves were reassembled with a spring constant of 0.03 lbf mm⁻¹ in the inlet NOV and 0.05 lbf mm⁻¹ in the outlet NCV. FIG. 17B shows the pressure drop across the beds for 1 Hz operation with 2 V applied to the pump. For these measurements, the readings of the pressure transducers at ambient pressure were recorded and subtracted out to allow more direct comparison between readings. Since positive pressure drop corresponds to the hot-to-cold blow, i.e., chilled water delivered to the cold side, these periods are outlined with blue lines and, similarly, negative pressure drops are outlined with red lines. For the system to function as intended, the flow volumes for both the hot-to-cold and cold-to-hot blows need to match, and that volume should be the same for each regenerator. For each individual regenerator, the balance between the two blows can be evaluated based on the time the pressure drop is negative vs. the time it is positive, as well as the magnitude of the pressure drops during these times. For six of the regenerators, the time for the cold-to-hot blow, tₗ, is longer than the hot-to-cold blow, tₕ. The relative flow volumes of the two blows are difficult to estimate owing to the large oscillations in pressure drop compared to the signals, which are on the low-end of the range of the pressure transducers. The comparison of flow volume between regenerators can be roughly estimated by the swing from positive pressure difference (averaged over tₕ) to negative pressure difference (averaged over tₗ), ΔP_{d}. Since the full range of ΔP_{d} is about 30% of the average, the flows through the nine regenerators are almost certainly too dissimilar for efficient HPD device operation. It is worth mentioning that the balance of the flow distributed amongst the regenerators depends on the entire flow circuit of which the valves are only one part.

FIG. 17A shows measured differences between the hot side and cold side pressures for 2 V applied to the pump and 1 Hz operating frequency show that the combination of c_{NO} of 0.03 lbf mm⁻¹ and c_{NC} of 0.05 lbf mm⁻¹ (top left) minimizes the time that both valves are open, while that of c_{NO} of 0.05 lbf mm⁻¹ and c_{NC} of 0.03 lbf mm⁻¹ (top middle and right) results in the longest time where both valves are open, as highlighted with the red circle.

FIG. 17B shows pressure drop data indicating flow modulation for 9 regenerator beds 52 with spring constants c_{NO} of 0.03 lbf mm⁻¹ and c_{NC} of 0.05 lbf mm⁻¹.

A core target for Specific Embodiment 3 is to explore operating frequencies of 7 Hz and possibly above. FIG. 17C shows the pressure drop measured across a representative regenerator bed measured for 1.5 seconds for operating frequencies of: top left, 1 Hz; bottom left, 2 Hz; top right, 5 Hz; and bottom right, 7 Hz. The modeling effort neglected any forces on the actuators from the fluid, so it was unclear whether the valve design would actuate at the high frequencies. Based on the pressure drop data, the valves are clearly modulating the flow up to 7 Hz.

### Specific Embodiment 4: Magnetic Cam Variation

FIGS. 18A-E illustrate one non-limiting AMR system 50 with automatic magnetic valve pairs 20A/B arranged around a so-called magnetic cam 80 (see FIG. 19C) to achieve the target flow profiles. By using hard magnetic material for both the magnetic field source 29 and magnetic actuators 27, the magnetic force can alternatively attract and repel the actuators. Here we adopt the convention that normally open valves are open when the magnetic force repels the actuator and closed when the magnetic force attracts the actuator, and normally closed valves are closed when the magnetic force repels the actuator and open when the magnetic force attracts the actuator.

FIG. 18A shows an experimental proof of concept with valves 20A and 20B actuated by action of an electric motor 32 to spin a magnetic cam 70, here a permanent magnet array constructed for the sole purpose of controlling flow for an AMR system 50.

FIG. 18B shows a schematic of the magnetic field lines and magnetic forces acting on two permanent magnets with (left) attraction between aligned permanent magnets and (right) repulsion between anti-aligned permanent magnets.

FIG. 18C shows a version of magnetically cammed valves in an AMR system 50 with magnetic cam system 80 with one set of valves 20A/B only for illustration (left) and the magnet cam 74 (right) with magnetization direction shown with black arrows. Cam 74 includes two sets each (four sets total) of magnets 82A-C and 86A-C with different magnetic directions to give varying off-board generated magnetic fields over angular ranges 83(×2) and 87 (×2) to provide varying magnetic fields to control timing of opening/closing of valves 20A/B. As can be appreciated, slots 79 would allow rotational adjustment of the magnets sets relative to the rotational axis at their center to fine-tune the timing.

FIG. 18D illustrates radial forces on the two actuators of FIG. 20A as a function of rotation estimated using COMSOL. Negative forces are toward the center of rotation, positive forces are away from the center.

FIG. 18E Shows two non-limiting examples of hard magnetic actuator assemblies: the left having three miniature springs 28 combination of hard magnet (pink) and ferromagnetic (blue) actuator 27 and a valve seat 25 comprising contacting faces of the actuator and housing and the right having a single larger spring 28, combination of hard magnet (pink) and ferromagnetic (blue) actuator 27 with an attaching structure 94 to allow affixing an o-ring 95 to the valve plug end 26, and valve seat 25 comprising a conical groove.

### REFERENCES CITED IN SPECIFIC EMBODIMENT 3 (IN SQUARE BRACKETS)

[1] J. M. Calm, “The next generation of refrigerants-Historical review, considerations, and outlook,” International Journal of Refrigeration, vol. 31, no. 7, pp. 1123-1133, 2008.
[2] J. M. Calm and D. A. Didion, “Trade-offs in refrigerant selections: Past, present, and future,” International Journal of Refrigeration, vol. 21, no. 4, pp. 308-321, 1998.
[3] W. Goetzler, “Energy Savings Potential and RD&D Opportunities for Commercial Building HVAC Systems U.S. DOE,” United States Department of Energy, 2017.
[4] W. Giauque, “A thermodynamic treatment of certain magnetic effects. A proposed method for producing temperatures considerably below 1 absolute,” Journal of the American Chemical Society, pp. 1864-1870, 1927.
[5] J. A. Barclay and W. A. Steyert.U.S. Pat. No. 4,332,135, 1982.
[6] C. Zimm, A. Boeder, J. Chell, A. Sternberg, A. Fujita, S. Fujieda and K. Fukamichi, “Design and performance of a permanent-magnet rotary refrigerator,” International Journal of Refrigeration, vol. 29, no. 8, pp. 1302-1306, 2006.
[7] D. Eriksen, K. Engelbrecht, C. R. Haffenden Bahl and R. Bjørk, “Exploring the efficiency potential for an active magnetic regenerator,” Science and Technology for the Built Environment, vol. 22, no. 5, pp. 527-533, 2016.
[8] S. L. Russek and C. B. Zimm, “Potential for cost effective magnetocaloric air conditioning systems,” International Journal of Refrigeration, vol. 29, no. 8, pp. 1366-1373, 2006.
[9] S. Jacobs, J. Auringer, A. Boeder, J. Chell, L. Komorowski, J. Leonard, S. Russek and C. Zimm, “The performance of a large-scale rotary magnetic refrigerator,” Elsevier Ltd and IIR, 2014.
[10] D. Eriksen, K. Engelbrecht, C. Bahl, R. Bjork and K. Nielsen, “Effects of flow balancing on active magnetic regenerator performance,” Applied Thermal Engineering, vol. 103, pp. 1-8, 2016.
[11] L. Griffith, A. Czernuszewicz, J. Slaughter and V. Pecharsky, “Active magnetic regenerative cooling with smaller magnets,” International Journal of Refrigeration, vol. 125, pp. 44-51, 2021.
[12] A. Kitanovski, J. Tušek, U. Tomc, U. Plaznik, M. Ožbolt and A. Poredoš, Magnetocaloric energy conversion-From theory to applications, Springer, 2015, p. 456.
[13] R. Hooke, Lectures de Potentia Restitutiva, Or of Spring Explaining the Power of Springing Bodies, John Martyn, 1678.
[14] S. Qian, D. Nasuta, A. Rhoads, Y. Wang, Y. Geng, Y. Hwang, R. Radermacher and I. Takeuchi, “Not-in-kind cooling technologies: A quantitative comparison of refrigerants and system performance,” International Journal of Refrigeration, vol. 62, pp. 177-192, 2016.

### Additional Information: Dual Magnetic Valve Example for Use with Magnetic Cam Variation of Specific Embodiment 4

With reference to FIGS. 19A-J, more details about dual magnetic valves integrated into a single housing 66 are shown. Each valve 20A and B operates according to principles discussed herein (a magnetic actuator 27 is influenced towards or away from a valve seat/seal 25 along a flow path 24 through the housing 66 in response to an off-board magnetic field). The pair of valves 20 can be implemented with respect to a magnetocaloric regenerator, which needs a timed coordination of fluid flow to each regenerator bed. As indicated at FIG. 19A, plural dual magnetic valve housings 66 can be operatively positioned around the perimeter of a rotating magnet or magnetic cam (as discussed above) to allow coordinated valving timing of a plurality of pairs of valves 20. The number can be scaled up or down according to need or design.

As can be seen by these FIGS., each valve 20A and B has a fluid inlet (see arrow) and outlet (see arrow) along a flow path 24 through each valve. A magnetic actuator 27 having a form factor that is complementary with the interior flow path 24 of each valve has a range of movement towards and away from a valve seat or seal 25 in each valve. Each actuator 27 is influenced into a normal position (e.g. NC or NO) by a spring acting as a restoring force 28. There can be a single spring or multiple springs, as indicated in these figures. A rotating magnet or magnetic cam of a magnetocaloric regenerator 50 that provides a varying magnetic field to the regenerator beds (or other magnetocaloric component) that is in or near the plane with all of the valve pairs of valves of FIG. 9A provide the varying magnetic field to actuate each valve 20 between a normal position in the presence of low magnetic field strength (insufficient to overcome restoring force to the actuator) to an actuated position in the presence of high magnetic strength (sufficient to overcome restoring force). The varying magnetic field strength and gradient are engineered, along with the characteristics of the magnetic actuators 27, their direction and range of motion, and the direction and magnitude of the restoring force 28 in each valve, to coordinate valve openings and closings according to the principles and aspects described earlier.

FIGS. 19A-J help show one non-limiting example of such valves, including indications of size and scale. As will be appreciated by those skilled in the art, the spacing of each valve 20A and B of any valve pair relative to each other around the perimeter of rotation of the magnetic cam, as well as the spacing from and angle towards the perimeter of the magnetic cam, can be designed to provide the needed coordinated flows for a magnetocaloric regenerator. Similar principles can be applied regarding valves according to aspects of the invention in other applications, whether controlled in sets in a coordinated fashion, or just a single valve with individual control.

FIGS. 19A-J show one non-limiting example of the components and operation of such a valve 20. In this example, valve body 66 housing two engineered and formed flow channels 24A and B. Each channel 24 has a first portion closest to the rotating magnet or magnetic cam that housing a magnetic actuator 27 that has a complementary exterior form factor to the interior form factor of the flow channel to allow it to move over a range of motion in that first channel portion. A second channel portion remote from the rotating magnet or magnetic cam, and more easily accessible for assembly, maintenance, or repair, has a removable retaining member 67 that can close off flow path 24 to the exterior. In one non-limiting example, it can have exterior threads to allow it to be threadably secured to interior threading of the second channel portion. In-between the first and second channel portions is a valve seat or seal 25 that allows a plug end 26 of magnetic actuator 27 to seal against. Seat or seal 25 can also, in some embodiments, act as a mechanical stop to limit range of motion of actuator 27 in a direction from the first portion of flow channel 24 to the second portion.

The exploded view of FIG. 19C illustrates one example of a pair of flow channels 24A/B, a pair of removable retaining members 67A/B, and a pair of magnetic actuators 27A/B. The restoring force 28A for just magnetic actuator 27A is shown, here comprising three small springs that can be held in position with a spring retainer disc 68 with three complementary apertures to receive the springs. A similar set of springs and retainer would provide restoring force for magnetic actuator 27B of the second flow path 24B but are not shown in FIG. 19C. Springs 28 and retainers 68 would be held in position when the valves are assembled to provide the desired restoring force, as can be understood by reference to the other views of FIGS. 19A-J, including FIG. 19H which shows a magnetic actuator 27 sectioned along its longitudinal axis in place in a flow channel 24 shown in section view, in particular, showing actuator 27 in-between restoring force spring 28 and valve seat/seal 25. As will be appreciated, the range of motion of an actuator 27 only has to be sufficient to block or unblock flow through flow channel 24 according to what is needed in a particular application. In the embodiment of FIGS. 19A-J, that range of motion need only be slight (e.g. millimeter scale). As discussed earlier, range of motion can vary according to need and desire by considering the parameters discussed earlier herein. FIG. 19E helps understanding of how multiple dual valve bodies 66A to 66n, each body 66 with a pair of automatic magnetic valves 20, can be configured to have all of their first portions of their flow channels 24 near the perimeter of the rotating magnet or magnetic cam, but have inlets and outlets from each flow channel 24 routed to and from each flow channel 24.

### 4.5 Options and Alternatives

As will be appreciated by those skilled in the art, variations, options, and alternatives can be made to the foregoing exemplary embodiments while practicing one or more aspects of the present invention. A number of such variations, options, and alternatives have been described supra. Further information about the same follows.

### 4.5.1 Housing or Valve Body

As discussed earlier, the housing or valve body that houses and constrains ROM of the actuator can take a variety of forms and embodiments. Some characteristics can include:
a. At least substantially non-responsive to the effective off-board magnetic field that is used to actuate movement of the actuator, meaning that its materials and form factor do not block or disrupt that effective off-board magnetic field to make valve operation ineffective.
b. Effective to provide a desired flow path for the particular flowable material to be controlled in flow. Metals, ceramics, some plastics, and other materials are possible.
c. Effectively robust relative to the particular flowable material to be controlled including in terms of having a desired useful operating life with degradation making it ineffective. This relates both to structural robustness and resistance to degradation by both the pressures of forces acting on it and the chemical makeup of the flowable material.
d. May include ferromagnetic materials to enhance the magnetic field interacting with the magnetic material actuator.

### 4.5.2 Actuator

As discussed earlier, the magnetic material actuator 27, its ROM, and how it changes state of flow of the flowable material can take a variety of forms and embodiments. Some characteristics can include:
a. Effective to move over a desired ROM or fraction thereof in response to the effective off-board magnetic field that is used to actuate movement of the actuator, meaning that its materials and form factor do not respond to other typical forces that the valve will experience in a manner to make valve operation ineffective.
b. Typically, a ferromagnetic material at least in part.
c. Effectively robust relative to the particular flowable material to be controlled including in terms of having a desired useful operating life with degradation making it ineffective. This relates both to structural robustness and resistance to degradation by both the forces acting on it and the chemical makeup of the flowable material.

A variety of alternative possibilities for how magnetic actuator 27 can block flow in valve body 21 are possible. A few non-limiting examples follow.

FIG. 18E illustrates (left side) a valve 90 that can have an actuator 27 with a plug end or surface that creates a face seal 91 with a complementary valve seal or seat (or surface) in valve body 21. In comparison, FIG. 24 (right side) illustrates an alternative valve 93 with a carrier end 94 of actuator 27 that carries an o-ring 95 which seals or seats in complementary geometry of valve body 21.

### 4.5.3 Restoring Force Component or Technique

As discussed earlier, in some embodiments of the invention a restoring force component is used to hold the actuator in an initial position along its ROM, and it can take a variety of forms and embodiments. Some characteristics can include:
a. Effective to hold the actuator in intended initial position relative to any other forces acting upon it, including force of the flowable material.
b. Typically, an elastic material with a spring constant correlated to maintaining initial position of the actuator until overcome by magnetic force of an effective off-board magnetic field acting upon the actuator to move the actuator away from the initial position.
c. Effectively robust relative to the particular flowable material to be controlled including in terms of having a desired useful operating life with degradation making it ineffective. This relates both to structural robustness and resistance to degradation by the forces acting on it or the chemical makeup of the flowable material.

With particular reference to FIGS. 8A-B, one possible alternative embodiment for providing restoring force F_{restoring} to an automatic magnetic valve according to aspects of the invention is use of gravity. As illustrated, the orientation of valve 20 relative the center of the earth could be set during operation to take advantage of the mass of magnetic material actuator 27 as F_{restoring}. Actuator 27 can have freedom of movement along its ROM without any spring or elastic element, as in other embodiments.

In FIG. 8A (left side), the mass of actuator 27 would hold it in lower NO (normally open) position along its ROM when insufficient off-board magnetic field 29 to overcome the effects of gravity on its mass is present. Provision of an effective off-board magnetic field 29 (right side of FIG. 8A) provides a magnetic force F_{magnetic} that overcomes gravity as F_{restoring} (and any other competing forces including F_{flow}) to attract actuator 27 up and seat it to block flow.

Alternatively, in FIG. 8B (left side), the mass of actuator 27 would hold it in lower NC (normally closed) position along its ROM when insufficient off-board magnetic field 29 to overcome the effects of gravity on its mass is present. Provision of an effective off-board magnetic field 29 (right side of FIG. 8B) provides a magnetic force F_{magnetic} that overcomes gravity as F_{restoring} (and any other competing forces including F_{flow}) to attract actuator 27 up and unblock flow.

With particular reference to FIGS. 18B, one possible alternative embodiment for providing restoring force F_{restoring} to an automatic magnetic valve according to aspects of the invention is use of the repulsive force between two permanent magnets with opposite magnetic moments. As illustrated, the orientation of a hard magnet in valve actuator 27 relative the off-board magnetic field generator could be set during operation to take advantage of e.g. repulsive magnetic force as F_{restoring}. Actuator 27 can have freedom of movement along its ROM without any spring or elastic element, as in other embodiments.

### 4.5.4 Effective Off-Board Magnetic Field

As discussed earlier, the terms “off-board magnetic field or source”, “external magnetic field or source”, and sometimes “stray magnetic field”, or combinations of any of the same, is/are used to mean one that is effective to overcome any resisting forces (e.g., restoring force or, in some cases, force of the flowable material depending on valve configuration) to move a given actuator along its ROM in the housing or valve body according to some useful varying field strength. As such, the term does not refer to random or ambient weak magnetic field as can exist. Some characteristics of an effective off-board magnetic field can include:
a. Effective to overcome forces holding the actuator in intended initial position, including force of any restoring force or that of the flowable material.
b. Sometimes varying in field strength for or because of another function or purpose than moving the actuator of the valve, but this is not necessarily a required limitation to the invention. For example, it is envisioned there could be advantages of using an automatic magnetic valve or valves according to aspects of the invention as a flow control valve or valves using an effective off-board magnetic force to both move its/their ferromagnetic actuator(s) along its/their ROM(s) without an on-board magnetic field source, control circuit or electrical power source or connection for flow control and also for another purpose (e.g. magnetocaloric effect in a magnetocaloric heat pump as one non-limiting example). But the off-board effective magnetic field could also be dedicated to the valving flow control function (e.g. to turn a water faucet on or off).
c. Typically having some ability to adjust or tune either the strength of the effective off-board magnetic field, or its variance between strong and weak.
d. In some examples, the off-board magnetic field is from a permanent magnet or array of permanent magnets that, by some technique, can be moved towards the magnetic material actuator in the valve to impose a stronger magnetic field and magnetic force on the actuator to move it along its ROM and overcome any resisting forces, or moved away from the actuator such that its magnetic field and force is no longer effective to move the actuator along its ROM. The ways to do so can vary. A rotating permanent magnet arrangement could have some motive means to sequentially pass to nearer the actuator to actuate it with its effective off-board magnetic field (based on selection of the magnet(s) and its/their magnetic flux) and then away for the actuator sufficiently to remove the effective off-board magnetic field from the actuator. One or more magnets could be placed nearer the perimeter of a wheel and the motive means could turn the wheel to move each magnet towards and away from the actuator. Just one permanent magnet could be on the wheel, or a plurality of permanent magnets at spaced away locations around the wheel. Alternatively, sets or arrays of permanent magnets can be used instead of individual discrete permanent magnets. The electric motor or other motive means to move the magnet(s) relative the valve body and magnetic material actuator of each automatic magnetic valve according to the invention could have some type of control circuit to adjust rotational movement of the wheel according to need or desire. Other motive means are possible. Non-limiting examples include linear actuators that could controllably move a permanent magnet or array of the same towards and away from the actuator in the appropriate direction of movement to influence the desired movement of the actuator along its ROM. Permanent magnets can take many forms including but not limited to metal-based or composite metal-based.
e. In other examples, the stray magnetic field is from an electromagnetic or other powered source of a magnetic field, where its magnetic field can be controlled to become an effective off-board magnetic field to influence movement of the actuator along its ROM in terms of magnitude and direction of magnetic force. It can also be controlled to change or remove the magnetic field so that it is no longer an effective off-board magnetic field to move the actuator.

### 4.5.5 Flowable Material

As discussed earlier, in some embodiments of the invention the flowable material is a fluid or liquid; for example, a heat transfer fluid effective for use in a magnetocaloric heat pump. As will be appreciated by those skilled in the art, the aspects of the invention of controlling flow can be applied to a variety of materials or substances that flow. This can include liquid, gas, or even solid state. Some characteristics can include:
a. The material or substance can both flow through a flow path and effectively be fully or partially blocked by an actuator element of the type described herein, or such an actuator element in cooperation with some type of valve seat, form factor, or surface.
b. Any solid phase material should be flowable, and typically would be particulate in form.

Some non-limiting examples include:

Liquid state:
water
ethylene glycol
hydrocarbons
alcohols
liquid metals
mixtures of any number of liquids
   Gas state:
air
nitrogen
argon
refrigerants
any mixture of gases
   Solid state:
loose particles substantially smaller than the ROM
particles plastics, metals, ceramics or other materials mixtures of particles and either gases or liquids.

What is claimed is:

1. An automatic magnetic valve comprising:
a. a housing to direct a flowable material through the housing along a flow path within the housing;
b. an on-board actuator of at least in part magnetic material, the actuator having freedom of movement along a range of motion (ROM) in the housing that at least either partially allows or blocks the flow path of flowable material in response to a first direction and magnitude of an off-board magnetic field that is effective to move the actuator along its ROM; and
c. a restoring force component in or at the housing that opposes movement of the actuator caused by the first direction and magnitude of the off-board magnetic field;
d. so that the magnetic actuator in the housing automatically follows changes in the off-board magnetic field to allow coordinated flow of the flowable material relative the flow path in response to changes in the off-board magnetic field.

2. The automatic magnetic valve of claim 1 wherein the housing comprises a valve body with a valve seat and the actuator comprises a valve plug that seats in the valve seat.

3. The automatic magnetic valve of claim 1 wherein the housing comprises substantially magnetically non-responsive material to allow passage of the off-board magnetic field.

4. The automatic magnetic valve of claim 1 where in the flowable material comprises:
a. a liquid phase material (including fluids);
b. a gaseous phase material;
c. a solid phase material; or
d. a combination of any of the foregoing.

5. The automatic magnetic valve of claim 1 wherein the actuator comprises:
a. magnetically responsive material;
b. ferromagnetic (soft or hard) material;
c. a permanent magnet or magnets;
d. a combination of any of the foregoing and other material.

6. The automatic magnetic valve of claim 1 wherein the ROM and direction and magnitude of the off-board magnetic field that at least partially allows or blocks the flowable material comprises one of:
a. full blocking of the flowable material or a full closed valve position;
b. full unblocking of the flowable material or a full open valve position;
c. partial blocking of the flowable material or a partially closed valve position; and
d. partial unblocking of the flowable material or a partially open valve position,

7. The automatic magnetic valve of claim 1 wherein the restoring force component comprises:
a. a resilient member having a changing force versus displacement curve (linear or non-linear) providing a F_{RESTORING} with the ability to recover shape quickly when a deforming force or pressure is removed (including elastic materials and springs that act in accordance with Hooke's law and materials and springs that act in a nonlinear fashion); and
b. a curve for F_{RESTORING} is predetermined based on consideration of:
i. the first direction and magnitude of magnetic force F_{magnetic} of the stray magnetic field relative the actuator; and
ii. the direction and magnitude of force F_{FLOW} of the flowable material relative the actuator
c. wherein F_{FLOW} and F_{RESTORING} can be one of:
i. aligned (⬆⬆);
ii. anti-aligned (⬆⬇); or
iii. perpendicular (⬆→).

8. The automatic magnetic valve of claim 1 wherein the restoring force component comprises:
a. orientation of the valve body to have freedom of movement of the actuator along its ROM substantially vertically in operating conditions of the valve;
b. gravity as the restoring force based on mass of the actuator and position along its ROM.

9. The automatic magnetic valve of claim 1 wherein the off-board magnetic field is:
a. generated off-board the automatic magnetic valve; and/or
b. without a control circuit on-board the automatic magnetic valve; and/or
c. without the need of an on-board electrical power source; and/or
d. one of:
i. dedicated to valve operation, or
ii. dual function of valve operation and another function.

10. The automatic magnetic valve of claim 1 wherein the off-board magnetic field varies between a low field of lower magnetic force in the first direction and a high field of higher magnetic force in the first direction, wherein the low field can have a magnitude of zero to a first value, and the high field can have a magnitude above the first value.

11. The automatic magnetic valve of claim 10 wherein the automatic magnetic valve can be configured for one of:
normally open configuration constructed such that when the off-board magnetic field is low, the valve actuator and housing allow flowable material to flow through the housing; and
normally closed configuration constructed such that when the off-board magnetic field is low, the valve actuator and housing fully block the path of flowable material, thereby preventing flowable material flow.

12. One or more of the automatic magnetic valve of claim 1 in combination with:
a. a source of off-board magnetic field; and
b. a source of flowable material.

13. The automatic magnetic valve of claim 12 wherein the source of off-board magnetic field comprises a magnetocaloric heat pump system where the off-board magnetic field is primarily used for inducing magnetocaloric effect in a magnetocaloric material.

14. The automatic magnetic valve of claim 12 wherein a mechanism and source of off-board magnetic field comprises one of:
a. a faucet where the off-board magnetic field is primarily used for inducing docking of a spray nozzle and a hose;
b. a concealed mechanism to control flow of a gas or a liquid (including flammable and corrosive) where the off-board magnetic field is primarily used for inducing rotary motion of a motor or pump;
c. a plastic pipe where the off-board magnetic field is primarily used for inducing rotary motion of a motor or pump;
d. an elastocaloric heat pumping system where the off-board magnetic field is primarily used for inducing rotary or linear motion of a motor;
e. a tamper-proof valve assembly where the off-board magnetic field influences the magnetic actuator inside the valve body;
f. a pressure vessel where the off-board magnetic field influences the magnetic actuator inside the pressure vessel;
g. a valve assembly where the off-board magnetic field is controlled by a signal from a control location remote from the valve assembly.

15. A method of controlling flow of a flowable material comprising:
a. interposing an automatic magnetic valve comprising a magnetic actuator moveable in a valve body relative to a flow path for the flowable material through the valve body without any on-board magnetic field source for actuating the valve, or control circuit or electrical power source;
b. selecting operating state of the valve to normally-open or normally-closed by configuration of the restoring force component relative to the magnetic actuator;
c. positioning the valve relative to an off-board magnetic field to effectively take advantage of a direction and magnitude of the off-board magnetic field; and
d. operatively connecting and controlling a flow of the flowable material through the valve body with the off-board magnetic field.

16. The method of claim 15 wherein the automatic magnetic valve comprises of one or more of the automatic valve variations of claims 1-14.

17. The method of claim 15 where in the flowable material comprises:
a. a liquid phase material (including fluids);
b. a gaseous phase material;
c. a solid phase material; or
d. a combination of any of the foregoing.

18. The method of claim 15 wherein the actuator comprises:
a. magnetically responsive material;
b. ferromagnetic (soft or hard) material;
c. a permanent magnet or magnets;
d. a combination of any of the foregoing and other material.

19. The method of claim 15 wherein the direction and magnitude of the off-board magnetic field that at least partially allows or blocks the flowable material comprises one of:
a. full blocking of the flowable material or a full closed valve position;
b. full unblocking of the flowable material or a full open valve position;
c. partial blocking of the flowable material or a partially closed valve position; and
d. partial unblocking of the flowable material or a partially open valve position,

20. The method of claim 15 wherein the restoring force component comprises:
a. a changing force versus displacement curve (linear or non-linear) providing a F_{restoring} with the ability to recover shape quickly when a deforming force or pressure is removed (including elastic materials and springs that act in accordance with Hooke's law and materials and springs that act in a nonlinear fashion); and
b. a curve for F_{restoring} is predetermined based on consideration of:
i. the first direction and magnitude of magnetic force F_{magnetic} of the stray magnetic field relative the actuator; and
ii. the direction and magnitude of force F_{FLOW} of the flowable material relative the actuator
c. wherein F_{flow} and F_{restoring} can be one of:
i. aligned (⬆⬆);
ii. anti-aligned (⬆⬇); or
iii. perpendicular (⬆→).

21. The method of claim 15 wherein the off-board magnetic field is:
a. generated off-board the automatic magnetic valve; and/or
b. without a control circuit on-board the automatic magnetic valve; and/or
c. without the need of an on-board electrical power source; and/or
d. one of:
i. dedicated to valve operation, or
ii. dual function of valve operation and another function.

22. The method of claim 15 wherein the off-board magnetic field varies between a low field of lower magnetic force in the first direction and a high field of higher magnetic force in the first direction, wherein the low field can have a magnitude of zero to a first value, and the high field can have a magnitude above the first value.

23. The method of claim 15 wherein the automatic magnetic valve can be configured for one of:
normally open configuration constructed such that when the off-board magnetic field is low, the valve actuator and housing allow flowable material to flow through the housing; and
normally closed configuration constructed such that when the off-board magnetic field is low, the valve actuator and housing fully block the path of flowable material, thereby preventing flowable material flow.

24. The method of claim 15 wherein the source of off-board magnetic field comprises a magnetocaloric heat pump system where the off-board magnetic field is primarily used for inducing magnetocaloric effect in a magnetocaloric material.

25. The method of claim 15 wherein a mechanism and source of off-board magnetic field comprises one of:
a. a faucet where the off-board magnetic field is primarily used for inducing docking of a spray nozzle and a hose;
b. a concealed mechanism to control flow of a gas or a liquid (including flammable and corrosive) where the off-board magnetic field is primarily used for inducing rotary motion of a motor or pump;
c. a plastic pipe where the off-board magnetic field is primarily used for inducing rotary motion of a motor or pump;
d. an elastocaloric heat pumping system where the off-board magnetic field is primarily used for inducing rotary or linear motion of a motor;
e. a tamper-proof valve assembly where the off-board magnetic field influences the magnetic actuator inside the valve body;
f. a pressure vessel where the off-board magnetic field influences the magnetic actuator inside the pressure vessel;
g. a valve assembly where the off-board magnetic field is controlled by a signal from a control location remote from the valve assembly.

26. A system of controlling flow of a flowable material comprising:
a. an off-board magnetic field subsystem comprising:
i. a source of variable magnetic field generating a magnetic force; and
b. an automatic magnetic valving subsystem comprising:
i. an automatic magnetic valve positioned in effective proximity to the off-board source of the variable magnetic field along a flow path;
ii. in operative communication with a source of a flowable material along a flow path wherein the automatic magnetic valve is positioned relative to the off-board magnetic field to effectively take advantage of the direction and magnitude of the off-board magnetic field to control flow of the flowable material.

27. A valve for automatically and passively controlling flow of a flowable material at a flow force F_{flow} without separate control and/or electrical power by using the presence of an off-board magnetic field that varies in a time-dependent manner between a magnetic force F_{magnetic1} and a magnetic force F_{magnetic2}, where F_{magnetic1} is greater than F_{magnetic2}, comprising:
a. a valve body having a flow path for the flowable material between first and second ports and that is at least substantially magnetically non-responsive to the magnetic force F_{magnetic1};
b. an actuator member of magnetic (e.g. ferromagnetic or a permanent magnet) material having freedom of movement (FOV) along a constrained range of motion (ROM) inside the valve body between a flow blocking position and a flow allowing position relative the flow path; and
c. a restoring force component having a restoring force F_{restoring} that constantly urges the actuator member to one of the flow blocking and flow allowing positions, wherein the F_{magnetic1} at the actuator member is greater than F_{restoring} plus F_{flow};
d. so that in response to effective proximity and orientation of the valve body to an off-board variable magnetic field whether dedicated to operation of the valve or also used for another purpose, the actuator member automatically and passively moves to the other of one of the flow blocking or flow allowing positions by overcoming F_{restoring} plus F_{flow}.
